(19) United States
(12) Patent Application Publication
(10) Pub. No.: US 2022/0255591 A1
(43) Pub. Date: Aug. 11, 2022

(54) Conditional Handover Configurations of Multiple Beams of a Cell

(71) Applicant: Ofinno, LLC, Reston, VA (US)

(72) Inventors: Kyungmin Park, Vienna, VA (US); Esmael Hejazi Dinan, McLean, VA (US); Taehun Kim, Fairfax, VA (US); Hyoungsuk Jeon, Centreville, VA (US); Jinsook Ryu, Oakton, VA (US); Peyman Talebi Fard, Vienna, VA (US); Hyukjin Chae, Fairfax, VA (US)

(73) Assignee: Ofinno, LLC, Reston, VA (US)

(21) Appl. No.: 17/734,470

(22) Filed: May 2, 2022

Related U.S. Application Data
(63) Continuation of application No. PCT/US2020/059735, filed on Nov. 9, 2020.
(60) Provisional application No. 62/932,466, filed on Nov. 7, 2019.
(60) Provisional application No. 62/932,109, filed on Nov. 7, 2019.

(51) Int. Cl. H04B 7/0408; H04B 7/08; H04B 7/26; H04B 17/318

(52) U.S. Cl. CPC H04B 7/0408; H04B 17/318; H04B 7/2681; H04B 7/0811

(57) ABSTRACT

A wireless device receives at least one message for a conditional handover to a cell. The at least one message comprises: a first execution condition for at least one first beam of the cell; and a second execution condition for at least one second beam of the cell. a random access preamble is sent via a radio resource associated with selected at least one beam of the cell. The selected at least one beam is one of: the at least one first beam based on the first execution condition being met; or the at least one second beam based on the second execution condition being met.

### CROSS-REFERENCE TO RELATED APPLICATIONS

This application is a continuation of International Application No. PCT/US2020/059735, filed Nov. 9, 2020, which claims the benefit of U.S. Provisional Application No. 62/932,109, filed Nov. 7, 2019, and U.S. Provisional Application No. 62/932,466, filed Nov. 7, 2019, all of which are hereby incorporated by reference in their entirety.

### BRIEF DESCRIPTION OF THE DRAWINGS

Examples of several of the various embodiments of the present disclosure are described herein with reference to the drawings.

FIG. 1A and FIG. 1B illustrate example mobile communication networks in which embodiments of the present disclosure may be implemented.

FIG. 2A and FIG. 2B respectively illustrate a New Radio (NR) user plane and control plane protocol stack.

FIG. 3 illustrates an example of services provided between protocol layers of the NR user plane protocol stack of FIG. 2A.

FIG. 4A illustrates an example downlink data flow through the NR user plane protocol stack of FIG. 2A.

FIG. 4B illustrates an example format of a MAC subheader in a MAC PDU.

FIG. 5A and FIG. 5B respectively illustrate a mapping between logical channels, transport channels, and physical channels for the downlink and uplink.

FIG. 6 is an example diagram showing RRC state transitions of a UE.

FIG. 7 illustrates an example configuration of an NR frame into which OFDM symbols are grouped.

FIG. 8 illustrates an example configuration of a slot in the time and frequency domain for an NR carrier.

FIG. 9 illustrates an example of bandwidth adaptation using three configured BWPs for an NR carrier.

FIG. 10A illustrates three carrier aggregation configurations with two component carriers.

FIG. 10B illustrates an example of how aggregated cells may be configured into one or more PUCCH groups.

FIG. 11A illustrates an example of an SS/PBCH block structure and location.

FIG. 11B illustrates an example of CSI-RSs that are mapped in the time and frequency domains.

FIG. 12A and FIG. 12B respectively illustrate examples of three downlink and uplink beam management procedures.

FIG. 13A, FIG. 13B, and FIG. 13C respectively illustrate a four-step contention-based random access procedure, a two-step contention-free random access procedure, and another two-step random access procedure.

FIG. 14A illustrates an example of CORESET configurations for a bandwidth part.

FIG. 14B illustrates an example of a CCE-to-REG mapping for DCI transmission on a CORESET and PDCCH processing.

FIG. 15 illustrates an example of a wireless device in communication with a base station.

FIG. 16A, FIG. 16B, FIG. 16C, and FIG. 16D illustrate example structures for uplink and downlink transmission.

FIG. 17 is an diagram of an aspect of an example embodiment of the present disclosure.

FIG. 18 is an diagram of an aspect of an example embodiment of the present disclosure.

FIG. 19 is an diagram of an aspect of an example embodiment of the present disclosure.

FIG. 20 is an diagram of an aspect of an example embodiment of the present disclosure.

FIG. 21 is an diagram of an aspect of an example embodiment of the present disclosure.

FIG. 22 is an diagram of an aspect of an example embodiment of the present disclosure.

FIG. 23 is an diagram of an aspect of an example embodiment of the present disclosure.

FIG. 24 is an diagram of an aspect of an example embodiment of the present disclosure.

FIG. 25 is an diagram of an aspect of an example embodiment of the present disclosure.

FIG. 26 is an diagram of an aspect of an example embodiment of the present disclosure.

FIG. 27 is an diagram of an aspect of an example embodiment of the present disclosure.

FIG. 28 is an diagram of an aspect of an example embodiment of the present disclosure.

FIG. 29 is an diagram of an aspect of an example embodiment of the present disclosure.

FIG. 30 is an diagram of an aspect of an example embodiment of the present disclosure.

FIG. 31 is an diagram of an aspect of an example embodiment of the present disclosure.

FIG. 32 is an diagram of an aspect of an example embodiment of the present disclosure.

FIG. 33 is an diagram of an aspect of an example embodiment of the present disclosure.

FIG. 34 is an diagram of an aspect of an example embodiment of the present disclosure.

FIG. 35 is an diagram of an aspect of an example embodiment of the present disclosure.

FIG. 36 is an diagram of an aspect of an example embodiment of the present disclosure.

FIG. 37 is an diagram of an aspect of an example embodiment of the present disclosure.

FIG. 38 is an diagram of an aspect of an example embodiment of the present disclosure.

FIG. 39 is an diagram of an aspect of an example embodiment of the present disclosure.

FIG. 40 is an diagram of an aspect of an example embodiment of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have some specific capability(ies) depending on wireless device category and/or capability(ies). When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, should be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={cell1, cell2} are: {cell1}, {cell2}, and {cell1, cell2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages comprise a plurality of parameters, it implies that a parameter in the plurality of parameters is in at least one of the one or more messages, but does not have to be in each of the one or more messages.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or Lab VIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

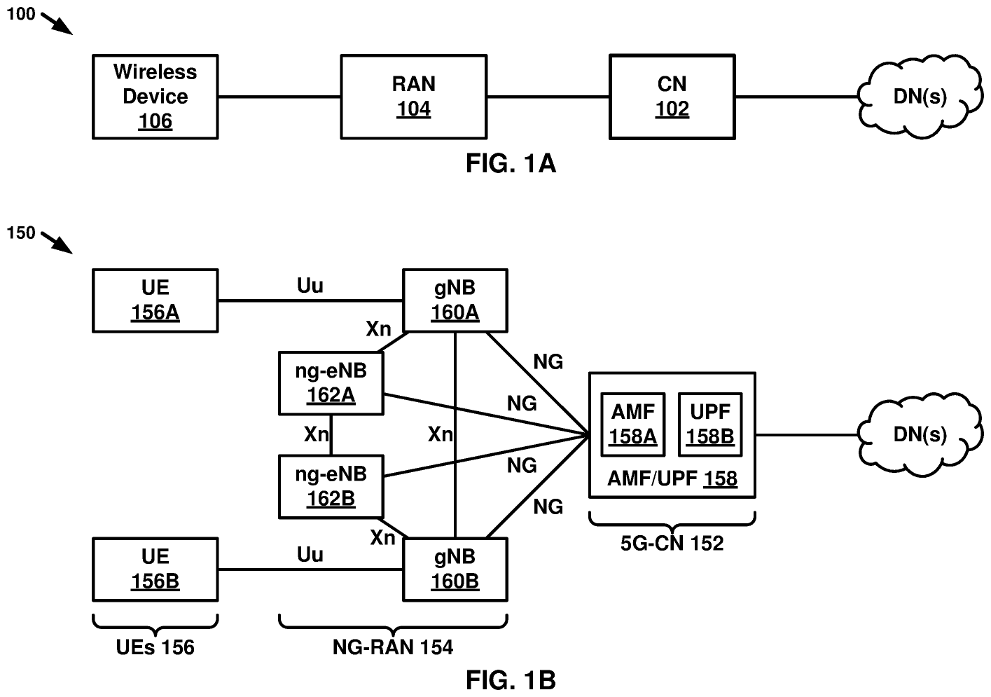

FIG. 1A illustrates an example of a mobile communication network 100 in which embodiments of the present disclosure may be implemented. The mobile communication network 100 may be, for example, a public land mobile network (PLMN) run by a network operator. As illustrated in FIG. 1A, the mobile communication network 100 includes a core network (CN) 102, a radio access network (RAN) 104, and a wireless device 106.

The CN 102 may provide the wireless device 106 with an interface to one or more data networks (DNs), such as public DNs (e.g., the Internet), private DNs, and/or intra-operator DNs. As part of the interface functionality, the CN 102 may set up end-to-end connections between the wireless device 106 and the one or more DNs, authenticate the wireless device 106, and provide charging functionality.

The RAN 104 may connect the CN 102 to the wireless device 106 through radio communications over an air interface. As part of the radio communications, the RAN 104 may provide scheduling, radio resource management, and retransmission protocols. The communication direction from the RAN 104 to the wireless device 106 over the air interface is known as the downlink and the communication direction from the wireless device 106 to the RAN 104 over the air interface is known as the uplink. Downlink transmissions may be separated from uplink transmissions using frequency division duplexing (FDD), time-division duplexing (TDD), and/or some combination of the two duplexing techniques.

The term wireless device may be used throughout this disclosure to refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle road side unit (RSU), relay node, automobile, and/or any combination thereof. The term wireless device encompasses other terminology, including user equipment (UE), user terminal (UT), access terminal (AT), mobile station, handset, wireless transmit and receive unit (WTRU), and/or wireless communication device.

The RAN 104 may include one or more base stations (not shown). The term base station may be used throughout this disclosure to refer to and encompass a Node B (associated with UMTS and/or 3G standards), an Evolved Node B (eNB, associated with E-UTRA and/or 4G standards), a remote radio head (RRH), a baseband processing unit coupled to one or more RRHs, a repeater node or relay node used to extend the coverage area of a donor node, a Next Generation Evolved Node B (ng-eNB), a Generation Node B (gNB, associated with NR and/or 5G standards), an access point (AP, associated with, for example, WiFi or any other suitable wireless communication standard), and/or any combination thereof. A base station may comprise at least one gNB Central Unit (gNB-CU) and at least one a gNB Distributed Unit (gNB-DU).

A base station included in the RAN 104 may include one or more sets of antennas for communicating with the wireless device 106 over the air interface. For example, one or more of the base stations may include three sets of antennas to respectively control three cells (or sectors). The size of a cell may be determined by a range at which a receiver (e.g., a base station receiver) can successfully receive the transmissions from a transmitter (e.g., a wireless device transmitter) operating in the cell. Together, the cells of the base stations may provide radio coverage to the wireless device 106 over a wide geographic area to support wireless device mobility.

In addition to three-sector sites, other implementations of base stations are possible. For example, one or more of the base stations in the RAN 104 may be implemented as a sectored site with more or less than three sectors. One or more of the base stations in the RAN 104 may be implemented as an access point, as a baseband processing unit coupled to several remote radio heads (RRHs), and/or as a repeater or relay node used to extend the coverage area of a donor node. A baseband processing unit coupled to RRHs may be part of a centralized or cloud RAN architecture, where the baseband processing unit may be either centralized in a pool of baseband processing units or virtualized. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The RAN 104 may be deployed as a homogenous network of macrocell base stations that have similar antenna patterns and similar high-level transmit powers. The RAN 104 may be deployed as a heterogeneous network. In heterogeneous networks, small cell base stations may be used to provide small coverage areas, for example, coverage areas that overlap with the comparatively larger coverage areas provided by macrocell base stations. The small coverage areas may be provided in areas with high data traffic (or so-called “hotspots”) or in areas with weak macrocell coverage. Examples of small cell base stations include, in order of decreasing coverage area, microcell base stations, picocell base stations, and femtocell base stations or home base stations.

The Third-Generation Partnership Project (3GPP) was formed in 1998 to provide global standardization of specifications for mobile communication networks similar to the mobile communication network 100 in FIG. 1A. To date, 3GPP has produced specifications for three generations of mobile networks: a third generation (3G) network known as Universal Mobile Telecommunications System (UMTS), a fourth generation (4G) network known as Long-Term Evolution (LTE), and a fifth generation (5G) network known as 5G System (5GS). Embodiments of the present disclosure are described with reference to the RAN of a 3GPP 5G network, referred to as next-generation RAN (NG-RAN). Embodiments may be applicable to RANs of other mobile communication networks, such as the RAN 104 in FIG. 1A, the RANs of earlier 3G and 4G networks, and those of future networks yet to be specified (e.g., a 3GPP 6G network). NG-RAN implements 5G radio access technology known as New Radio (NR) and may be provisioned to implement 4G radio access technology or other radio access technologies, including non-3GPP radio access technologies.

FIG. 1B illustrates another example mobile communication network 150 in which embodiments of the present disclosure may be implemented. Mobile communication network 150 may be, for example, a PLMN run by a network operator. As illustrated in FIG. 1B, mobile communication network 150 includes a 5G core network (5G-CN) 152, an NG-RAN 154, and UEs 156A and 156B (collectively UEs 156). These components may be implemented and operate in the same or similar manner as corresponding components described with respect to FIG. 1A.

The 5G-CN 152 provides the UEs 156 with an interface to one or more DNs, such as public DNs (e.g., the Internet), private DNs, and/or intra-operator DNs. As part of the interface functionality, the 5G-CN 152 may set up end-to-end connections between the UEs 156 and the one or more DNs, authenticate the UEs 156, and provide charging functionality. Compared to the CN of a 3GPP 4G network, the basis of the 5G-CN 152 may be a service-based architecture. This means that the architecture of the nodes making up the 5G-CN 152 may be defined as network functions that offer services via interfaces to other network functions. The network functions of the 5G-CN 152 may be implemented in several ways, including as network elements on dedicated or shared hardware, as software instances running on dedicated or shared hardware, or as virtualized functions instantiated on a platform (e.g., a cloud-based platform).

As illustrated in FIG. 1B, the 5G-CN 152 includes an Access and Mobility Management Function (AMF) 158A and a User Plane Function (UPF) 158B, which are shown as one component AMF/UPF 158 in FIG. 1B for ease of illustration. The UPF 158B may serve as a gateway between the NG-RAN 154 and the one or more DNs. The UPF 158B may perform functions such as packet routing and forwarding, packet inspection and user plane policy rule enforcement, traffic usage reporting, uplink classification to support routing of traffic flows to the one or more DNs, quality of service (QoS) handling for the user plane (e.g., packet filtering, gating, uplink/downlink rate enforcement, and uplink traffic verification), downlink packet buffering, and downlink data notification triggering. The UPF 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The UEs 156 may be configured to receive services through a PDU session, which is a logical connection between a UE and a DN.

The AMF 158A may perform functions such as Non-Access Stratum (NAS) signaling termination, NAS signaling security, Access Stratum (AS) security control, inter-CN node signaling for mobility between 3GPP access networks, idle mode UE reachability (e.g., control and execution of paging retransmission), registration area management, intra-system and inter-system mobility support, access authentication, access authorization including checking of roaming rights, mobility management control (subscription and policies), network slicing support, and/or session management function (SMF) selection. NAS may refer to the functionality operating between a CN and a UE, and AS may refer to the functionality operating between the UE and a RAN.

The 5G-CN 152 may include one or more additional network functions that are not shown in FIG. 1B for the sake of clarity. For example, the 5G-CN 152 may include one or more of a Session Management Function (SMF), an NR Repository Function (NRF), a Policy Control Function (PCF), a Network Exposure Function (NEF), a Unified Data Management (UDM), an Application Function (AF), and/or an Authentication Server Function (AUSF).

The NG-RAN 154 may connect the 5G-CN 152 to the UEs 156 through radio communications over the air interface. The NG-RAN 154 may include one or more gNBs, illustrated as gNB 160A and gNB 160B (collectively gNBs 160) and/or one or more ng-eNBs, illustrated as ng-eNB 162A and ng-eNB 162B (collectively ng-eNBs 162). The gNBs 160 and ng-eNBs 162 may be more generically referred to as base stations. The gNBs 160 and ng-eNBs 162 may include one or more sets of antennas for communicating with the UEs 156 over an air interface. For example, one or more of the gNBs 160 and/or one or more of the ng-eNBs 162 may include three sets of antennas to respectively control three cells (or sectors). Together, the cells of the gNBs 160 and the ng-eNBs 162 may provide radio coverage to the UEs 156 over a wide geographic area to support UE mobility.

As shown in FIG. 1B, the gNBs 160 and/or the ng-eNBs 162 may be connected to the 5G-CN 152 by means of an NG interface and to other base stations by an Xn interface. The NG and Xn interfaces may be established using direct physical connections and/or indirect connections over an underlying transport network, such as an internet protocol (IP) transport network. The gNBs 160 and/or the ng-eNBs 162 may be connected to the UEs 156 by means of a Uu interface. For example, as illustrated in FIG. 1B, gNB 160A may be connected to the UE 156A by means of a Uu interface. The NG, Xn, and Uu interfaces are associated with a protocol stack. The protocol stacks associated with the interfaces may be used by the network elements in FIG. 1B to exchange data and signaling messages and may include two planes: a user plane and a control plane. The user plane may handle data of interest to a user. The control plane may handle signaling messages of interest to the network elements.

The gNBs 160 and/or the ng-eNBs 162 may be connected to one or more AMF/UPF functions of the 5G-CN 152, such as the AMF/UPF 158, by means of one or more NG interfaces. For example, the gNB 160A may be connected to the UPF 158B of the AMF/UPF 158 by means of an NG-User plane (NG-U) interface. The NG-U interface may provide delivery (e.g., non-guaranteed delivery) of user plane PDUs between the gNB 160A and the UPF 158B. The gNB 160A may be connected to the AMF 158A by means of an NG-Control plane (NG-C) interface. The NG-C interface may provide, for example, NG interface management, UE context management, UE mobility management, transport of NAS messages, paging, PDU session management, and configuration transfer and/or warning message transmission.

The gNBs 160 may provide NR user plane and control plane protocol terminations towards the UEs 156 over the Uu interface. For example, the gNB 160A may provide NR user plane and control plane protocol terminations toward the UE 156A over a Uu interface associated with a first protocol stack. The ng-eNBs 162 may provide Evolved UMTS Terrestrial Radio Access (E-UTRA) user plane and control plane protocol terminations towards the UEs 156 over a Uu interface, where E-UTRA refers to the 3GPP 4G radio-access technology. For example, the ng-eNB 162B may provide E-UTRA user plane and control plane protocol terminations towards the UE 156B over a Uu interface associated with a second protocol stack.

The 5G-CN 152 was described as being configured to handle NR and 4G radio accesses. It will be appreciated by one of ordinary skill in the art that it may be possible for NR to connect to a 4G core network in a mode known as “non-standalone operation.” In non-standalone operation, a 4G core network is used to provide (or at least support) control-plane functionality (e.g., initial access, mobility, and paging). Although only one AMF/UPF 158 is shown in FIG. 1B, one gNB or ng-eNB may be connected to multiple AMF/UPF nodes to provide redundancy and/or to load share across the multiple AMF/UPF nodes.

As discussed, an interface (e.g., Uu, Xn, and NG interfaces) between the network elements in FIG. 1B may be associated with a protocol stack that the network elements use to exchange data and signaling messages. A protocol stack may include two planes: a user plane and a control plane. The user plane may handle data of interest to a user, and the control plane may handle signaling messages of interest to the network elements.

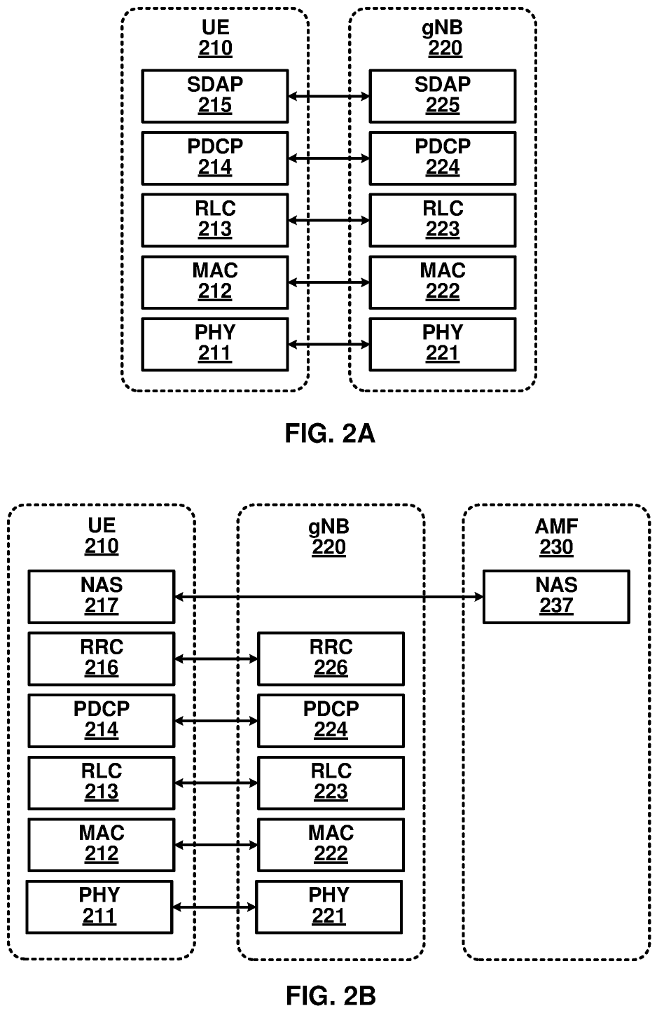

FIG. 2A and FIG. 2B respectively illustrate examples of NR user plane and NR control plane protocol stacks for the Uu interface that lies between a UE 210 and a gNB 220. The protocol stacks illustrated in FIG. 2A and FIG. 2B may be the same or similar to those used for the Uu interface between, for example, the UE 156A and the gNB 160A shown in FIG. 1B.

FIG. 2A illustrates a NR user plane protocol stack comprising five layers implemented in the UE 210 and the gNB 220. At the bottom of the protocol stack, physical layers (PHYs) 211 and 221 may provide transport services to the higher layers of the protocol stack and may correspond to layer 1 of the Open Systems Interconnection (OSI) model. The next four protocols above PHYs 211 and 221 comprise media access control layers (MACs) 212 and 222, radio link control layers (RLCs) 213 and 223, packet data convergence protocol layers (PDCPs) 214 and 224, and service data application protocol layers (SDAPs) 215 and 225. Together, these four protocols may make up layer 2, or the data link layer, of the OSI model.

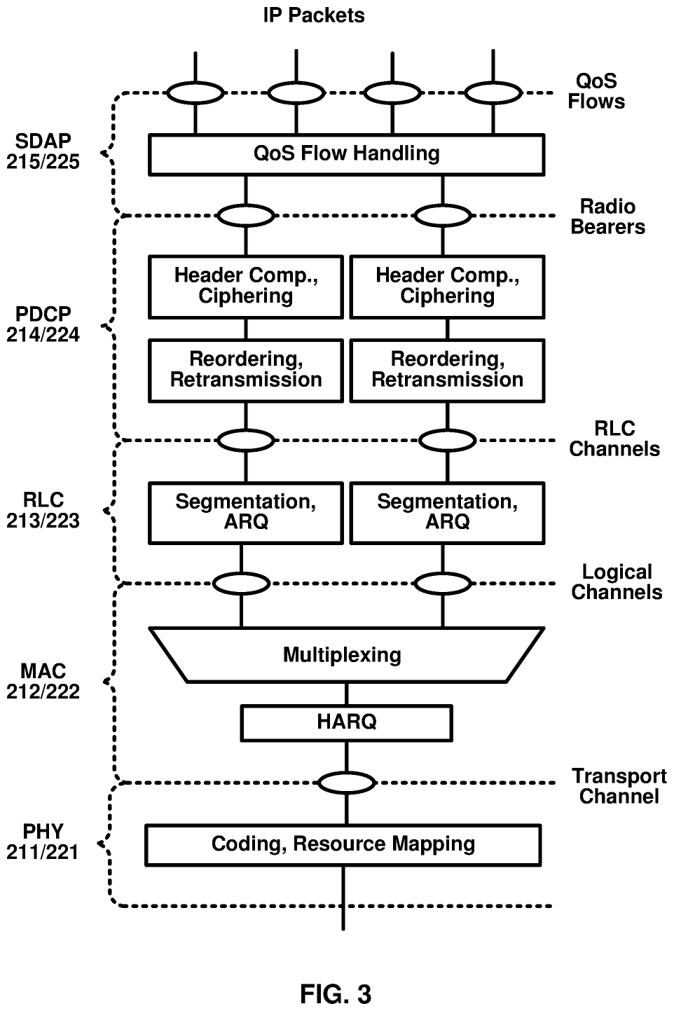

FIG. 3 illustrates an example of services provided between protocol layers of the NR user plane protocol stack. Starting from the top of FIG. 2A and FIG. 3, the SDAPs 215 and 225 may perform QoS flow handling. The UE 210 may receive services through a PDU session, which may be a logical connection between the UE 210 and a DN. The PDU session may have one or more QoS flows. A UPF of a CN (e.g., the UPF 158B) may map IP packets to the one or more QoS flows of the PDU session based on QoS requirements (e.g., in terms of delay, data rate, and/or error rate). The SDAPs 215 and 225 may perform mapping/de-mapping between the one or more QoS flows and one or more data radio bearers. The mapping/de-mapping between the QoS flows and the data radio bearers may be determined by the SDAP 225 at the gNB 220. The SDAP 215 at the UE 210 may be informed of the mapping between the QoS flows and the data radio bearers through reflective mapping or control signaling received from the gNB 220. For reflective mapping, the SDAP 225 at the gNB 220 may mark the downlink packets with a QoS flow indicator (QFI), which may be observed by the SDAP 215 at the UE 210 to determine the mapping/de-mapping between the QoS flows and the data radio bearers.

The PDCPs 214 and 224 may perform header compression/decompression to reduce the amount of data that needs to be transmitted over the air interface, ciphering/deciphering to prevent unauthorized decoding of data transmitted over the air interface, and integrity protection (to ensure control messages originate from intended sources. The PDCPs 214 and 224 may perform retransmissions of undelivered packets, in-sequence delivery and reordering of packets, and removal of packets received in duplicate due to, for example, an intra-gNB handover. The PDCPs 214 and 224 may perform packet duplication to improve the likelihood of the packet being received and, at the receiver, remove any duplicate packets. Packet duplication may be useful for services that require high reliability.

Although not shown in FIG. 3, PDCPs 214 and 224 may perform mapping/de-mapping between a split radio bearer and RLC channels in a dual connectivity scenario. Dual connectivity is a technique that allows a UE to connect to two cells or, more generally, two cell groups: a master cell group (MCG) and a secondary cell group (SCG). A split bearer is when a single radio bearer, such as one of the radio bearers provided by the PDCPs 214 and 224 as a service to the SDAPs 215 and 225, is handled by cell groups in dual connectivity. The PDCPs 214 and 224 may map/de-map the split radio bearer between RLC channels belonging to cell groups.

The RLCs 213 and 223 may perform segmentation, retransmission through Automatic Repeat Request (ARQ), and removal of duplicate data units received from MACs 212 and 222, respectively. The RLCs 213 and 223 may support three transmission modes: transparent mode (TM); unacknowledged mode (UM); and acknowledged mode (AM). Based on the transmission mode an RLC is operating, the RLC may perform one or more of the noted functions. The RLC configuration may be per logical channel with no dependency on numerologies and/or Transmission Time Interval (TTI) durations. As shown in FIG. 3, the RLCs 213 and 223 may provide RLC channels as a service to PDCPs 214 and 224, respectively.

The MACs 212 and 222 may perform multiplexing/demultiplexing of logical channels and/or mapping between logical channels and transport channels. The multiplexing/demultiplexing may include multiplexing/demultiplexing of data units, belonging to the one or more logical channels, into/from Transport Blocks (TBs) delivered to/from the PHYs 211 and 221. The MAC 222 may be configured to perform scheduling, scheduling information reporting, and priority handling between UEs by means of dynamic scheduling. Scheduling may be performed in the gNB 220 (at the MAC 222) for downlink and uplink. The MACs 212 and 222 may be configured to perform error correction through Hybrid Automatic Repeat Request (HARQ) (e.g., one HARQ entity per carrier in case of Carrier Aggregation (CA)), priority handling between logical channels of the UE 210 by means of logical channel prioritization, and/or padding. The MACs 212 and 222 may support one or more numerologies and/or transmission timings. In an example, mapping restrictions in a logical channel prioritization may control which numerology and/or transmission timing a logical channel may use. As shown in FIG. 3, the MACs 212 and 222 may provide logical channels as a service to the RLCs 213 and 223.

The PHYs 211 and 221 may perform mapping of transport channels to physical channels and digital and analog signal processing functions for sending and receiving information over the air interface. These digital and analog signal processing functions may include, for example, coding/decoding and modulation/demodulation. The PHYs 211 and 221 may perform multi-antenna mapping. As shown in FIG. 3, the PHYs 211 and 221 may provide one or more transport channels as a service to the MACs 212 and 222.

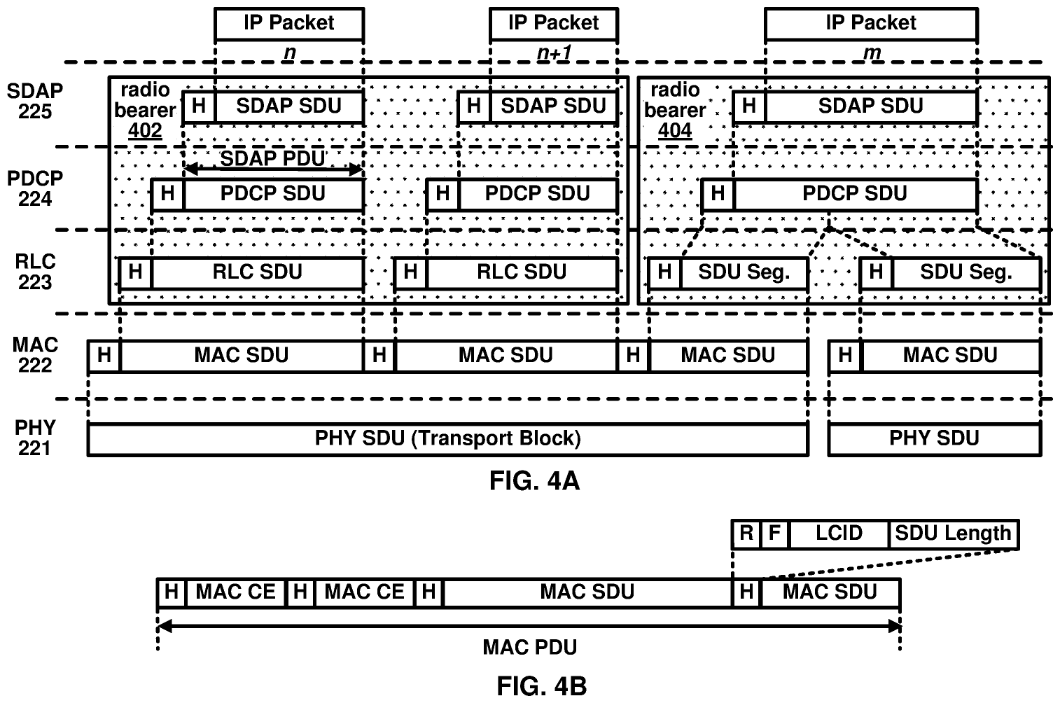

FIG. 4A illustrates an example downlink data flow through the NR user plane protocol stack. FIG. 4A illustrates a downlink data flow of three IP packets (n, n+1, and m) through the NR user plane protocol stack to generate two TBs at the gNB 220. An uplink data flow through the NR user plane protocol stack may be similar to the downlink data flow depicted in FIG. 4A.

The downlink data flow of FIG. 4A begins when SDAP 225 receives the three IP packets from one or more QoS flows and maps the three packets to radio bearers. In FIG. 4A, the SDAP 225 maps IP packets n and n+1 to a first radio bearer 402 and maps IP packet m to a second radio bearer 404. An SDAP header (labeled with an “H” in FIG. 4A) is added to an IP packet. The data unit from/to a higher protocol layer is referred to as a service data unit (SDU) of the lower protocol layer and the data unit to/from a lower protocol layer is referred to as a protocol data unit (PDU) of the higher protocol layer. As shown in FIG. 4A, the data unit from the SDAP 225 is an SDU of lower protocol layer PDCP 224 and is a PDU of the SDAP 225.

The remaining protocol layers in FIG. 4A may perform their associated functionality (e.g., with respect to FIG. 3), add corresponding headers, and forward their respective outputs to the next lower layer. For example, the PDCP 224 may perform IP-header compression and ciphering and forward its output to the RLC 223. The RLC 223 may optionally perform segmentation (e.g., as shown for IP packet m in FIG. 4A) and forward its output to the MAC 222. The MAC 222 may multiplex a number of RLC PDUs and may attach a MAC subheader to an RLC PDU to form a transport block. In NR, the MAC subheaders may be distributed across the MAC PDU, as illustrated in FIG. 4A. In LTE, the MAC subheaders may be entirely located at the beginning of the MAC PDU. The NR MAC PDU structure may reduce processing time and associated latency because the MAC PDU subheaders may be computed before the full MAC PDU is assembled.

FIG. 4B illustrates an example format of a MAC subheader in a MAC PDU. The MAC subheader includes: an SDU length field for indicating the length (e.g., in bytes) of the MAC SDU to which the MAC subheader corresponds; a logical channel identifier (LCID) field for identifying the logical channel from which the MAC SDU originated to aid in the demultiplexing process; a flag (F) for indicating the size of the SDU length field; and a reserved bit (R) field for future use.

FIG. 4B further illustrates MAC control elements (CEs) inserted into the MAC PDU by a MAC, such as MAC 223 or MAC 222. For example, FIG. 4B illustrates two MAC CEs inserted into the MAC PDU. MAC CEs may be inserted at the beginning of a MAC PDU for downlink transmissions (as shown in FIG. 4B) and at the end of a MAC PDU for uplink transmissions. MAC CEs may be used for in-band control signaling. Example MAC CEs include: scheduling-related MAC CEs, such as buffer status reports and power headroom reports; activation/deactivation MAC CEs, such as those for activation/deactivation of PDCP duplication detection, channel state information (CSI) reporting, sounding reference signal (SRS) transmission, and prior configured components; discontinuous reception (DRX) related MAC CEs; timing advance MAC CEs; and random access related MAC CEs. A MAC CE may be preceded by a MAC subheader with a similar format as described for MAC SDUs and may be identified with a reserved value in the LCID field that indicates the type of control information included in the MAC CE.

Before describing the NR control plane protocol stack, logical channels, transport channels, and physical channels are first described as well as a mapping between the channel types. One or more of the channels may be used to carry out functions associated with the NR control plane protocol stack described later below.

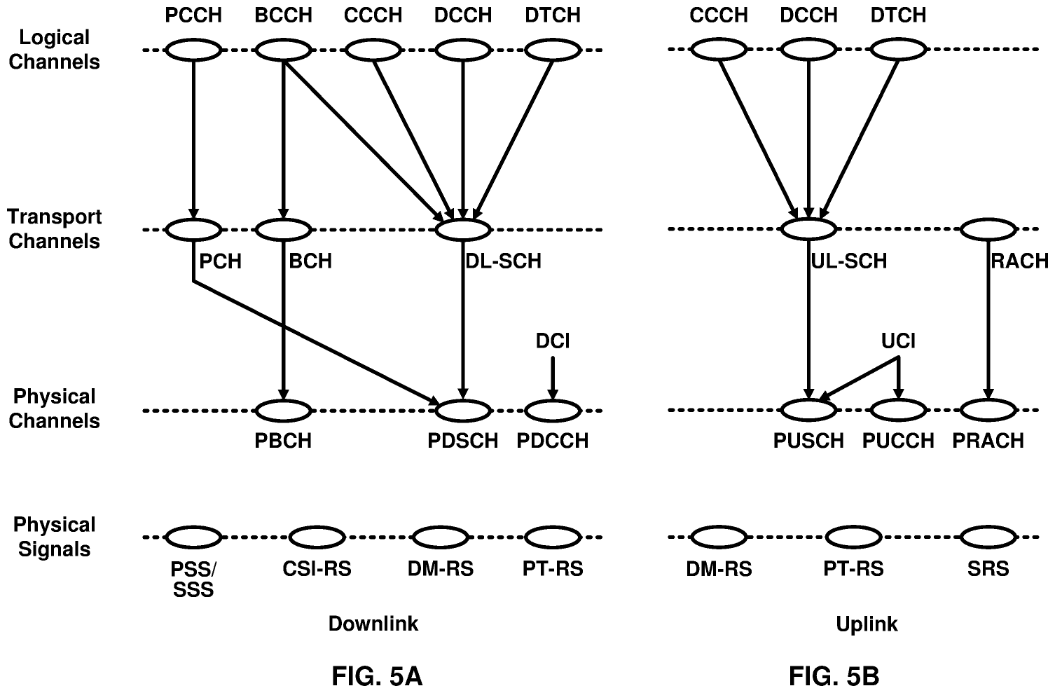

FIG. 5A and FIG. 5B illustrate, for downlink and uplink respectively, a mapping between logical channels, transport channels, and physical channels. Information is passed through channels between the RLC, the MAC, and the PHY of the NR protocol stack. A logical channel may be used between the RLC and the MAC and may be classified as a control channel that carries control and configuration information in the NR control plane or as a traffic channel that carries data in the NR user plane. A logical channel may be classified as a dedicated logical channel that is dedicated to a specific UE or as a common logical channel that may be used by more than one UE. A logical channel may also be defined by the type of information it carries. The set of logical channels defined by NR include, for example:
a paging control channel (PCCH) for carrying paging messages used to page a UE whose location is not known to the network on a cell level;
a broadcast control channel (BCCH) for carrying system information messages in the form of a master information block (MIB) and several system information blocks (SIBs), wherein the system information messages may be used by the UEs to obtain information about how a cell is configured and how to operate within the cell;
a common control channel (CCCH) for carrying control messages together with random access;
a dedicated control channel (DCCH) for carrying control messages to/from a specific the UE to configure the UE; and
a dedicated traffic channel (DTCH) for carrying user data to/from a specific the UE.

Transport channels are used between the MAC and PHY layers and may be defined by how the information they carry is transmitted over the air interface. The set of transport channels defined by NR include, for example:
a paging channel (PCH) for carrying paging messages that originated from the PCCH;
a broadcast channel (BCH) for carrying the MIB from the BCCH;
a downlink shared channel (DL-SCH) for carrying downlink data and signaling messages, including the SIBs from the BCCH;
an uplink shared channel (UL-SCH) for carrying uplink data and signaling messages; and
a random access channel (RACH) for allowing a UE to contact the network without any prior scheduling.

The PHY may use physical channels to pass information between processing levels of the PHY. A physical channel may have an associated set of time-frequency resources for carrying the information of one or more transport channels. The PHY may generate control information to support the low-level operation of the PHY and provide the control information to the lower levels of the PHY via physical control channels, known as L1/L2 control channels. The set of physical channels and physical control channels defined by NR include, for example:
a physical broadcast channel (PBCH) for carrying the MIB from the BCH;
a physical downlink shared channel (PDSCH) for carrying downlink data and signaling messages from the DL-SCH, as well as paging messages from the PCH;
a physical downlink control channel (PDCCH) for carrying downlink control information (DCI), which may include downlink scheduling commands, uplink scheduling grants, and uplink power control commands;
a physical uplink shared channel (PUSCH) for carrying uplink data and signaling messages from the UL-SCH and in some instances uplink control information (UCI) as described below;
a physical uplink control channel (PUCCH) for carrying UCI, which may include HARQ acknowledgments, channel quality indicators (CQI), pre-coding matrix indicators (PMI), rank indicators (RI), and scheduling requests (SR); and
a physical random access channel (PRACH) for random access.

Similar to the physical control channels, the physical layer generates physical signals to support the low-level operation of the physical layer. As shown in FIG. 5A and FIG. 5B, the physical layer signals defined by NR include: primary synchronization signals (PSS), secondary synchronization signals (SSS), channel state information reference signals (CSI-RS), demodulation reference signals (DMRS), sounding reference signals (SRS), and phase-tracking reference signals (PT-RS). These physical layer signals will be described in greater detail below.

FIG. 2B illustrates an example NR control plane protocol stack. As shown in FIG. 2B, the NR control plane protocol stack may use the same/similar first four protocol layers as the example NR user plane protocol stack. These four protocol layers include the PHYs 211 and 221, the MACs 212 and 222, the RLCs 213 and 223, and the PDCPs 214 and 224. Instead of having the SDAPs 215 and 225 at the top of the stack as in the NR user plane protocol stack, the NR control plane stack has radio resource controls (RRCs) 216 and 226 and NAS protocols 217 and 237 at the top of the NR control plane protocol stack.

The NAS protocols 217 and 237 may provide control plane functionality between the UE 210 and the AMF 230 (e.g., the AMF 158A) or, more generally, between the UE 210 and the CN. The NAS protocols 217 and 237 may provide control plane functionality between the UE 210 and the AMF 230 via signaling messages, referred to as NAS messages. There is no direct path between the UE 210 and the AMF 230 through which the NAS messages can be transported. The NAS messages may be transported using the AS of the Uu and NG interfaces. NAS protocols 217 and 237 may provide control plane functionality such as authentication, security, connection setup, mobility management, and session management.

The RRCs 216 and 226 may provide control plane functionality between the UE 210 and the gNB 220 or, more generally, between the UE 210 and the RAN. The RRCs 216 and 226 may provide control plane functionality between the UE 210 and the gNB 220 via signaling messages, referred to as RRC messages. RRC messages may be transmitted between the UE 210 and the RAN using signaling radio bearers and the same/similar PDCP, RLC, MAC, and PHY protocol layers. The MAC may multiplex control-plane and user-plane data into the same transport block (TB). The RRCs 216 and 226 may provide control plane functionality such as: broadcast of system information related to AS and NAS; paging initiated by the CN or the RAN; establishment, maintenance and release of an RRC connection between the UE 210 and the RAN; security functions including key management; establishment, configuration, maintenance and release of signaling radio bearers and data radio bearers; mobility functions; QoS management functions; the UE measurement reporting and control of the reporting; detection of and recovery from radio link failure (RLF); and/or NAS message transfer. As part of establishing an RRC connection, RRCs 216 and 226 may establish an RRC context, which may involve configuring parameters for communication between the UE 210 and the RAN.

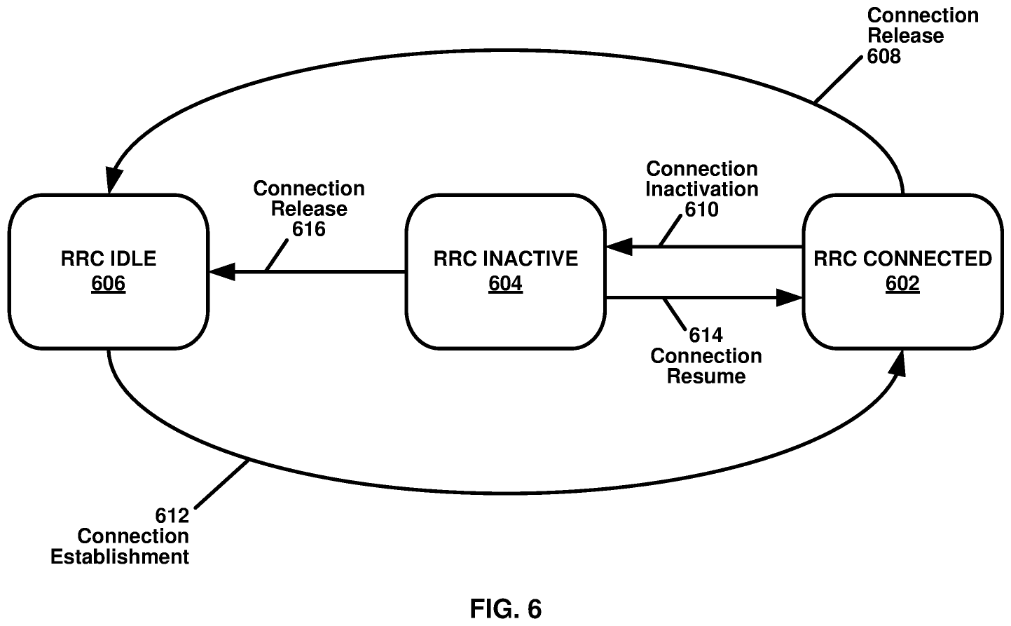

FIG. 6 is an example diagram showing RRC state transitions of a UE. The UE may be the same or similar to the wireless device 106 depicted in FIG. 1A, the UE 210 depicted in FIG. 2A and FIG. 2B, or any other wireless device described in the present disclosure. As illustrated in FIG. 6, a UE may be in at least one of three RRC states: RRC connected 602 (e.g., RRC_CONNECTED), RRC idle 604 (e.g., RRC_IDLE), and RRC inactive 606 (e.g., RRC_INACTIVE).

In RRC connected 602, the UE has an established RRC context and may have at least one RRC connection with a base station. The base station may be similar to one of the one or more base stations included in the RAN 104 depicted in FIG. 1A, one of the gNBs 160 or ng-eNBs 162 depicted in FIG. 1B, the gNB 220 depicted in FIG. 2A and FIG. 2B, or any other base station described in the present disclosure. The base station with which the UE is connected may have the RRC context for the UE. The RRC context, referred to as the UE context, may comprise parameters for communication between the UE and the base station. These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. While in RRC connected 602, mobility of the UE may be managed by the RAN (e.g., the RAN 104 or the NG-RAN 154). The UE may measure the signal levels (e.g., reference signal levels) from a serving cell and neighboring cells and report these measurements to the base station currently serving the UE. The UE's serving base station may request a handover to a cell of one of the neighboring base stations based on the reported measurements. The RRC state may transition from RRC connected 602 to RRC idle 604 through a connection release procedure 608 or to RRC inactive 606 through a connection inactivation procedure 610.

In RRC idle 604, an RRC context may not be established for the UE. In RRC idle 604, the UE may not have an RRC connection with the base station. While in RRC idle 604, the UE may be in a sleep state for the majority of the time (e.g., to conserve battery power). The UE may wake up periodically (e.g., once in every discontinuous reception cycle) to monitor for paging messages from the RAN. Mobility of the UE may be managed by the UE through a procedure known as cell reselection. The RRC state may transition from RRC idle 604 to RRC connected 602 through a connection establishment procedure 612, which may involve a random access procedure as discussed in greater detail below.

In RRC inactive 606, the RRC context previously established is maintained in the UE and the base station. This allows for a fast transition to RRC connected 602 with reduced signaling overhead as compared to the transition from RRC idle 604 to RRC connected 602. While in RRC inactive 606, the UE may be in a sleep state and mobility of the UE may be managed by the UE through cell reselection. The RRC state may transition from RRC inactive 606 to RRC connected 602 through a connection resume procedure 614 or to RRC idle 604 though a connection release procedure 616 that may be the same as or similar to connection release procedure 608.

An RRC state may be associated with a mobility management mechanism. In RRC idle 604 and RRC inactive 606, mobility is managed by the UE through cell reselection. The purpose of mobility management in RRC idle 604 and RRC inactive 606 is to allow the network to be able to notify the UE of an event via a paging message without having to broadcast the paging message over the entire mobile communications network. The mobility management mechanism used in RRC idle 604 and RRC inactive 606 may allow the network to track the UE on a cell-group level so that the paging message may be broadcast over the cells of the cell group that the UE currently resides within instead of the entire mobile communication network. The mobility management mechanisms for RRC idle 604 and RRC inactive 606 track the UE on a cell-group level. They may do so using different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN (e.g., the CN 102 or the 5G-CN 152) may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 606 state, the UE may be assigned a RAN notification area. A RAN notification area may comprise one or more cell identities, a list of RAIs, or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 606.

A gNB, such as gNBs 160 in FIG. 1B, may be split in two parts: a central unit (gNB-CU), and one or more distributed units (gNB-DU). A gNB-CU may be coupled to one or more gNB-DUs using an F1 interface. The gNB-CU may comprise the RRC, the PDCP, and the SDAP. A gNB-DU may comprise the RLC, the MAC, and the PHY.

In NR, the physical signals and physical channels (discussed with respect to FIG. 5A and FIG. 5B) may be mapped onto orthogonal frequency divisional multiplexing (OFDM) symbols. OFDM is a multicarrier communication scheme that transmits data over F orthogonal subcarriers (or tones). Before transmission, the data may be mapped to a series of complex symbols (e.g., M-quadrature amplitude modulation (M-QAM) or M-phase shift keying (M-PSK) symbols), referred to as source symbols, and divided into F parallel symbol streams. The F parallel symbol streams may be treated as though they are in the frequency domain and used as inputs to an Inverse Fast Fourier Transform (IFFT) block that transforms them into the time domain. The IFFT block may take in F source symbols at a time, one from each of the F parallel symbol streams, and use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. After some processing (e.g., addition of a cyclic prefix) and up-conversion, an OFDM symbol provided by the IFFT block may be transmitted over the air interface on a carrier frequency. The F parallel symbol streams may be mixed using an FFT block before being processed by the IFFT block. This operation produces Discrete Fourier Transform (DFT)-precoded OFDM symbols and may be used by UEs in the uplink to reduce the peak to average power ratio (PAPR). Inverse processing may be performed on the OFDM symbol at a receiver using an FFT block to recover the data mapped to the source symbols.

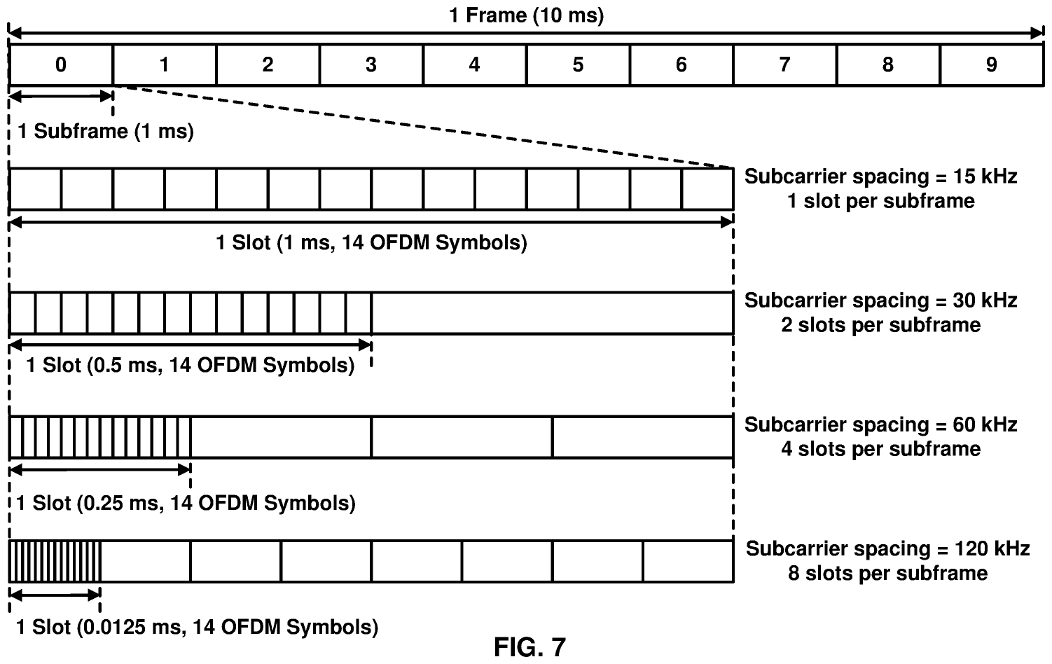

FIG. 7 illustrates an example configuration of an NR frame into which OFDM symbols are grouped. An NR frame may be identified by a system frame number (SFN). The SFN may repeat with a period of 1024 frames. As illustrated, one NR frame may be 10 milliseconds (ms) in duration and may include 10 subframes that are 1 ms in duration. A subframe may be divided into slots that include, for example, 14 OFDM symbols per slot.

The duration of a slot may depend on the numerology used for the OFDM symbols of the slot. In NR, a flexible numerology is supported to accommodate different cell deployments (e.g., cells with carrier frequencies below 1 GHz up to cells with carrier frequencies in the mm-wave range). A numerology may be defined in terms of subcarrier spacing and cyclic prefix duration. For a numerology in NR, subcarrier spacings may be scaled up by powers of two from a baseline subcarrier spacing of 15 kHz, and cyclic prefix durations may be scaled down by powers of two from a baseline cyclic prefix duration of 4.7 μs. For example, NR defines numerologies with the following subcarrier spacing/cyclic prefix duration combinations: 15 kHz/4.7 μs; 30 kHz/2.3 μs; 60 kHz/1.2 μs; 120 kHz/0.59 μs; and 240 kHz/0.29 μs.

A slot may have a fixed number of OFDM symbols (e.g., 14 OFDM symbols). A numerology with a higher subcarrier spacing has a shorter slot duration and, correspondingly, more slots per subframe. FIG. 7 illustrates this numerology-dependent slot duration and slots-per-subframe transmission structure (the numerology with a subcarrier spacing of 240 kHz is not shown in FIG. 7 for ease of illustration). A subframe in NR may be used as a numerology-independent time reference, while a slot may be used as the unit upon which uplink and downlink transmissions are scheduled. To support low latency, scheduling in NR may be decoupled from the slot duration and start at any OFDM symbol and last for as many symbols as needed for a transmission. These partial slot transmissions may be referred to as mini-slot or subslot transmissions.

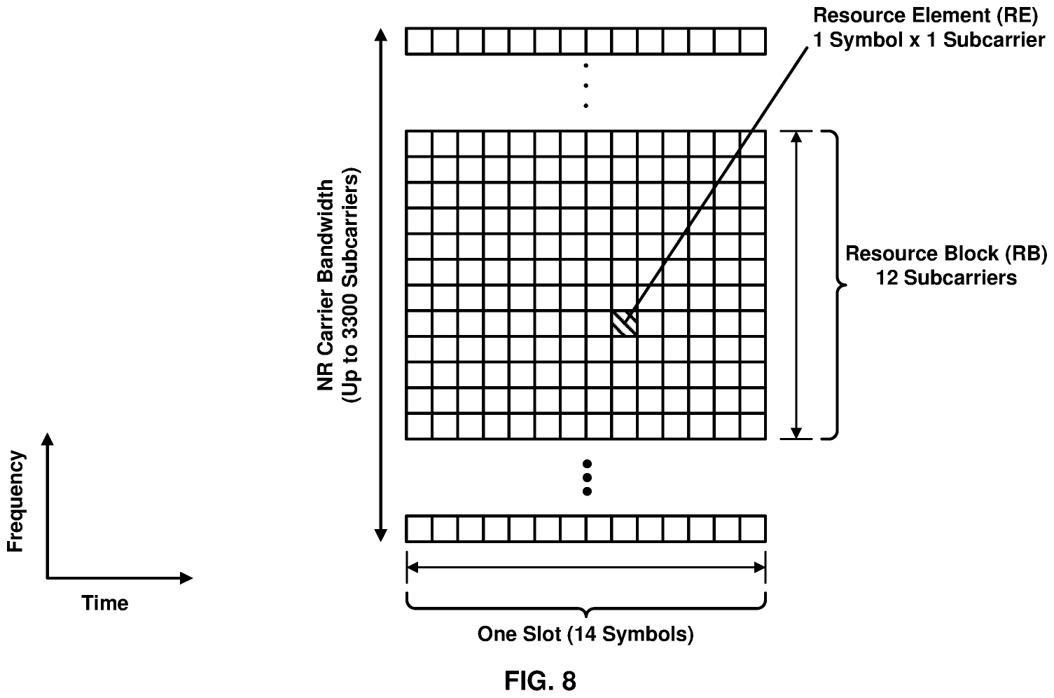

FIG. 8 illustrates an example configuration of a slot in the time and frequency domain for an NR carrier. The slot includes resource elements (REs) and resource blocks (RBs). An RE is the smallest physical resource in NR. An RE spans one OFDM symbol in the time domain by one subcarrier in the frequency domain as shown in FIG. 8. An RB spans twelve consecutive REs in the frequency domain as shown in FIG. 8. An NR carrier may be limited to a width of 275 RBs or 275×12=3300 subcarriers. Such a limitation, if used, may limit the NR carrier to 50, 100, 200, and 400 MHz for subcarrier spacings of 15, 30, 60, and 120 kHz, respectively, where the 400 MHz bandwidth may be set based on a 400 MHz per carrier bandwidth limit.

FIG. 8 illustrates a single numerology being used across the entire bandwidth of the NR carrier. In other example configurations, multiple numerologies may be supported on the same carrier.

NR may support wide carrier bandwidths (e.g., up to 400 MHz for a subcarrier spacing of 120 kHz). Not all UEs may be able to receive the full carrier bandwidth (e.g., due to hardware limitations). Also, receiving the full carrier bandwidth may be prohibitive in terms of UE power consumption. In an example, to reduce power consumption and/or for other purposes, a UE may adapt the size of the UE's receive bandwidth based on the amount of traffic the UE is scheduled to receive. This is referred to as bandwidth adaptation.

NR defines bandwidth parts (BWPs) to support UEs not capable of receiving the full carrier bandwidth and to support bandwidth adaptation. In an example, a BWP may be defined by a subset of contiguous RBs on a carrier. A UE may be configured (e.g., via RRC layer) with one or more downlink BWPs and one or more uplink BWPs per serving cell (e.g., up to four downlink BWPs and up to four uplink BWPs per serving cell). At a given time, one or more of the configured BWPs for a serving cell may be active. These one or more BWPs may be referred to as active BWPs of the serving cell. When a serving cell is configured with a secondary uplink carrier, the serving cell may have one or more first active BWPs in the uplink carrier and one or more second active BWPs in the secondary uplink carrier.

For unpaired spectra, a downlink BWP from a set of configured downlink BWPs may be linked with an uplink BWP from a set of configured uplink BWPs if a downlink BWP index of the downlink BWP and an uplink BWP index of the uplink BWP are the same. For unpaired spectra, a UE may expect that a center frequency for a downlink BWP is the same as a center frequency for an uplink BWP.

For a downlink BWP in a set of configured downlink BWPs on a primary cell (PCell), a base station may configure a UE with one or more control resource sets (CORESETs) for at least one search space. A search space is a set of locations in the time and frequency domains where the UE may find control information. The search space may be a UE-specific search space or a common search space (potentially usable by a plurality of UEs). For example, a base station may configure a UE with a common search space, on a PCell or on a primary secondary cell (PSCell), in an active downlink BWP.

For an uplink BWP in a set of configured uplink BWPs, a BS may configure a UE with one or more resource sets for one or more PUCCH transmissions. A UE may receive downlink receptions (e.g., PDCCH or PDSCH) in a downlink BWP according to a configured numerology (e.g., subcarrier spacing and cyclic prefix duration) for the downlink BWP. The UE may transmit uplink transmissions (e.g., PUCCH or PUSCH) in an uplink BWP according to a configured numerology (e.g., subcarrier spacing and cyclic prefix length for the uplink BWP).

One or more BWP indicator fields may be provided in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a UE with a default downlink BWP within a set of configured downlink BWPs associated with a PCell. If the base station does not provide the default downlink BWP to the UE, the default downlink BWP may be an initial active downlink BWP. The UE may determine which BWP is the initial active downlink BWP based on a CORESET configuration obtained using the PBCH.

A base station may configure a UE with a BWP inactivity timer value for a PCell. The UE may start or restart a BWP inactivity timer at any appropriate time. For example, the UE may start or restart the BWP inactivity timer (a) when the UE detects a DCI indicating an active downlink BWP other than a default downlink BWP for a paired spectra operation; or (b) when a UE detects a DCI indicating an active downlink BWP or active uplink BWP other than a default downlink BWP or uplink BWP for an unpaired spectra operation. If the UE does not detect DCI during an interval of time (e.g., 1 ms or 0.5 ms), the UE may run the BWP inactivity timer toward expiration (for example, increment from zero to the BWP inactivity timer value, or decrement from the BWP inactivity timer value to zero). When the BWP inactivity timer expires, the UE may switch from the active downlink BWP to the default downlink BWP.

In an example, a base station may semi-statically configure a UE with one or more BWPs. A UE may switch an active BWP from a first BWP to a second BWP in response to receiving a DCI indicating the second BWP as an active BWP and/or in response to an expiry of the BWP inactivity timer (e.g., if the second BWP is the default BWP).

Downlink and uplink BWP switching (where BWP switching refers to switching from a currently active BWP to a not currently active BWP) may be performed independently in paired spectra. In unpaired spectra, downlink and uplink BWP switching may be performed simultaneously. Switching between configured BWPs may occur based on RRC signaling, DCI, expiration of a BWP inactivity timer, and/or an initiation of random access.

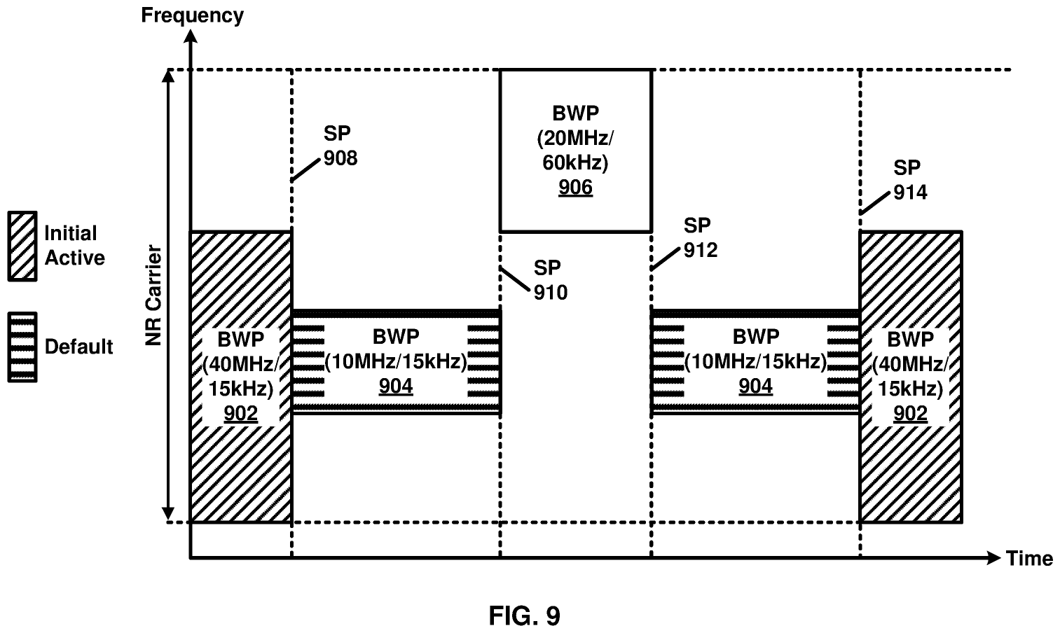

FIG. 9 illustrates an example of bandwidth adaptation using three configured BWPs for an NR carrier. A UE configured with the three BWPs may switch from one BWP to another BWP at a switching point. In the example illustrated in FIG. 9, the BWPs include: a BWP 902 with a bandwidth of 40 MHz and a subcarrier spacing of 15 kHz; a BWP 904 with a bandwidth of 10 MHz and a subcarrier spacing of 15 kHz; and a BWP 906 with a bandwidth of 20 MHz and a subcarrier spacing of 60 kHz. The BWP 902 may be an initial active BWP, and the BWP 904 may be a default BWP. The UE may switch between BWPs at switching points. In the example of FIG. 9, the UE may switch from the BWP 902 to the BWP 904 at a switching point 908. The switching at the switching point 908 may occur for any suitable reason, for example, in response to an expiry of a BWP inactivity timer (indicating switching to the default BWP) and/or in response to receiving a DCI indicating BWP 904 as the active BWP. The UE may switch at a switching point 910 from active BWP 904 to BWP 906 in response receiving a DCI indicating BWP 906 as the active BWP. The UE may switch at a switching point 912 from active BWP 906 to BWP 904 in response to an expiry of a BWP inactivity timer and/or in response receiving a DCI indicating BWP 904 as the active BWP. The UE may switch at a switching point 914 from active BWP 904 to BWP 902 in response receiving a DCI indicating BWP 902 as the active BWP.

If a UE is configured for a secondary cell with a default downlink BWP in a set of configured downlink BWPs and a timer value, UE procedures for switching BWPs on a secondary cell may be the same/similar as those on a primary cell. For example, the UE may use the timer value and the default downlink BWP for the secondary cell in the same/similar manner as the UE would use these values for a primary cell.

To provide for greater data rates, two or more carriers can be aggregated and simultaneously transmitted to/from the same UE using carrier aggregation (CA). The aggregated carriers in CA may be referred to as component carriers (CCs). When CA is used, there are a number of serving cells for the UE, one for a CC. The CCs may have three configurations in the frequency domain.

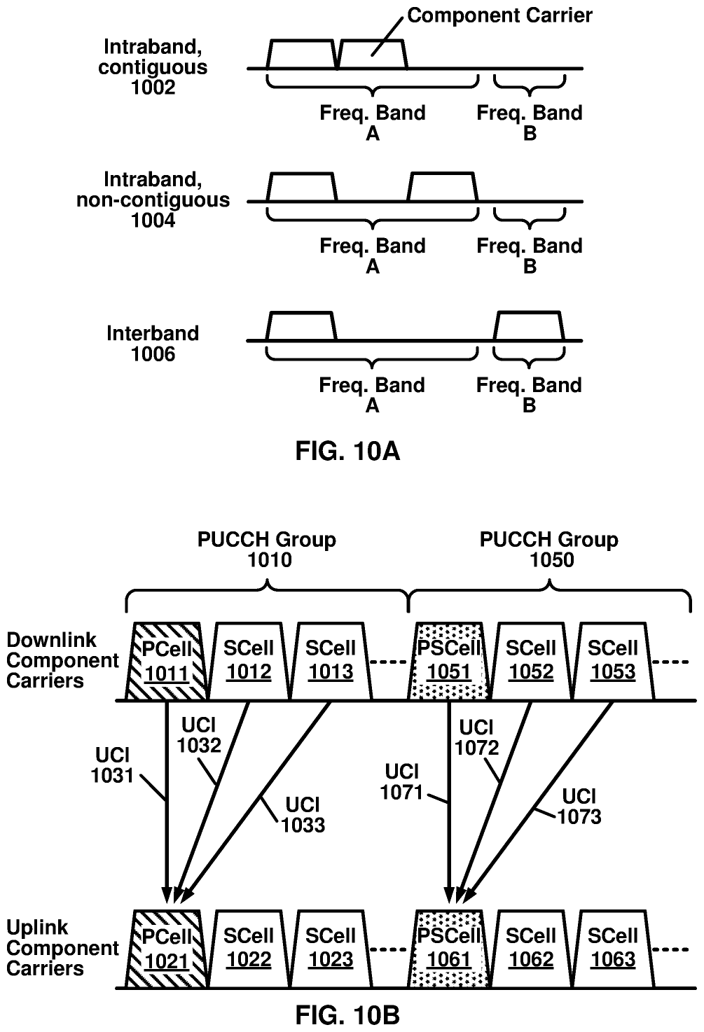

FIG. 10A illustrates the three CA configurations with two CCs. In the intraband, contiguous configuration 1002, the two CCs are aggregated in the same frequency band (frequency band A) and are located directly adjacent to each other within the frequency band. In the intraband, non-contiguous configuration 1004, the two CCs are aggregated in the same frequency band (frequency band A) and are separated in the frequency band by a gap. In the interband configuration 1006, the two CCs are located in frequency bands (frequency band A and frequency band B).

In an example, up to 32 CCs may be aggregated. The aggregated CCs may have the same or different bandwidths, subcarrier spacing, and/or duplexing schemes (TDD or FDD). A serving cell for a UE using CA may have a downlink CC. For FDD, one or more uplink CCs may be optionally configured for a serving cell. The ability to aggregate more downlink carriers than uplink carriers may be useful, for example, when the UE has more data traffic in the downlink than in the uplink.

When CA is used, one of the aggregated cells for a UE may be referred to as a primary cell (PCell). The PCell may be the serving cell that the UE initially connects to at RRC connection establishment, reestablishment, and/or handover. The PCell may provide the UE with NAS mobility information and the security input. UEs may have different PCells. In the downlink, the carrier corresponding to the PCell may be referred to as the downlink primary CC (DL PCC). In the uplink, the carrier corresponding to the PCell may be referred to as the uplink primary CC (UL PCC). The other aggregated cells for the UE may be referred to as secondary cells (SCells). In an example, the SCells may be configured after the PCell is configured for the UE. For example, an SCell may be configured through an RRC Connection Reconfiguration procedure. In the downlink, the carrier corresponding to an SCell may be referred to as a downlink secondary CC (DL SCC). In the uplink, the carrier corresponding to the SCell may be referred to as the uplink secondary CC (UL SCC).

Configured SCells for a UE may be activated and deactivated based on, for example, traffic and channel conditions. Deactivation of an SCell may mean that PDCCH and PDSCH reception on the SCell is stopped and PUSCH, SRS, and CQI transmissions on the SCell are stopped. Configured SCells may be activated and deactivated using a MAC CE with respect to FIG. 4B. For example, a MAC CE may use a bitmap (e.g., one bit per SCell) to indicate which SCells (e.g., in a subset of configured SCells) for the UE are activated or deactivated. Configured SCells may be deactivated in response to an expiration of an SCell deactivation timer (e.g., one SCell deactivation timer per SCell).

Downlink control information, such as scheduling assignments and scheduling grants, for a cell may be transmitted on the cell corresponding to the assignments and grants, which is known as self-scheduling. The DCI for the cell may be transmitted on another cell, which is known as cross-carrier scheduling. Uplink control information (e.g., HARQ acknowledgments and channel state feedback, such as CQI, PMI, and/or RI) for aggregated cells may be transmitted on the PUCCH of the PCell. For a larger number of aggregated downlink CCs, the PUCCH of the PCell may become overloaded. Cells may be divided into multiple PUCCH groups.

FIG. 10B illustrates an example of how aggregated cells may be configured into one or more PUCCH groups. A PUCCH group 1010 and a PUCCH group 1050 may include one or more downlink CCs, respectively. In the example of FIG. 10B, the PUCCH group 1010 includes three downlink CCs: a PCell 1011, an SCell 1012, and an SCell 1013. The PUCCH group 1050 includes three downlink CCs in the present example: a PCell 1051, an SCell 1052, and an SCell 1053. One or more uplink CCs may be configured as a PCell 1021, an SCell 1022, and an SCell 1023. One or more other uplink CCs may be configured as a primary Scell (PSCell) 1061, an SCell 1062, and an SCell 1063. Uplink control information (UCI) related to the downlink CCs of the PUCCH group 1010, shown as UCI 1031, UCI 1032, and UCI 1033, may be transmitted in the uplink of the PCell 1021. Uplink control information (UCI) related to the downlink CCs of the PUCCH group 1050, shown as UCI 1071, UCI 1072, and UCI 1073, may be transmitted in the uplink of the PSCell 1061. In an example, if the aggregated cells depicted in FIG. 10B were not divided into the PUCCH group 1010 and the PUCCH group 1050, a single uplink PCell to transmit UCI relating to the downlink CCs, and the PCell may become overloaded. By dividing transmissions of UCI between the PCell 1021 and the PSCell 1061, overloading may be prevented.

A cell, comprising a downlink carrier and optionally an uplink carrier, may be assigned with a physical cell ID and a cell index. The physical cell ID or the cell index may identify a downlink carrier and/or an uplink carrier of the cell, for example, depending on the context in which the physical cell ID is used. A physical cell ID may be determined using a synchronization signal transmitted on a downlink component carrier. A cell index may be determined using RRC messages. In the disclosure, a physical cell ID may be referred to as a carrier ID, and a cell index may be referred to as a carrier index. For example, when the disclosure refers to a first physical cell ID for a first downlink carrier, the disclosure may mean the first physical cell ID is for a cell comprising the first downlink carrier. The same/similar concept may apply to, for example, a carrier activation. When the disclosure indicates that a first carrier is activated, the specification may mean that a cell comprising the first carrier is activated.

In CA, a multi-carrier nature of a PHY may be exposed to a MAC. In an example, a HARQ entity may operate on a serving cell. A transport block may be generated per assignment/grant per serving cell. A transport block and potential HARQ retransmissions of the transport block may be mapped to a serving cell.

In the downlink, a base station may transmit (e.g., unicast, multicast, and/or broadcast) one or more Reference Signals (RSs) to a UE (e.g., PSS, SSS, CSI-RS, DMRS, and/or PT-RS, as shown in FIG. 5A). In the uplink, the UE may transmit one or more RSs to the base station (e.g., DMRS, PT-RS, and/or SRS, as shown in FIG. 5B). The PSS and the SSS may be transmitted by the base station and used by the UE to synchronize the UE to the base station. The PSS and the SSS may be provided in a synchronization signal (SS)/physical broadcast channel (PBCH) block that includes the PSS, the SSS, and the PBCH. The base station may periodically transmit a burst of SS/PBCH blocks.

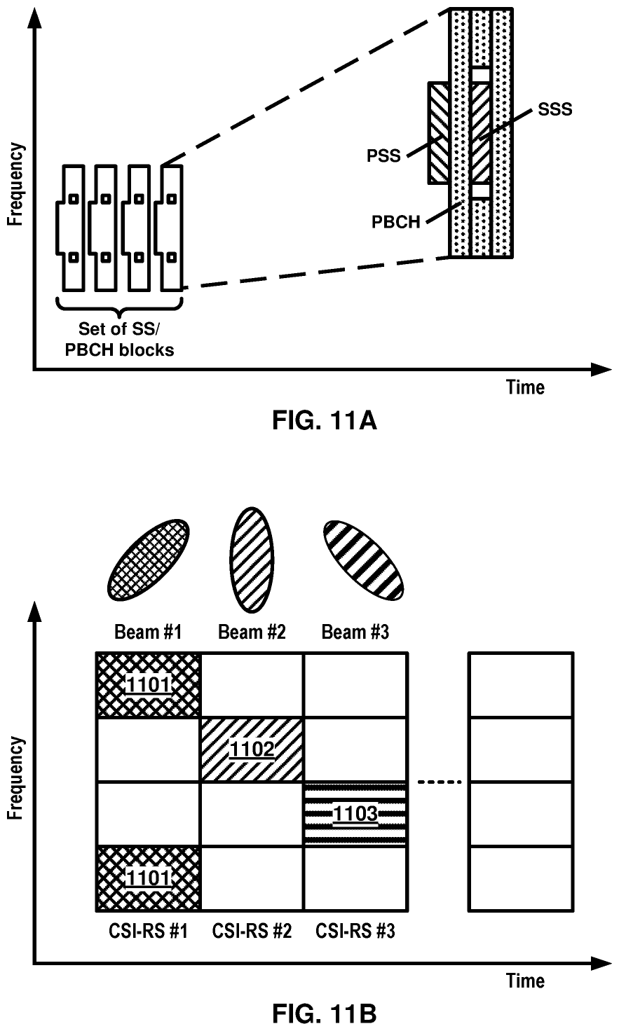

FIG. 11A illustrates an example of an SS/PBCH block's structure and location. A burst of SS/PBCH blocks may include one or more SS/PBCH blocks (e.g., 4 SS/PBCH blocks, as shown in FIG. 11A). Bursts may be transmitted periodically (e.g., every 2 frames or 20 ms). A burst may be restricted to a half-frame (e.g., a first half-frame having a duration of 5 ms). It will be understood that FIG. 11A is an example, and that these parameters (number of SS/PBCH blocks per burst, periodicity of bursts, position of burst within the frame) may be configured based on, for example: a carrier frequency of a cell in which the SS/PBCH block is transmitted; a numerology or subcarrier spacing of the cell; a configuration by the network (e.g., using RRC signaling); or any other suitable factor. In an example, the UE may assume a subcarrier spacing for the SS/PBCH block based on the carrier frequency being monitored, unless the radio network configured the UE to assume a different subcarrier spacing.

The SS/PBCH block may span one or more OFDM symbols in the time domain (e.g., 4 OFDM symbols, as shown in the example of FIG. 11A) and may span one or more subcarriers in the frequency domain (e.g., 240 contiguous subcarriers). The PSS, the SSS, and the PBCH may have a common center frequency. The PSS may be transmitted first and may span, for example, 1 OFDM symbol and 127 subcarriers. The SSS may be transmitted after the PSS (e.g., two symbols later) and may span 1 OFDM symbol and 127 subcarriers. The PBCH may be transmitted after the PSS (e.g., across the next 3 OFDM symbols) and may span 240 subcarriers.

The location of the SS/PBCH block in the time and frequency domains may not be known to the UE (e.g., if the UE is searching for the cell). To find and select the cell, the UE may monitor a carrier for the PSS. For example, the UE may monitor a frequency location within the carrier. If the PSS is not found after a certain duration (e.g., 20 ms), the UE may search for the PSS at a different frequency location within the carrier, as indicated by a synchronization raster. If the PSS is found at a location in the time and frequency domains, the UE may determine, based on a known structure of the SS/PBCH block, the locations of the SSS and the PBCH, respectively. The SS/PBCH block may be a cell-defining SS block (CD-SSB). In an example, a primary cell may be associated with a CD-SSB. The CD-SSB may be located on a synchronization raster. In an example, a cell selection/search and/or reselection may be based on the CD-SSB.

The SS/PBCH block may be used by the UE to determine one or more parameters of the cell. For example, the UE may determine a physical cell identifier (PCI) of the cell based on the sequences of the PSS and the SSS, respectively. The UE may determine a location of a frame boundary of the cell based on the location of the SS/PBCH block. For example, the SS/PBCH block may indicate that it has been transmitted in accordance with a transmission pattern, wherein a SS/PBCH block in the transmission pattern is a known distance from the frame boundary.

The PBCH may use a QPSK modulation and may use forward error correction (FEC). The FEC may use polar coding. One or more symbols spanned by the PBCH may carry one or more DMRSs for demodulation of the PBCH. The PBCH may include an indication of a current system frame number (SFN) of the cell and/or a SS/PBCH block timing index. These parameters may facilitate time synchronization of the UE to the base station. The PBCH may include a master information block (MIB) used to provide the UE with one or more parameters. The MIB may be used by the UE to locate remaining minimum system information (RMSI) associated with the cell. The RMSI may include a System Information Block Type 1 (SIB1). The SIB1 may contain information needed by the UE to access the cell. The UE may use one or more parameters of the MIB to monitor PDCCH, which may be used to schedule PDSCH. The PDSCH may include the SIB1. The SIB1 may be decoded using parameters provided in the MIB. The PBCH may indicate an absence of SIB1. Based on the PBCH indicating the absence of SIB1, the UE may be pointed to a frequency. The UE may search for an SS/PBCH block at the frequency to which the UE is pointed.

The UE may assume that one or more SS/PBCH blocks transmitted with a same SS/PBCH block index are quasi co-located (QCLed) (e.g., having the same/similar Doppler spread, Doppler shift, average gain, average delay, and/or spatial Rx parameters). The UE may not assume QCL for SS/PBCH block transmissions having different SS/PBCH block indices.

SS/PBCH blocks (e.g., those within a half-frame) may be transmitted in spatial directions (e.g., using different beams that span a coverage area of the cell). In an example, a first SS/PBCH block may be transmitted in a first spatial direction using a first beam, and a second SS/PBCH block may be transmitted in a second spatial direction using a second beam.

In an example, within a frequency span of a carrier, a base station may transmit a plurality of SS/PBCH blocks. In an example, a first PCI of a first SS/PBCH block of the plurality of SS/PBCH blocks may be different from a second PCI of a second SS/PBCH block of the plurality of SS/PBCH blocks. The PCIs of SS/PBCH blocks transmitted in different frequency locations may be different or the same.

The CSI-RS may be transmitted by the base station and used by the UE to acquire channel state information (CSI). The base station may configure the UE with one or more CSI-RSs for channel estimation or any other suitable purpose. The base station may configure a UE with one or more of the same/similar CSI-RSs. The UE may measure the one or more CSI-RSs. The UE may estimate a downlink channel state and/or generate a CSI report based on the measuring of the one or more downlink CSI-RSs. The UE may provide the CSI report to the base station. The base station may use feedback provided by the UE (e.g., the estimated downlink channel state) to perform link adaptation.

The base station may semi-statically configure the UE with one or more CSI-RS resource sets. A CSI-RS resource may be associated with a location in the time and frequency domains and a periodicity. The base station may selectively activate and/or deactivate a CSI-RS resource. The base station may indicate to the UE that a CSI-RS resource in the CSI-RS resource set is activated and/or deactivated.

The base station may configure the UE to report CSI measurements. The base station may configure the UE to provide CSI reports periodically, aperiodically, or semi-persistently. For periodic CSI reporting, the UE may be configured with a timing and/or periodicity of a plurality of CSI reports. For aperiodic CSI reporting, the base station may request a CSI report. For example, the base station may command the UE to measure a configured CSI-RS resource and provide a CSI report relating to the measurements. For semi-persistent CSI reporting, the base station may configure the UE to transmit periodically, and selectively activate or deactivate the periodic reporting. The base station may configure the UE with a CSI-RS resource set and CSI reports using RRC signaling.

The CSI-RS configuration may comprise one or more parameters indicating, for example, up to 32 antenna ports. The UE may be configured to employ the same OFDM symbols for a downlink CSI-RS and a control resource set (CORESET) when the downlink CSI-RS and CORESET are spatially QCLed and resource elements associated with the downlink CSI-RS are outside of the physical resource blocks (PRBs) configured for the CORESET. The UE may be configured to employ the same OFDM symbols for downlink CSI-RS and SS/PBCH blocks when the downlink CSI-RS and SS/PBCH blocks are spatially QCLed and resource elements associated with the downlink CSI-RS are outside of PRBs configured for the SS/PBCH blocks.

Downlink DMRSs may be transmitted by a base station and used by a UE for channel estimation. For example, the downlink DMRS may be used for coherent demodulation of one or more downlink physical channels (e.g., PDSCH). An NR network may support one or more variable and/or configurable DMRS patterns for data demodulation. At least one downlink DMRS configuration may support a front-loaded DMRS pattern. A front-loaded DMRS may be mapped over one or more OFDM symbols (e.g., one or two adjacent OFDM symbols). A base station may semi-statically configure the UE with a number (e.g. a maximum number) of front-loaded DMRS symbols for PDSCH. A DMRS configuration may support one or more DMRS ports. For example, for single user-MIMO, a DMRS configuration may support up to eight orthogonal downlink DMRS ports per UE. For multiuser-MIMO, a DMRS configuration may support up to 4 orthogonal downlink DMRS ports per UE. A radio network may support (e.g., at least for CP-OFDM) a common DMRS structure for downlink and uplink, wherein a DMRS location, a DMRS pattern, and/or a scrambling sequence may be the same or different. The base station may transmit a downlink DMRS and a corresponding PDSCH using the same precoding matrix. The UE may use the one or more downlink DMRSs for coherent demodulation/channel estimation of the PDSCH.

In an example, a transmitter (e.g., a base station) may use a precoder matrices for a part of a transmission bandwidth. For example, the transmitter may use a first precoder matrix for a first bandwidth and a second precoder matrix for a second bandwidth. The first precoder matrix and the second precoder matrix may be different based on the first bandwidth being different from the second bandwidth. The UE may assume that a same precoding matrix is used across a set of PRBs. The set of PRBs may be denoted as a precoding resource block group (PRG).

A PDSCH may comprise one or more layers. The UE may assume that at least one symbol with DMRS is present on a layer of the one or more layers of the PDSCH. A higher layer may configure up to 3 DMRSs for the PDSCH.

Downlink PT-RS may be transmitted by a base station and used by a UE for phase-noise compensation. Whether a downlink PT-RS is present or not may depend on an RRC configuration. The presence and/or pattern of the downlink PT-RS may be configured on a UE-specific basis using a combination of RRC signaling and/or an association with one or more parameters employed for other purposes (e.g., modulation and coding scheme (MCS)), which may be indicated by DCI. When configured, a dynamic presence of a downlink PT-RS may be associated with one or more DCI parameters comprising at least MCS. An NR network may support a plurality of PT-RS densities defined in the time and/or frequency domains. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. Downlink PT-RS may be confined in the scheduled time/frequency duration for the UE. Downlink PT-RS may be transmitted on symbols to facilitate phase tracking at the receiver.

The UE may transmit an uplink DMRS to a base station for channel estimation. For example, the base station may use the uplink DMRS for coherent demodulation of one or more uplink physical channels. For example, the UE may transmit an uplink DMRS with a PUSCH and/or a PUCCH. The uplink DM-RS may span a range of frequencies that is similar to a range of frequencies associated with the corresponding physical channel. The base station may configure the UE with one or more uplink DMRS configurations. At least one DMRS configuration may support a front-loaded DMRS pattern. The front-loaded DMRS may be mapped over one or more OFDM symbols (e.g., one or two adjacent OFDM symbols). One or more uplink DMRSs may be configured to transmit at one or more symbols of a PUSCH and/or a PUCCH. The base station may semi-statically configure the UE with a number (e.g. maximum number) of front-loaded DMRS symbols for the PUSCH and/or the PUCCH, which the UE may use to schedule a single-symbol DMRS and/or a double-symbol DMRS. An NR network may support (e.g., for cyclic prefix orthogonal frequency division multiplexing (CP-OFDM)) a common DMRS structure for downlink and uplink, wherein a DMRS location, a DMRS pattern, and/or a scrambling sequence for the DMRS may be the same or different.

A PUSCH may comprise one or more layers, and the UE may transmit at least one symbol with DMRS present on a layer of the one or more layers of the PUSCH. In an example, a higher layer may configure up to three DMRSs for the PUSCH.

Uplink PT-RS (which may be used by a base station for phase tracking and/or phase-noise compensation) may or may not be present depending on an RRC configuration of the UE. The presence and/or pattern of uplink PT-RS may be configured on a UE-specific basis by a combination of RRC signaling and/or one or more parameters employed for other purposes (e.g., Modulation and Coding Scheme (MCS)), which may be indicated by DCI. When configured, a dynamic presence of uplink PT-RS may be associated with one or more DCI parameters comprising at least MCS. A radio network may support a plurality of uplink PT-RS densities defined in time/frequency domain. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. For example, uplink PT-RS may be confined in the scheduled time/frequency duration for the UE.

SRS may be transmitted by a UE to a base station for channel state estimation to support uplink channel dependent scheduling and/or link adaptation. SRS transmitted by the UE may allow a base station to estimate an uplink channel state at one or more frequencies. A scheduler at the base station may employ the estimated uplink channel state to assign one or more resource blocks for an uplink PUSCH transmission from the UE. The base station may semi-statically configure the UE with one or more SRS resource sets. For an SRS resource set, the base station may configure the UE with one or more SRS resources. An SRS resource set applicability may be configured by a higher layer (e.g., RRC) parameter. For example, when a higher layer parameter indicates beam management, an SRS resource in a SRS resource set of the one or more SRS resource sets (e.g., with the same/similar time domain behavior, periodic, aperiodic, and/or the like) may be transmitted at a time instant (e.g., simultaneously). The UE may transmit one or more SRS resources in SRS resource sets. An NR network may support aperiodic, periodic and/or semi-persistent SRS transmissions. The UE may transmit SRS resources based on one or more trigger types, wherein the one or more trigger types may comprise higher layer signaling (e.g., RRC) and/or one or more DCI formats. In an example, at least one DCI format may be employed for the UE to select at least one of one or more configured SRS resource sets. An SRS trigger type 0 may refer to an SRS triggered based on a higher layer signaling. An SRS trigger type 1 may refer to an SRS triggered based on one or more DCI formats. In an example, when PUSCH and SRS are transmitted in a same slot, the UE may be configured to transmit SRS after a transmission of a PUSCH and a corresponding uplink DMRS.

The base station may semi-statically configure the UE with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port is defined such that the channel over which a symbol on the antenna port is conveyed can be inferred from the channel over which another symbol on the same antenna port is conveyed. If a first symbol and a second symbol are transmitted on the same antenna port, the receiver may infer the channel (e.g., fading gain, multipath delay, and/or the like) for conveying the second symbol on the antenna port, from the channel for conveying the first symbol on the antenna port. A first antenna port and a second antenna port may be referred to as quasi co-located (QCLed) if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming require beam management. Beam management may comprise beam measurement, beam selection, and beam indication. A beam may be associated with one or more reference signals. For example, a beam may be identified by one or more beamformed reference signals. The UE may perform downlink beam measurement based on downlink reference signals (e.g., a channel state information reference signal (CSI-RS)) and generate a beam measurement report. The UE may perform the downlink beam measurement procedure after an RRC connection is set up with a base station.

FIG. 11B illustrates an example of channel state information reference signals (CSI-RSs) that are mapped in the time and frequency domains. A square shown in FIG. 11B may span a resource block (RB) within a bandwidth of a cell. A base station may transmit one or more RRC messages comprising CSI-RS resource configuration parameters indicating one or more CSI-RSs. One or more of the following parameters may be configured by higher layer signaling (e.g., RRC and/or MAC signaling) for a CSI-RS resource configuration: a CSI-RS resource configuration identity, a number of CSI-RS ports, a CSI-RS configuration (e.g., symbol and resource element (RE) locations in a subframe), a CSI-RS subframe configuration (e.g., subframe location, offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

The three beams illustrated in FIG. 11B may be configured for a UE in a UE-specific configuration. Three beams are illustrated in FIG. 11B (beam #1, beam #2, and beam #3), more or fewer beams may be configured. Beam #1 may be allocated with CSI-RS 1101 that may be transmitted in one or more subcarriers in an RB of a first symbol. Beam #2 may be allocated with CSI-RS 1102 that may be transmitted in one or more subcarriers in an RB of a second symbol. Beam #3 may be allocated with CSI-RS 1103 that may be transmitted in one or more subcarriers in an RB of a third symbol. By using frequency division multiplexing (FDM), a base station may use other subcarriers in a same RB (for example, those that are not used to transmit CSI-RS 1101) to transmit another CSI-RS associated with a beam for another UE. By using time domain multiplexing (TDM), beams used for the UE may be configured such that beams for the UE use symbols from beams of other UEs.

CSI-RSs such as those illustrated in FIG. 11B (e.g., CSI-RS 1101, 1102, 1103) may be transmitted by the base station and used by the UE for one or more measurements. For example, the UE may measure a reference signal received power (RSRP) of configured CSI-RS resources. The base station may configure the UE with a reporting configuration and the UE may report the RSRP measurements to a network (for example, via one or more base stations) based on the reporting configuration. In an example, the base station may determine, based on the reported measurement results, one or more transmission configuration indication (TCI) states comprising a number of reference signals. In an example, the base station may indicate one or more TCI states to the UE (e.g., via RRC signaling, a MAC CE, and/or a DCI). The UE may receive a downlink transmission with a receive (Rx) beam determined based on the one or more TCI states. In an example, the UE may or may not have a capability of beam correspondence. If the UE has the capability of beam correspondence, the UE may determine a spatial domain filter of a transmit (Tx) beam based on a spatial domain filter of the corresponding Rx beam. If the UE does not have the capability of beam correspondence, the UE may perform an uplink beam selection procedure to determine the spatial domain filter of the Tx beam. The UE may perform the uplink beam selection procedure based on one or more sounding reference signal (SRS) resources configured to the UE by the base station. The base station may select and indicate uplink beams for the UE based on measurements of the one or more SRS resources transmitted by the UE.

In a beam management procedure, a UE may assess (e.g., measure) a channel quality of one or more beam pair links, a beam pair link comprising a transmitting beam transmitted by a base station and a receiving beam received by the UE. Based on the assessment, the UE may transmit a beam measurement report indicating one or more beam pair quality parameters comprising, e.g., one or more beam identifications (e.g., a beam index, a reference signal index, or the like), RSRP, a precoding matrix indicator (PMI), a channel quality indicator (CQI), and/or a rank indicator (RI).

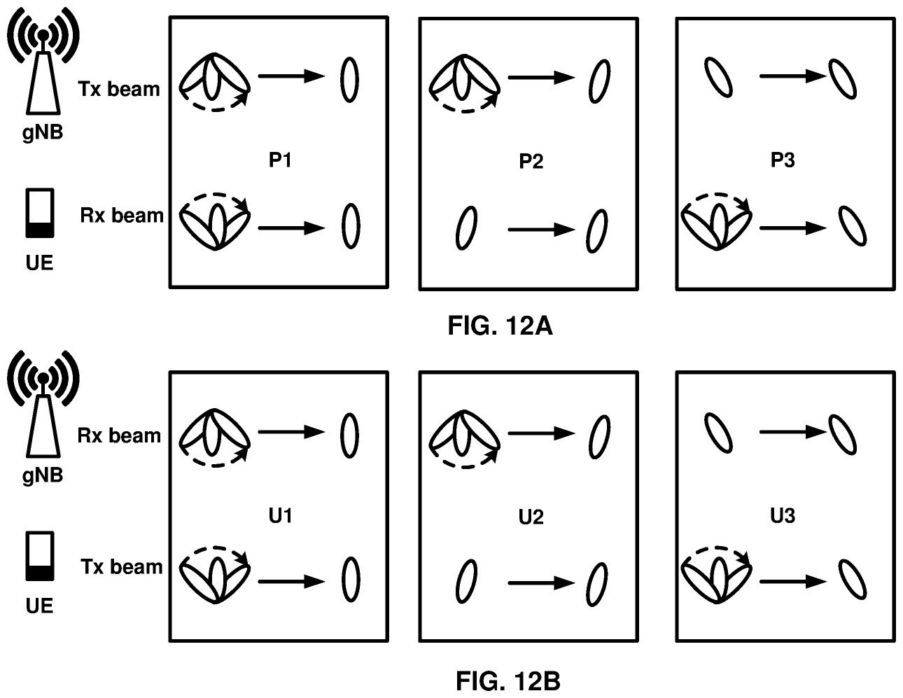

FIG. 12A illustrates examples of three downlink beam management procedures: P1, P2, and P3. Procedure P1 may enable a UE measurement on transmit (Tx) beams of a transmission reception point (TRP) (or multiple TRPs), e.g., to support a selection of one or more base station Tx beams and/or UE Rx beams (shown as ovals in the top row and bottom row, respectively, of P1). Beamforming at a TRP may comprise a Tx beam sweep for a set of beams (shown, in the top rows of P1 and P2, as ovals rotated in a counter-clockwise direction indicated by the dashed arrow). Beamforming at a UE may comprise an Rx beam sweep for a set of beams (shown, in the bottom rows of P1 and P3, as ovals rotated in a clockwise direction indicated by the dashed arrow). Procedure P2 may be used to enable a UE measurement on Tx beams of a TRP (shown, in the top row of P2, as ovals rotated in a counter-clockwise direction indicated by the dashed arrow). The UE and/or the base station may perform procedure P2 using a smaller set of beams than is used in procedure P1, or using narrower beams than the beams used in procedure P1. This may be referred to as beam refinement. The UE may perform procedure P3 for Rx beam determination by using the same Tx beam at the base station and sweeping an Rx beam at the UE.

FIG. 12B illustrates examples of three uplink beam management procedures: U1, U2, and U3. Procedure U1 may be used to enable a base station to perform a measurement on Tx beams of a UE, e.g., to support a selection of one or more UE Tx beams and/or base station Rx beams (shown as ovals in the top row and bottom row, respectively, of U1). Beamforming at the UE may include, e.g., a Tx beam sweep from a set of beams (shown in the bottom rows of U1 and U3 as ovals rotated in a clockwise direction indicated by the dashed arrow). Beamforming at the base station may include, e.g., an Rx beam sweep from a set of beams (shown, in the top rows of U1 and U2, as ovals rotated in a counter-clockwise direction indicated by the dashed arrow). Procedure U2 may be used to enable the base station to adjust its Rx beam when the UE uses a fixed Tx beam. The UE and/or the base station may perform procedure U2 using a smaller set of beams than is used in procedure P1, or using narrower beams than the beams used in procedure P1. This may be referred to as beam refinement The UE may perform procedure U3 to adjust its Tx beam when the base station uses a fixed Rx beam.

A UE may initiate a beam failure recovery (BFR) procedure based on detecting a beam failure. The UE may transmit a BFR request (e.g., a preamble, a UCI, an SR, a MAC CE, and/or the like) based on the initiating of the BFR procedure. The UE may detect the beam failure based on a determination that a quality of beam pair link(s) of an associated control channel is unsatisfactory (e.g., having an error rate higher than an error rate threshold, a received signal power lower than a received signal power threshold, an expiration of a timer, and/or the like).

The UE may measure a quality of a beam pair link using one or more reference signals (RSs) comprising one or more SS/PBCH blocks, one or more CSI-RS resources, and/or one or more demodulation reference signals (DMRSs). A quality of the beam pair link may be based on one or more of a block error rate (BLER), an RSRP value, a signal to interference plus noise ratio (SINR) value, a reference signal received quality (RSRQ) value, and/or a CSI value measured on RS resources. The base station may indicate that an RS resource is quasi co-located (QCLed) with one or more DM-RSs of a channel (e.g., a control channel, a shared data channel, and/or the like). The RS resource and the one or more DMRSs of the channel may be QCLed when the channel characteristics (e.g., Doppler shift, Doppler spread, average delay, delay spread, spatial Rx parameter, fading, and/or the like) from a transmission via the RS resource to the UE are similar or the same as the channel characteristics from a transmission via the channel to the UE.

A network (e.g., a gNB and/or an ng-eNB of a network) and/or the UE may initiate a random access procedure. A UE in an RRC_IDLE state and/or an RRC_INACTIVE state may initiate the random access procedure to request a connection setup to a network. The UE may initiate the random access procedure from an RRC_CONNECTED state. The UE may initiate the random access procedure to request uplink resources (e.g., for uplink transmission of an SR when there is no PUCCH resource available) and/or acquire uplink timing (e.g., when uplink synchronization status is non-synchronized). The UE may initiate the random access procedure to request one or more system information blocks (SIBs) (e.g., other system information such as SIB2, SIB3, and/or the like). The UE may initiate the random access procedure for a beam failure recovery request. A network may initiate a random access procedure for a handover and/or for establishing time alignment for an SCell addition.

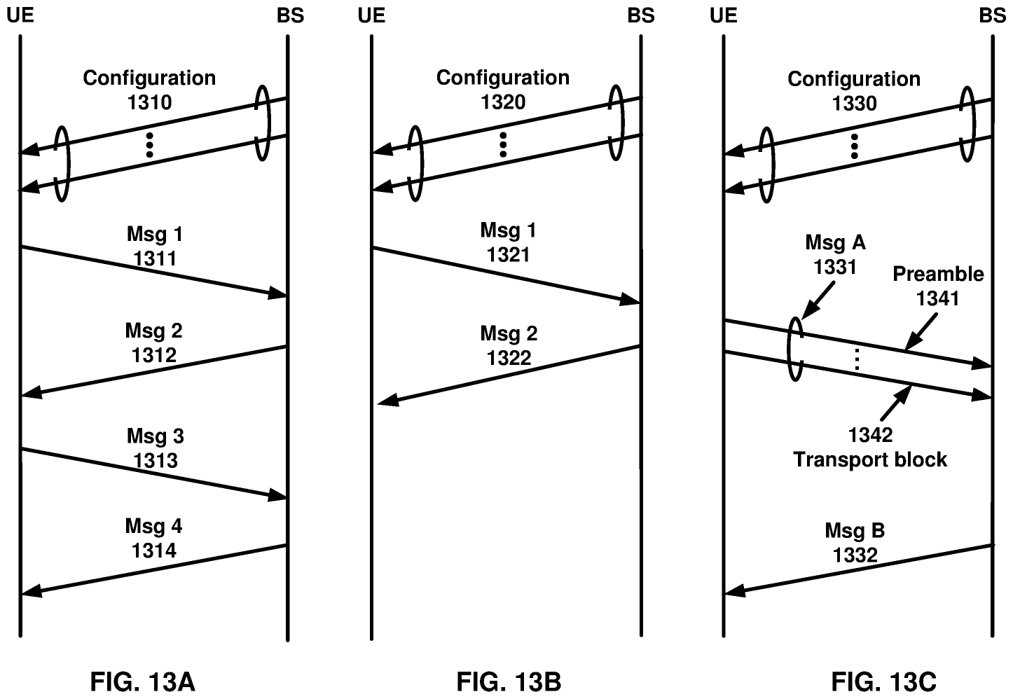

FIG. 13A illustrates a four-step contention-based random access procedure. Prior to initiation of the procedure, a base station may transmit a configuration message 1310 to the UE. The procedure illustrated in FIG. 13A comprises transmission of four messages: a Msg 1 1311, a Msg 2 1312, a Msg 3 1313, and a Msg 4 1314. The Msg 1 1311 may include and/or be referred to as a preamble (or a random access preamble). The Msg 2 1312 may include and/or be referred to as a random access response (RAR).

The configuration message 1310 may be transmitted, for example, using one or more RRC messages. The one or more RRC messages may indicate one or more random access channel (RACH) parameters to the UE. The one or more RACH parameters may comprise at least one of following: general parameters for one or more random access procedures (e.g., RACH-configGeneral); cell-specific parameters (e.g., RACH-ConfigCommon); and/or dedicated parameters (e.g., RACH-configDedicated). The base station may broadcast or multicast the one or more RRC messages to one or more UEs. The one or more RRC messages may be UE-specific (e.g., dedicated RRC messages transmitted to a UE in an RRC_CONNECTED state and/or in an RRC_INACTIVE state). The UE may determine, based on the one or more RACH parameters, a time-frequency resource and/or an uplink transmit power for transmission of the Msg 1 1311 and/or the Msg 3 1313. Based on the one or more RACH parameters, the UE may determine a reception timing and a downlink channel for receiving the Msg 2 1312 and the Msg 4 1314.

The one or more RACH parameters provided in the configuration message 1310 may indicate one or more Physical RACH (PRACH) occasions available for transmission of the Msg 1 1311. The one or more PRACH occasions may be predefined. The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. For example, the one or more RACH parameters may indicate a number of SS/PBCH blocks mapped to a PRACH occasion and/or a number of preambles mapped to a SS/PBCH blocks.

The one or more RACH parameters provided in the configuration message 1310 may be used to determine an uplink transmit power of Msg 1 1311 and/or Msg 3 1313. For example, the one or more RACH parameters may indicate a reference power for a preamble transmission (e.g., a received target power and/or an initial power of the preamble transmission). There may be one or more power offsets indicated by the one or more RACH parameters. For example, the one or more RACH parameters may indicate: a power ramping step; a power offset between SSB and CSI-RS; a power offset between transmissions of the Msg 1 1311 and the Msg 3 1313; and/or a power offset value between preamble groups. The one or more RACH parameters may indicate one or more thresholds based on which the UE may determine at least one reference signal (e.g., an SSB and/or CSI-RS) and/or an uplink carrier (e.g., a normal uplink (NUL) carrier and/or a supplemental uplink (SUL) carrier).

The Msg 1 1311 may include one or more preamble transmissions (e.g., a preamble transmission and one or more preamble retransmissions). An RRC message may be used to configure one or more preamble groups (e.g., group A and/or group B). A preamble group may comprise one or more preambles. The UE may determine the preamble group based on a pathloss measurement and/or a size of the Msg 3 1313. The UE may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The UE may select at least one preamble associated with the one or more reference signals and/or a selected preamble group, for example, if the association between the one or more preambles and the at least one reference signal is configured by an RRC message.

The UE may determine the preamble based on the one or more RACH parameters provided in the configuration message 1310. For example, the UE may determine the preamble based on a pathloss measurement, an RSRP measurement, and/or a size of the Msg 3 1313. As another example, the one or more RACH parameters may indicate: a preamble format; a maximum number of preamble transmissions; and/or one or more thresholds for determining one or more preamble groups (e.g., group A and group B). A base station may use the one or more RACH parameters to configure the UE with an association between one or more preambles and one or more reference signals (e.g., SSBs and/or CSI-RSs). If the association is configured, the UE may determine the preamble to include in Msg 1 1311 based on the association. The Msg 1 1311 may be transmitted to the base station via one or more PRACH occasions. The UE may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The UE may perform a preamble retransmission if no response is received following a preamble transmission. The UE may increase an uplink transmit power for the preamble retransmission. The UE may select an initial preamble transmit power based on a pathloss measurement and/or a target received preamble power configured by the network. The UE may determine to retransmit a preamble and may ramp up the uplink transmit power. The UE may receive one or more RACH parameters (e.g., PREAMBLE_POWER_RAMPING_STEP) indicating a ramping step for the preamble retransmission. The ramping step may be an amount of incremental increase in uplink transmit power for a retransmission. The UE may ramp up the uplink transmit power if the UE determines a reference signal (e.g., SSB and/or CSI-RS) that is the same as a previous preamble transmission. The UE may count a number of preamble transmissions and/or retransmissions (e.g., PREAMBLE_TRANSMISSION_COUNTER). The UE may determine that a random access procedure completed unsuccessfully, for example, if the number of preamble transmissions exceeds a threshold configured by the one or more RACH parameters (e.g., preambleTransMax).

The Msg 2 1312 received by the UE may include an RAR. In some scenarios, the Msg 2 1312 may include multiple RARs corresponding to multiple UEs. The Msg 2 1312 may be received after or in response to the transmitting of the Msg 1 1311. The Msg 2 1312 may be scheduled on the DL-SCH and indicated on a PDCCH using a random access RNTI (RA-RNTI). The Msg 2 1312 may indicate that the Msg 1 1311 was received by the base station. The Msg 2 1312 may include a time-alignment command that may be used by the UE to adjust the UE's transmission timing, a scheduling grant for transmission of the Msg 3 1313, and/or a Temporary Cell RNTI (TC-RNTI). After transmitting a preamble, the UE may start a time window (e.g., ra-ResponseWindow) to monitor a PDCCH for the Msg 2 1312. The UE may determine when to start the time window based on a PRACH occasion that the UE uses to transmit the preamble. For example, the UE may start the time window one or more symbols after a last symbol of the preamble (e.g., at a first PDCCH occasion from an end of a preamble transmission). The one or more symbols may be determined based on a numerology. The PDCCH may be in a common search space (e.g., a Type1-PDCCH common search space) configured by an RRC message. The UE may identify the RAR based on a Radio Network Temporary Identifier (RNTI). RNTIs may be used depending on one or more events initiating the random access procedure. The UE may use random access RNTI (RA-RNTI). The RA-RNTI may be associated with PRACH occasions in which the UE transmits a preamble. For example, the UE may determine the RA-RNTI based on: an OFDM symbol index; a slot index; a frequency domain index; and/or a UL carrier indicator of the PRACH occasions. An example of RA-RNTI may be as follows:

RA-RNTI=1+s_id+14×t_id+14×80×f_id+14×80×8×ul_carrier_id

where s_id may be an index of a first OFDM symbol of the PRACH occasion (e.g., 0<s_id<14), t_id may be an index of a first slot of the PRACH occasion in a system frame (e.g., 0<t_id<80), f_id may be an index of the PRACH occasion in the frequency domain (e.g., 0<f_id<8), and ul_carrier_id may be a UL carrier used for a preamble transmission (e.g., 0 for an NUL carrier, and 1 for an SUL carrier).
The UE may transmit the Msg 3 1313 in response to a successful reception of the Msg 2 1312 (e.g., using resources identified in the Msg 2 1312). The Msg 3 1313 may be used for contention resolution in, for example, the contention-based random access procedure illustrated in FIG. 13A. In some scenarios, a plurality of UEs may transmit a same preamble to a base station and the base station may provide an RAR that corresponds to a UE. Collisions may occur if the plurality of UEs interpret the RAR as corresponding to themselves. Contention resolution (e.g., using the Msg 3 1313 and the Msg 4 1314) may be used to increase the likelihood that the UE does not incorrectly use an identity of another the UE. To perform contention resolution, the UE may include a device identifier in the Msg 3 1313 (e.g., a C-RNTI if assigned, a TC-RNTI included in the Msg 2 1312, and/or any other suitable identifier).

The Msg 4 1314 may be received after or in response to the transmitting of the Msg 3 1313. If a C-RNTI was included in the Msg 3 1313, the base station will address the UE on the PDCCH using the C-RNTI. If the UE's unique C-RNTI is detected on the PDCCH, the random access procedure is determined to be successfully completed. If a TC-RNTI is included in the Msg 3 1313 (e.g., if the UE is in an RRC_IDLE state or not otherwise connected to the base station), Msg 4 1314 will be received using a DL-SCH associated with the TC-RNTI. If a MAC PDU is successfully decoded and a MAC PDU comprises the UE contention resolution identity MAC CE that matches or otherwise corresponds with the CCCH SDU sent (e.g., transmitted) in Msg 3 1313, the UE may determine that the contention resolution is successful and/or the UE may determine that the random access procedure is successfully completed.

The UE may be configured with a supplementary uplink (SUL) carrier and a normal uplink (NUL) carrier. An initial access (e.g., random access procedure) may be supported in an uplink carrier. For example, a base station may configure the UE with two separate RACH configurations: one for an SUL carrier and the other for an NUL carrier. For random access in a cell configured with an SUL carrier, the network may indicate which carrier to use (NUL or SUL). The UE may determine the SUL carrier, for example, if a measured quality of one or more reference signals is lower than a broadcast threshold. Uplink transmissions of the random access procedure (e.g., the Msg 1 1311 and/or the Msg 3 1313) may remain on the selected carrier. The UE may switch an uplink carrier during the random access procedure (e.g., between the Msg 1 1311 and the Msg 3 1313) in one or more cases. For example, the UE may determine and/or switch an uplink carrier for the Msg 1 1311 and/or the Msg 3 1313 based on a channel clear assessment (e.g., a listen-before-talk).

FIG. 13B illustrates a two-step contention-free random access procedure. Similar to the four-step contention-based random access procedure illustrated in FIG. 13A, a base station may, prior to initiation of the procedure, transmit a configuration message 1320 to the UE. The configuration message 1320 may be analogous in some respects to the configuration message 1310. The procedure illustrated in FIG. 13B comprises transmission of two messages: a Msg 1 1321 and a Msg 2 1322. The Msg 1 1321 and the Msg 2 1322 may be analogous in some respects to the Msg 1 1311 and a Msg 2 1312 illustrated in FIG. 13A, respectively. As will be understood from FIGS. 13A and 13B, the contention-free random access procedure may not include messages analogous to the Msg 3 1313 and/or the Msg 4 1314.

The contention-free random access procedure illustrated in FIG. 13B may be initiated for a beam failure recovery, other SI request, SCell addition, and/or handover. For example, a base station may indicate or assign to the UE the preamble to be used for the Msg 1 1321. The UE may receive, from the base station via PDCCH and/or RRC, an indication of a preamble (e.g., ra-PreambleIndex).

After transmitting a preamble, the UE may start a time window (e.g., ra-ResponseWindow) to monitor a PDCCH for the RAR. In the event of a beam failure recovery request, the base station may configure the UE with a separate time window and/or a separate PDCCH in a search space indicated by an RRC message (e.g., recoverySearchSpaceId). The UE may monitor for a PDCCH transmission addressed to a Cell RNTI (C-RNTI) on the search space. In the contention-free random access procedure illustrated in FIG. 13B, the UE may determine that a random access procedure successfully completes after or in response to transmission of Msg 1 1321 and reception of a corresponding Msg 2 1322. The UE may determine that a random access procedure successfully completes, for example, if a PDCCH transmission is addressed to a C-RNTI. The UE may determine that a random access procedure successfully completes, for example, if the UE receives an RAR comprising a preamble identifier corresponding to a preamble transmitted by the UE and/or the RAR comprises a MAC sub-PDU with the preamble identifier. The UE may determine the response as an indication of an acknowledgement for an SI request.

FIG. 13C illustrates another two-step random access procedure. Similar to the random access procedures illustrated in FIGS. 13A and 13B, a base station may, prior to initiation of the procedure, transmit a configuration message 1330 to the UE. The configuration message 1330 may be analogous in some respects to the configuration message 1310 and/or the configuration message 1320. The procedure illustrated in FIG. 13C comprises transmission of two messages: a Msg A 1331 and a Msg B 1332.

Msg A 1331 may be transmitted in an uplink transmission by the UE. Msg A 1331 may comprise one or more transmissions of a preamble 1341 and/or one or more transmissions of a transport block 1342. The transport block 1342 may comprise contents that are similar and/or equivalent to the contents of the Msg 3 1313 illustrated in FIG. 13A. The transport block 1342 may comprise UCI (e.g., an SR, a HARQ ACK/NACK, and/or the like). The UE may receive the Msg B 1332 after or in response to transmitting the Msg A 1331. The Msg B 1332 may comprise contents that are similar and/or equivalent to the contents of the Msg 2 1312 (e.g., an RAR) illustrated in FIGS. 13A and 13B and/or the Msg 4 1314 illustrated in FIG. 13A.

The UE may initiate the two-step random access procedure in FIG. 13C for licensed spectrum and/or unlicensed spectrum. The UE may determine, based on one or more factors, whether to initiate the two-step random access procedure. The one or more factors may be: a radio access technology in use (e.g., LTE, NR, and/or the like); whether the UE has valid TA or not; a cell size; the UE's RRC state; a type of spectrum (e.g., licensed vs. unlicensed); and/or any other suitable factors.

The UE may determine, based on two-step RACH parameters included in the configuration message 1330, a radio resource and/or an uplink transmit power for the preamble 1341 and/or the transport block 1342 included in the Msg A 1331. The RACH parameters may indicate a modulation and coding schemes (MCS), a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the UE to determine a reception timing and a downlink channel for monitoring for and/or receiving Msg B 1332.

The transport block 1342 may comprise data (e.g., delay-sensitive data), an identifier of the UE, security information, and/or device information (e.g., an International Mobile Subscriber Identity (IMSI)). The base station may transmit the Msg B 1332 as a response to the Msg A 1331. The Msg B 1332 may comprise at least one of following: a preamble identifier; a timing advance command; a power control command; an uplink grant (e.g., a radio resource assignment and/or an MCS); a UE identifier for contention resolution; and/or an RNTI (e.g., a C-RNTI or a TC-RNTI). The UE may determine that the two-step random access procedure is successfully completed if: a preamble identifier in the Msg B 1332 is matched to a preamble transmitted by the UE; and/or the identifier of the UE in Msg B 1332 is matched to the identifier of the UE in the Msg A 1331 (e.g., the transport block 1342).

A UE and a base station may exchange control signaling. The control signaling may be referred to as L1/L2 control signaling and may originate from the PHY layer (e.g., layer 1) and/or the MAC layer (e.g., layer 2). The control signaling may comprise downlink control signaling transmitted from the base station to the UE and/or uplink control signaling transmitted from the UE to the base station.

The downlink control signaling may comprise: a downlink scheduling assignment; an uplink scheduling grant indicating uplink radio resources and/or a transport format; a slot format information; a preemption indication; a power control command; and/or any other suitable signaling. The UE may receive the downlink control signaling in a payload transmitted by the base station on a physical downlink control channel (PDCCH). The payload transmitted on the PDCCH may be referred to as downlink control information (DCI). In some scenarios, the PDCCH may be a group common PDCCH (GC-PDCCH) that is common to a group of UEs.

A base station may attach one or more cyclic redundancy check (CRC) parity bits to a DCI in order to facilitate detection of transmission errors. When the DCI is intended for a UE (or a group of the UEs), the base station may scramble the CRC parity bits with an identifier of the UE (or an identifier of the group of the UEs). Scrambling the CRC parity bits with the identifier may comprise Modulo-2 addition (or an exclusive OR operation) of the identifier value and the CRC parity bits. The identifier may comprise a 16-bit value of a radio network temporary identifier (RNTI).

DCIs may be used for different purposes. A purpose may be indicated by the type of RNTI used to scramble the CRC parity bits. For example, a DCI having CRC parity bits scrambled with a paging RNTI (P-RNTI) may indicate paging information and/or a system information change notification. The P-RNTI may be predefined as “FFFE” in hexadecimal. A DCI having CRC parity bits scrambled with a system information RNTI (SI-RNTI) may indicate a broadcast transmission of the system information. The SI-RNTI may be predefined as “FFFF” in hexadecimal. A DCI having CRC parity bits scrambled with a random access RNTI (RA-RNTI) may indicate a random access response (RAR). A DCI having CRC parity bits scrambled with a cell RNTI (C-RNTI) may indicate a dynamically scheduled unicast transmission and/or a triggering of PDCCH-ordered random access. A DCI having CRC parity bits scrambled with a temporary cell RNTI (TC-RNTI) may indicate a contention resolution (e.g., a Msg 3 analogous to the Msg 3 1313 illustrated in FIG. 13A). Other RNTIs configured to the UE by a base station may comprise a Configured Scheduling RNTI (CS-RNTI), a Transmit Power Control-PUCCH RNTI (TPC-PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C-RNTI), and/or the like.

Depending on the purpose and/or content of a DCI, the base station may transmit the DCIs with one or more DCI formats. For example, DCI format 0_0 may be used for scheduling of PUSCH in a cell. DCI format 0_0 may be a fallback DCI format (e.g., with compact DCI payloads). DCI format 0_1 may be used for scheduling of PUSCH in a cell (e.g., with more DCI payloads than DCI format 0_0). DCI format 1_0 may be used for scheduling of PDSCH in a cell. DCI format 1_0 may be a fallback DCI format (e.g., with compact DCI payloads). DCI format 1_1 may be used for scheduling of PDSCH in a cell (e.g., with more DCI payloads than DCI format 1_0). DCI format 2_0 may be used for providing a slot format indication to a group of UEs. DCI format 2_1 may be used for notifying a group of UEs of a physical resource block and/or OFDM symbol where the UE may assume no transmission is intended to the UE. DCI format 2_2 may be used for transmission of a transmit power control (TPC) command for PUCCH or PUSCH. DCI format 2_3 may be used for transmission of a group of TPC commands for SRS transmissions by one or more UEs. DCI format(s) for new functions may be defined in future releases. DCI formats may have different DCI sizes, or may share the same DCI size.

After scrambling a DCI with a RNTI, the base station may process the DCI with channel coding (e.g., polar coding), rate matching, scrambling and/or QPSK modulation. A base station may map the coded and modulated DCI on resource elements used and/or configured for a PDCCH. Based on a payload size of the DCI and/or a coverage of the base station, the base station may transmit the DCI via a PDCCH occupying a number of contiguous control channel elements (CCEs). The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

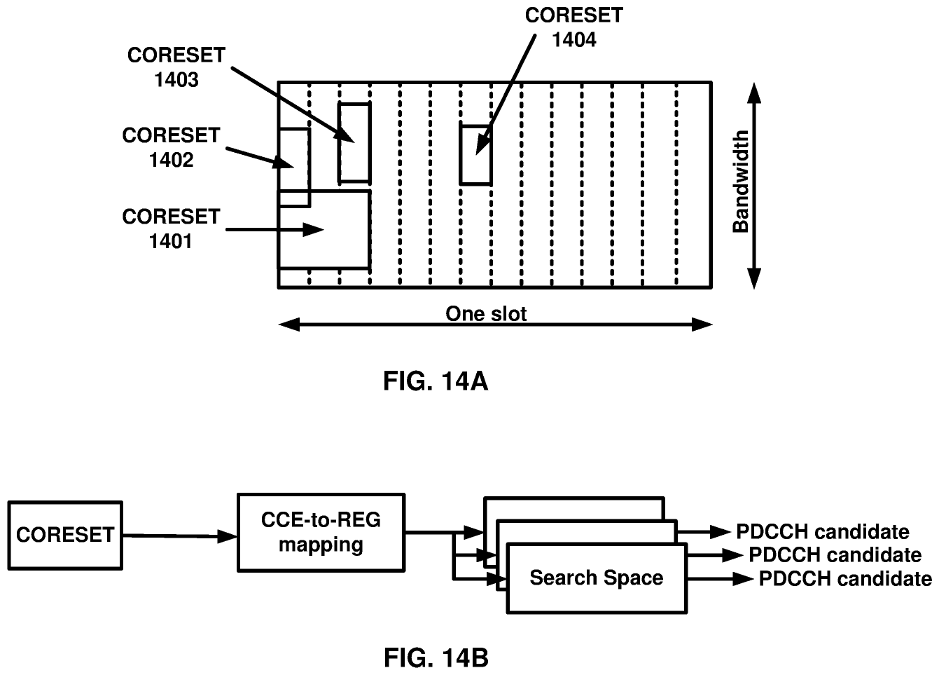

FIG. 14A illustrates an example of CORESET configurations for a bandwidth part. The base station may transmit a DCI via a PDCCH on one or more control resource sets (CORESETs). A CORESET may comprise a time-frequency resource in which the UE tries to decode a DCI using one or more search spaces. The base station may configure a CORESET in the time-frequency domain. In the example of FIG. 14A, a first CORESET 1401 and a second CORESET 1402 occur at the first symbol in a slot. The first CORESET 1401 overlaps with the second CORESET 1402 in the frequency domain. A third CORESET 1403 occurs at a third symbol in the slot. A fourth CORESET 1404 occurs at the seventh symbol in the slot. CORESETs may have a different number of resource blocks in frequency domain.

FIG. 14B illustrates an example of a CCE-to-REG mapping for DCI transmission on a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping by RRC configuration. A CORESET may be configured with an antenna port quasi co-location (QCL) parameter. The antenna port QCL parameter may indicate QCL information of a demodulation reference signal (DMRS) for PDCCH reception in the CORESET.

The base station may transmit, to the UE, RRC messages comprising configuration parameters of one or more CORESETs and one or more search space sets. The configuration parameters may indicate an association between a search space set and a CORESET. A search space set may comprise a set of PDCCH candidates formed by CCEs at a given aggregation level. The configuration parameters may indicate: a number of PDCCH candidates to be monitored per aggregation level; a PDCCH monitoring periodicity and a PDCCH monitoring pattern; one or more DCI formats to be monitored by the UE; and/or whether a search space set is a common search space set or a UE-specific search space set. A set of CCEs in the common search space set may be predefined and known to the UE. A set of CCEs in the UE-specific search space set may be configured based on the UE's identity (e.g., C-RNTI).

As shown in FIG. 14B, the UE may determine a time-frequency resource for a CORESET based on RRC messages. The UE may determine a CCE-to-REG mapping (e.g., interleaved or non-interleaved, and/or mapping parameters) for the CORESET based on configuration parameters of the CORESET. The UE may determine a number (e.g., at most 10) of search space sets configured on the CORESET based on the RRC messages. The UE may monitor a set of PDCCH candidates according to configuration parameters of a search space set. The UE may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding a DCI content of one or more PDCCH candidates with possible (or configured) PDCCH locations, possible (or configured) PDCCH formats (e.g., number of CCEs, number of PDCCH candidates in common search spaces, and/or number of PDCCH candidates in the UE-specific search spaces) and possible (or configured) DCI formats. The decoding may be referred to as blind decoding. The UE may determine a DCI as valid for the UE, in response to CRC checking (e.g., scrambled bits for CRC parity bits of the DCI matching a RNTI value). The UE may process information contained in the DCI (e.g., a scheduling assignment, an uplink grant, power control, a slot format indication, a downlink preemption, and/or the like).

The UE may transmit uplink control signaling (e.g., uplink control information (UCI)) to a base station. The uplink control signaling may comprise hybrid automatic repeat request (HARQ) acknowledgements for received DL-SCH transport blocks. The UE may transmit the HARQ acknowledgements after receiving a DL-SCH transport block. Uplink control signaling may comprise channel state information (CSI) indicating channel quality of a physical downlink channel. The UE may transmit the CSI to the base station. The base station, based on the received CSI, may determine transmission format parameters (e.g., comprising multi-antenna and beamforming schemes) for a downlink transmission. Uplink control signaling may comprise scheduling requests (SR). The UE may transmit an SR indicating that uplink data is available for transmission to the base station. The UE may transmit a UCI (e.g., HARQ acknowledgements (HARQ-ACK), CSI report, SR, and the like) via a physical uplink control channel (PUCCH) or a physical uplink shared channel (PUSCH). The UE may transmit the uplink control signaling via a PUCCH using one of several PUCCH formats.

There may be five PUCCH formats and the UE may determine a PUCCH format based on a size of the UCI (e.g., a number of uplink symbols of UCI transmission and a number of UCI bits). PUCCH format 0 may have a length of one or two OFDM symbols and may include two or fewer bits. The UE may transmit UCI in a PUCCH resource using PUCCH format 0 if the transmission is over one or two symbols and the number of HARQ-ACK information bits with positive or negative SR (HARQ-ACK/SR bits) is one or two. PUCCH format 1 may occupy a number between four and fourteen OFDM symbols and may include two or fewer bits. The UE may use PUCCH format 1 if the transmission is four or more symbols and the number of HARQ-ACK/SR bits is one or two. PUCCH format 2 may occupy one or two OFDM symbols and may include more than two bits. The UE may use PUCCH format 2 if the transmission is over one or two symbols and the number of UCI bits is two or more. PUCCH format 3 may occupy a number between four and fourteen OFDM symbols and may include more than two bits. The UE may use PUCCH format 3 if the transmission is four or more symbols, the number of UCI bits is two or more and PUCCH resource does not include an orthogonal cover code. PUCCH format 4 may occupy a number between four and fourteen OFDM symbols and may include more than two bits. The UE may use PUCCH format 4 if the transmission is four or more symbols, the number of UCI bits is two or more and the PUCCH resource includes an orthogonal cover code.

The base station may transmit configuration parameters to the UE for a plurality of PUCCH resource sets using, for example, an RRC message. The plurality of PUCCH resource sets (e.g., up to four sets) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a number (e.g. a maximum number) of UCI information bits the UE may transmit using one of the plurality of PUCCH resources in the PUCCH resource set. When configured with a plurality of PUCCH resource sets, the UE may select one of the plurality of PUCCH resource sets based on a total bit length of the UCI information bits (e.g., HARQ-ACK, SR, and/or CSI). If the total bit length of UCI information bits is two or fewer, the UE may select a first PUCCH resource set having a PUCCH resource set index equal to “0”. If the total bit length of UCI information bits is greater than two and less than or equal to a first configured value, the UE may select a second PUCCH resource set having a PUCCH resource set index equal to “1”. If the total bit length of UCI information bits is greater than the first configured value and less than or equal to a second configured value, the UE may select a third PUCCH resource set having a PUCCH resource set index equal to “2”. If the total bit length of UCI information bits is greater than the second configured value and less than or equal to a third value (e.g., 1406), the UE may select a fourth PUCCH resource set having a PUCCH resource set index equal to “3”.

After determining a PUCCH resource set from a plurality of PUCCH resource sets, the UE may determine a PUCCH resource from the PUCCH resource set for UCI (HARQ-ACK, CSI, and/or SR) transmission. The UE may determine the PUCCH resource based on a PUCCH resource indicator in a DCI (e.g., with a DCI format 1_0 or DCI for 1_1) received on a PDCCH. A three-bit PUCCH resource indicator in the DCI may indicate one of eight PUCCH resources in the PUCCH resource set. Based on the PUCCH resource indicator, the UE may transmit the UCI (HARQ-ACK, CSI and/or SR) using a PUCCH resource indicated by the PUCCH resource indicator in the DCI.

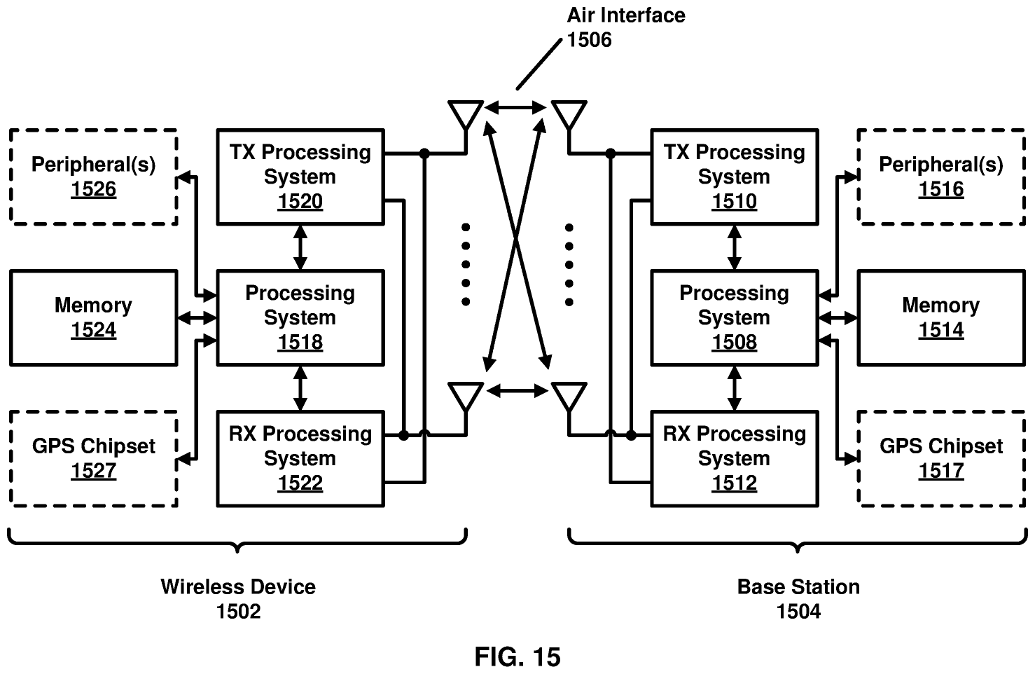

FIG. 15 illustrates an example of a wireless device 1502 in communication with a base station 1504 in accordance with embodiments of the present disclosure. The wireless device 1502 and base station 1504 may be part of a mobile communication network, such as the mobile communication network 100 illustrated in FIG. 1A, the mobile communication network 150 illustrated in FIG. 1B, or any other communication network. Only one wireless device 1502 and one base station 1504 are illustrated in FIG. 15, but it will be understood that a mobile communication network may include more than one UE and/or more than one base station, with the same or similar configuration as those shown in FIG. 15.

The base station 1504 may connect the wireless device 1502 to a core network (not shown) through radio communications over the air interface (or radio interface) 1506. The communication direction from the base station 1504 to the wireless device 1502 over the air interface 1506 is known as the downlink, and the communication direction from the wireless device 1502 to the base station 1504 over the air interface is known as the uplink. Downlink transmissions may be separated from uplink transmissions using FDD, TDD, and/or some combination of the two duplexing techniques.

In the downlink, data to be sent to the wireless device 1502 from the base station 1504 may be provided to the processing system 1508 of the base station 1504. The data may be provided to the processing system 1508 by, for example, a core network. In the uplink, data to be sent to the base station 1504 from the wireless device 1502 may be provided to the processing system 1518 of the wireless device 1502. The processing system 1508 and the processing system 1518 may implement layer 3 and layer 2 OSI functionality to process the data for transmission. Layer 2 may include an SDAP layer, a PDCP layer, an RLC layer, and a MAC layer, for example, with respect to FIG. 2A, FIG. 2B, FIG. 3, and FIG. 4A. Layer 3 may include an RRC layer as with respect to FIG. 2B.

After being processed by processing system 1508, the data to be sent to the wireless device 1502 may be provided to a transmission processing system 1510 of base station 1504. Similarly, after being processed by the processing system 1518, the data to be sent to base station 1504 may be provided to a transmission processing system 1520 of the wireless device 1502. The transmission processing system 1510 and the transmission processing system 1520 may implement layer 1 OSI functionality. Layer 1 may include a PHY layer with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

At the base station 1504, a reception processing system 1512 may receive the uplink transmission from the wireless device 1502. At the wireless device 1502, a reception processing system 1522 may receive the downlink transmission from base station 1504. The reception processing system 1512 and the reception processing system 1522 may implement layer 1 OSI functionality. Layer 1 may include a PHY layer with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

As shown in FIG. 15, a wireless device 1502 and the base station 1504 may include multiple antennas. The multiple antennas may be used to perform one or more MIMO or multi-antenna techniques, such as spatial multiplexing (e.g., single-user MIMO or multi-user MIMO), transmit/receive diversity, and/or beamforming. In other examples, the wireless device 1502 and/or the base station 1504 may have a single antenna.

The processing system 1508 and the processing system 1518 may be associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518 to carry out one or more of the functionalities discussed in the present application. Although not shown in FIG. 15, the transmission processing system 1510, the transmission processing system 1520, the reception processing system 1512, and/or the reception processing system 1522 may be coupled to a memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and the base station 1504 to operate in a wireless environment.

The processing system 1508 and/or the processing system 1518 may be connected to one or more peripherals 1516 and one or more peripherals 1526, respectively. The one or more peripherals 1516 and the one or more peripherals 1526 may include software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive user input data from and/or provide user output data to the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 and/or the processing system 1518 may be connected to a GPS chipset 1517 and a GPS chipset 1527, respectively. The GPS chipset 1517 and the GPS chipset 1527 may be configured to provide geographic location information of the wireless device 1502 and the base station 1504, respectively.

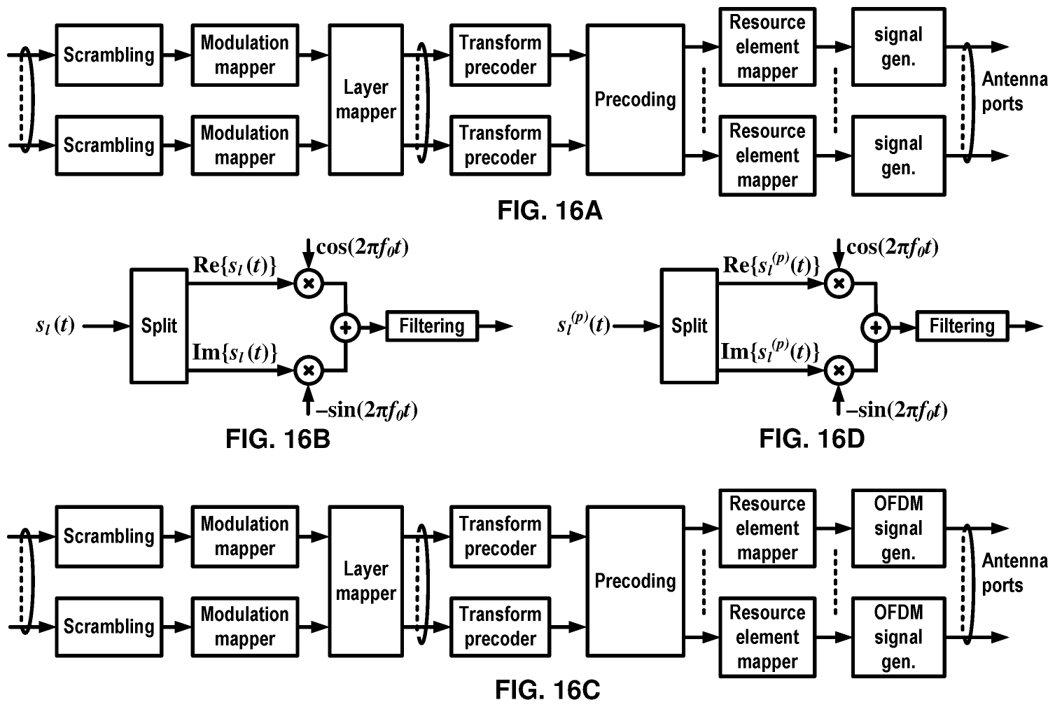

FIG. 16A illustrates an example structure for uplink transmission. A baseband signal representing a physical uplink shared channel may perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA) or CP-OFDM signal for an antenna port; and/or the like. In an example, when transform precoding is enabled, a SC-FDMA signal for uplink transmission may be generated. In an example, when transform precoding is not enabled, an CP-OFDM signal for uplink transmission may be generated by FIG. 16A. These functions are illustrated as examples and it is anticipated that other mechanisms may be implemented in various embodiments.

FIG. 16B illustrates an example structure for modulation and up-conversion of a baseband signal to a carrier frequency. The baseband signal may be a complex-valued SC-FDMA or CP-OFDM baseband signal for an antenna port and/or a complex-valued Physical Random Access Channel (PRACH) baseband signal. Filtering may be employed prior to transmission.

FIG. 16C illustrates an example structure for downlink transmissions. A baseband signal representing a physical downlink channel may perform one or more functions. The one or more functions may comprise: scrambling of coded bits in a codeword to be transmitted on a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are illustrated as examples and it is anticipated that other mechanisms may be implemented in various embodiments.

FIG. 16D illustrates another example structure for modulation and up-conversion of a baseband signal to a carrier frequency. The baseband signal may be a complex-valued OFDM baseband signal for an antenna port. Filtering may be employed prior to transmission.

A wireless device may receive from a base station one or more messages (e.g. RRC messages) comprising configuration parameters of a plurality of cells (e.g. primary cell, secondary cell). The wireless device may communicate with at least one base station (e.g. two or more base stations in dual-connectivity) via the plurality of cells. The one or more messages (e.g. as a part of the configuration parameters) may comprise parameters of physical, MAC, RLC, PCDP, SDAP, RRC layers for configuring the wireless device. For example, the configuration parameters may comprise parameters for configuring physical and MAC layer channels, bearers, etc. For example, the configuration parameters may comprise parameters indicating values of timers for physical, MAC, RLC, PCDP, SDAP, RRC layers, and/or communication channels.

A timer may begin running once it is started and continue running until it is stopped or until it expires. A timer may be started if it is not running or restarted if it is running. A timer may be associated with a value (e.g. the timer may be started or restarted from a value or may be started from zero and expire once it reaches the value). The duration of a timer may not be updated until the timer is stopped or expires (e.g., due to BWP switching). A timer may be used to measure a time period/window for a process. When the specification refers to an implementation and procedure related to one or more timers, it will be understood that there are multiple ways to implement the one or more timers. For example, it will be understood that one or more of the multiple ways to implement a timer may be used to measure a time period/window for the procedure. For example, a random access response window timer may be used for measuring a window of time for receiving a random access response. In an example, instead of starting and expiry of a random access response window timer, the time difference between two time stamps may be used. When a timer is restarted, a process for measurement of time window may be restarted. Other example implementations may be provided to restart a measurement of a time window.

In an example, the wireless device may receive, from a base station, an execution condition for a handover or a secondary node addition (e.g., secondary cell group (SCG) addition/configuration). The execution condition may comprise at least one of: event A1, event A2, event A3, event A4, event A5, event A6, event B1, event B2, event C1, event C2, event W1, event W2, event W3, event V1, event V2, event H1, event H2, and/or the like. The execution condition may comprise “AND combination” or “OR combination” of at least one of: the event A1, the event A2, the event A3, the event A4, the event A5, the event A6, the event B1, the event B2, the event C1, the event C2, the event W1, the event W2, the event W3, the event V1, the event V2, the event H1, the event H2, and/or the like. “AND combination” of events may be interpreted as all the events need to happen/occur to meet/satisfy the execution condition. “OR combination” of events may be interpreted as at least one of the events need to happen/occur to meet/satisfy the execution condition.

In an example, the event A1 may be that a serving cell (e.g., one or more beams of the serving cell) becomes better than threshold. An entering condition for this event may be considered to be satisfied when condition A1-1 is fulfilled/met/satisfied. A leaving condition for this event may be considered to be satisfied when condition A1-2 is fulfilled/met/satisfied. For the event A1, the inequality A1-1 (Entering condition) may be Ms-Hys>Thresh, and/or the inequality A1-2 (Leaving condition) may be Ms+Hys<Thresh. Ms may be a measurement result of the serving cell, and/or may not take into account offsets. Hys may be the hysteresis parameter for this event (e.g., hysteresis as defined within reportConfigEUTRA for this event). Thresh may be a threshold parameter for the event (i.e. a1-Threshold as defined within reportConfigEUTRA for the event). Ms may be expressed in dBm in case of RSRP, or in dB in case of RSRQ and RS-SINR. Hys may be expressed in dB. Thresh may be expressed in the same unit as Ms.

In an example, the event A2 may be that a serving cell (e.g., one or more beams of the serving cell) becomes worse than threshold. An entering condition for this event may be considered to be satisfied when condition A2-1 is fulfilled/met/satisfied. A leaving condition for this event may be considered to be satisfied when condition A2-2 is fulfilled/met/satisfied. For the event A2, the inequality A2-1 (Entering condition) may be Ms+Hys<Thresh, and/or the inequality A2-2 (Leaving condition) may be Ms−Hys>Thresh. Ms may be a measurement result of the serving cell, and/or may not take into account offsets. Hys may be the hysteresis parameter for this event (e.g., hysteresis as defined within reportConfigNR and/or reportConfigEUTRA for this event). Thresh may be a threshold parameter for the event (e.g., a2-Threshold as defined within reportConfigNR and/or reportConfigEUTRA for the event). Ms may be expressed in dBm in case of RSRP, or in dB in case of RSRQ and RS-SINR. Hys may be expressed in dB. Thresh may be expressed in the same unit as Ms.

In an example, the event A3 may be that a neighbour cell (e.g., a target cell, one or more beams of the neighbour cell) becomes offset better than PCell/PSCell (e.g., the serving cell, the one or more beams of the serving cell). An entering condition for this event may be considered to be satisfied when condition A3-1 is fulfilled/met/satisfied. A leaving condition for this event may be considered to be satisfied when condition A3-2 is fulfilled/met/satisfied. For the event A3, the inequality A3-1 (Entering condition) may be Mn+Ofn+Ocn−Hys>Mp+Ofp+Ocp+Off, and/or the inequality A3-2 (Leaving condition) may be Mn+Ofn+Ocn+Hys<Mp+Ofp+Ocp+Off. Mn may be a measurement result of the neighbour cell, and/or may not take into account offsets. Ofn may be a frequency specific offset of a frequency of the neighbour cell (e.g., offsetFreq as defined within measObjectNR and/or measObjectEUTRA corresponding to the frequency of the neighbour cell). Ocn may be a cell specific offset of the neighbour cell (e.g., cellIndividualOffset as defined within measObjectNR and/or measObjectEUTRA corresponding to the frequency of the neighbour cell), and/or may be set to zero if not configured for the neighbour cell. Mp may be a measurement result of the PCell and/or PSCell, and/or may not take into account offsets. Ofp may be a frequency specific offset of the frequency of the PCell/PSCell (e.g., offsetFreq as defined within measObjectNR and/or measObjectEUTRA corresponding to the frequency of the PCell/PSCell). Ocp may be a cell specific offset of the PCell/PSCell (e.g., cellIndividualOffset as defined within measObjectNR and/or measObjectEUTRA corresponding to the frequency of the PCell/PSCell), and/or may be set to zero if not configured for the PCell/PSCell. Hys may be a hysteresis parameter for this event (e.g., hysteresis as defined within reportConfigNR and/or reportConfigEUTRA for this event). Off may be an offset parameter for this event (i.e. a3-Offset as defined within reportConfigNR and/or reportConfigEUTRA for this event). Mn and/or Mp may be expressed in dBm in case of RSRP, and/or in dB in case of RSRQ and RS-SINR. Ofn, Ocn, Ofp, Ocp, Hys, and/or Off may be expressed in dB.

In an example, the event A4 may be that a neighbour cell (e.g., a target cell, one or more beams of the neighbour cell) becomes better than threshold. An entering condition for this event may be considered to be satisfied when condition A4-1 is fulfilled/met/satisfied. A leaving condition for this event may be considered to be satisfied when condition A4-2 is fulfilled/met/satisfied. For the event A4, the inequality A4-1 (Entering condition) may be Mn+Ofn+Ocn−Hys>Thresh, and/or the inequality A4-2 (Leaving condition) may be Mn+Ofn+Ocn+Hys<Thresh. Mn may be a measurement result of the neighbour cell, and/or may not take into account offsets. Ofn may be a frequency specific offset of the frequency of the neighbour cell (e.g., offsetFreq as defined within measObjectNR and/or measObjectEUTRA corresponding to the frequency of the neighbour cell). Ocn may be a cell specific offset of the neighbour cell (e.g., cellIndividualOffset as defined within measObjectNR and/or measObjectEUTRA corresponding to the frequency of the neighbour cell), and/or may be set to zero if not configured for the neighbour cell. Hys may be a hysteresis parameter for this event (e.g., hysteresis as defined within reportConfigNR and/or reportConfigEUTRA for this event). Thresh may be a threshold parameter for this event (e.g., a4-Threshold as defined within reportConfigNR and/or reportConfigEUTRA for this event). Mn may be expressed in dBm in case of RSRP, and/or in dB in case of RSRQ and RS-SINR. Ofn, Ocn, and/or Hys are expressed in dB. Thresh may be expressed in the same unit as Mn.

In an example, the event A5 may be that a PCell/PSCell (e.g., the serving cell, one or more beams of the serving cell) becomes worse than threshold1 and a neighbour cell (e.g., a target cell, one or more beams of the neighbour cell) becomes better than threshold2. An entering condition for this event may be considered to be satisfied when both condition A5-1 and condition A5-2 are fulfilled/met/satisfied. A leaving condition for this event may be considered to be satisfied when condition A5-3 or condition A5-4 (e.g., at least one of the two conditions A5-3 or A5-4) is fulfilled/met/satisfied. For the event A5, the inequality A5-1 (Entering condition 1) may be Mp+Hys<Thresh1; the inequality A5-2 (Entering condition 2) may be Mn+Ofn+Ocn−Hys>Thresh2; the inequality A5-3 (Leaving condition 1) may be Mp−Hys>Thresh1; and/or the inequality A5-4 (Leaving condition 2) may be Mn+Ofn+Ocn+Hys<Thresh2. Mp may be a measurement result of the PCell/PSCell, and/or may not take into account offsets. Mn may be a measurement result of the neighbour cell, and/or may not take into account offsets. Ofn may be a frequency specific offset of the frequency of the neighbour cell (e.g., offsetFreq as defined within measObjectNR and/or measObjectEUTRA corresponding to the frequency of the neighbour cell). Ocn may be a cell specific offset of the neighbour cell (e.g., cellIndividualOffset as defined within measObjectNR and/or measObjectEUTRA corresponding to the frequency of the neighbour cell), and/or may be set to zero if not configured for the neighbour cell. Hys may be a hysteresis parameter for this event (e.g., hysteresis as defined within reportConfigNR and/or reportConfigEUTRA for this event). Thresh1 may be a threshold parameter for this event (e.g., a5-Threshold1 as defined within reportConfigNR and/or reportConfigEUTRA for this event). Thresh2 may be a threshold parameter for this event (e.g., a5-Threshold2 as defined within reportConfigNR and/or reportConfigEUTRA for this event). Mn and/or Mp may be expressed in dBm in case of RSRP, and/or in dB in case of RSRQ and RS-SINR. Ofn, Ocn, and/or Hys may be expressed in dB. Thresh1 may be expressed in the same unit as Mp. Thresh2 may be expressed in the same unit as Mn.

In an example, the event A6 may be that a neighbour cell (e.g., a target cell, one or more beams of the neighbour cell) becomes offset better than SCell (e.g., a secondary cell, a serving cell, one or more beams of SCell). An entering condition for this event may be considered to be satisfied when condition A6-1 is fulfilled/met/satisfied. A leaving condition for this event may be considered to be satisfied when condition A6-2 is fulfilled/met/satisfied. For the event A6, the inequality A6-1 (Entering condition) may be Mn+Ocn−Hys>Ms+Ocs+Off, and/or the inequality A6-2 (Leaving condition) may be Mn+Ocn+Hys<Ms+Ocs+Off. Mn may be a measurement result of the neighbour cell, and/or may not take into account offsets. Ocn may be a cell specific offset of the neighbour cell (e.g., cellIndividualOffset as defined within measObjectNR and/or measObjectEUTRA corresponding to the frequency of the neighbour cell), and/or may be set to zero if not configured for the neighbour cell. Ms may be a measurement result of the serving cell, and/or may not take into account offsets. Ocs may be a cell specific offset of the serving cell (e.g., cellIndividualOffset as defined within measObjectNR and/or measObjectEUTRA corresponding to the serving frequency), and/or may be set to zero if not configured for the serving cell. Hys may be a hysteresis parameter for this event (e.g., hysteresis as defined within reportConfigNR and/or reportConfigEUTRA for this event). Off may be an offset parameter for this event (e.g., a6-Offset as defined within reportConfigNR and/or reportConfigEUTRA for this event). Mn and/or Ms may be expressed in dBm in case of RSRP, and/or in dB in case of RSRQ and RS-SINR. Ocn, Ocs, Hys, and/or Off may be expressed in dB.

In an example, the event B1 may be that an inter RAT neighbour cell (e.g., a target cell, one or more beams of the neighbour cell) becomes better than threshold. An entering condition for this event may be considered to be satisfied when condition B1-1 is fulfilled/met/satisfied. A leaving condition for this event may be considered to be satisfied when condition B1-2 is fulfilled/met/satisfied. For the event B1, the inequality B1-1 (Entering condition) may be Mn+Ofn+Ocn−Hys>Thresh, and/or the inequality B1-2 (Leaving condition) may be Mn+Ofn+Ocn+Hys<Thresh. Mn may be a measurement result of the inter-RAT neighbour cell, and/or may not take into account offsets (e.g., for CDMA 2000 measurement result, pilotStrength may be divided by −2). Ofn may be a frequency specific offset of a frequency of the inter-RAT neighbour cell (e.g., offsetFreq as defined within the measObject corresponding to the frequency of the neighbour inter-RAT cell). Hys may be a hysteresis parameter for this event (e.g., hysteresis as defined within reportConfigInterRAT for this event). Thresh may be a threshold parameter for this event (e.g., b1-Threshold as defined within reportConfigInterRAT for this event) (e.g., for CDMA2000, b1-Threshold may be divided by −2). Mn may be expressed in dBm or in dB, depending on a measurement quantity of the inter-RAT neighbour cell. Ofn and/or Hys may be expressed in dB. Thresh may be expressed in the same unit as Mn.

In an example, the event B2 may be a PCell (e.g., the serving cell, one or more beams of the serving cell) becomes worse than threshold1 and an inter RAT neighbour cell becomes better than threshold2. An entering condition for this event may be considered to be satisfied when both condition B2-1 and condition B2-2 are fulfilled/met/satisfied. A leaving condition for this event may be considered to be satisfied when condition B2-3 or condition B2-4 (e.g., at least one of the two B2-3 or B2-4) is fulfilled/met/satisfied. For the event B2, the inequality B2-1 (Entering condition 1) may be Mp+Hys<Thresh1; the inequality B2-2 (Entering condition 2) may be Mn+Ofn+Ocn−Hys>Thresh2; the inequality B2-3 (Leaving condition 1) may be Mp−Hys>Thresh1; and/or the inequality B2-4 (Leaving condition 2) may be Mn+Ofn+Ocn+Hys<Thresh2. Mp may be a measurement result of the PCell, and/or may not take into account offsets. Mn may be a measurement result of the inter-RAT neighbour cell, and/or may not take into account offsets (e.g., for CDMA2000 measurement result, pilotStrength may be divided by −2). Ofn may be a frequency specific offset of a frequency of the inter-RAT neighbour cell (e.g., offsetFreq as defined within the measObject corresponding to the frequency of the inter-RAT neighbour cell). Hys may be a hysteresis parameter for this event (e.g., hysteresis as defined within reportConfigInterRAT for this event). Thresh1 may be a threshold parameter for this event (e.g., b2-Threshold1 as defined within reportConfigInterRAT for this event). Thresh2 may be a threshold parameter for this event (e.g., b2-Threshold2 as defined within reportConfigInterRAT for this event) (e.g., CDMA2000, b2-Threshold2 may be divided by −2). Mp may be expressed in dBm in case of RSRP, and/or in dB in case of RSRQ. Mn may be expressed in dBm or dB, depending on the measurement quantity of the inter-RAT neighbour cell. Ofn and/or Hys may be expressed in dB. Thresh1 may be expressed in the same unit as Mp. Thresh2 may be expressed in the same unit as Mn.

In an example, the event C1 may be CSI-RS resource (e.g., of a cell and/or one or more beams of the cell) becomes better than threshold. An entering condition for this event may be considered to be satisfied when condition C1-1 is fulfilled/met/satisfied. A leaving condition for this event may be considered to be satisfied when condition C1-2 is fulfilled/met/satisfied. For the event C1, the inequality C1-1 (Entering condition) may be Mcr+Ocr−Hys>Thresh, and/or the inequality C1-2 (Leaving condition) may be Mcr+Ocr+Hys<Thresh. Mcr may be a measurement result of the CSI-RS resource, and/or may not take into account offsets. Ocr may be a CSI-RS specific offset (e.g., csi-RS-IndividualOffset as defined within measObjectNR and/or measObjectEUTRA corresponding to a frequency of the CSI-RS resource), and/or may be set to zero if not configured for the CSI-RS resource. Hys may be a hysteresis parameter for this event (e.g., hysteresis as defined within reportConfigNR and/or reportConfigEUTRA for this event). Thresh may be a threshold parameter for this event (e.g., c1-Threshold as defined within reportConfigNR and/or reportConfigEUTRA for this event). Mcr and/or Thresh may be expressed in dBm. Ocr and/or Hys may be expressed in dB.

In an example, the event C2 may be CSI-RS resource (e.g., of a first cell and/or one or more beams of the first cell) becomes offset better than reference CSI-RS resource (e.g., of a second cell or the first cell; and/or of one or more beams of the second cell or the first cell). An entering condition for this event may be considered to be satisfied when condition C2-1 is fulfilled/met/satisfied. A leaving condition for this event may be considered to be satisfied when condition C2-2 is fulfilled/met/satisfied. For the event C2, the inequality C2-1 (Entering condition) may be Mcr+Ocr−Hys>Mref+Oref+Off, and/or the inequality C2-2 (Leaving condition) may be Mcr+Ocr+Hys<Mref+Oref+Off. Mcr may be a measurement result of the CSI-RS resource, and/or may not take into account offsets. Ocr may be a CSI-RS specific offset of the CSI-RS resource (e.g., csi-RS-IndividualOffset as defined within measObjectNR and/or measObjectEUTRA corresponding to a frequency of the CSI-RS resource), and/or may be set to zero if not configured for the CSI-RS resource. Mref may be a measurement result of the reference CSI-RS resource (e.g., c2-RefCSI-RS as defined within reportConfigNR and/or reportConfigEUTRA for this event), and/or may not take into account offsets. Oref may be a CSI-RS specific offset of the reference CSI-RS resource (e.g., csi-RS-IndividualOffset as defined within measObjectNR and/or measObjectEUTRA corresponding to a frequency of the reference CSI-RS resource), and/or may be set to zero if not configured for the reference CSI-RS resource. Hys may be a hysteresis parameter for this event (e.g., hysteresis as defined within reportConfigNR and/or reportConfigEUTRA for this event). Off may be an offset parameter for this event (e.g., c2-Offset as defined within reportConfigNR and/or reportConfigEUTRA for this event). Mcr and/or Mref may be expressed in dBm. Ocr, Oref, Hys, and/or Off may be expressed in dB.

In an example, the event W1 may be WLAN (e.g., WiFi signal and/or signal from an access point of WLAN) becomes better than a threshold. An entering condition for this event may be considered to be satisfied when wlan-MobilitySet within VarWLAN-MobilityConfig does not contain entries and/or condition W1-1 is fulfilled/met/satisfied. A leaving condition for this event may be considered to be satisfied when condition W1-2 is fulfilled/met/satisfied. For the event W1, the inequality W1-1 (Entering condition) may be Mn−Hys>Thresh, and/or the inequality W1-2 (Leaving condition) may be Mn+Hys<Thresh. Mn may be a measurement result of WLAN(s) configured in a measurement object, and/or may not take into account offsets. Hys may be a hysteresis parameter for this event. Thresh may be a threshold parameter for this event (i.e. w1-Threshold as defined within reportConfigInterRAT for this event). Mn may be expressed in dBm. Hys may be expressed in dB. Thresh is expressed in the same unit as Mn.

In an example, the event W2 may be (e.g., all) WLAN (e.g., WiFi signal and/or signal from an access point of WLAN) inside WLAN mobility set becomes worse than threshold1 and a WLAN (e.g., WiFi signal and/or signal from an access point of WLAN) outside WLAN mobility set becomes better than threshold2. An entering condition for this event may be considered to be satisfied when both conditions W2-1 and W2-2 are fulfilled/met/satisfied. A leaving condition for this event may be considered to be satisfied when condition W2-3 or condition W2-4 (e.g., at least one of the two W2-3 or W2-4) is fulfilled/met/satisfied. For the event W2, the inequality W2-1 (Entering condition 1) may be Ms+Hys<Thresh1; the inequality W2-2 (Entering condition 2) may be Mn−Hys>Thresh2; the inequality W2-3 (Leaving condition 1) may be Ms−Hys>Thresh1; and/or the inequality W2-4 (Leaving condition 2) may be Mn+Hys<Thresh2. Ms may be a measurement result of WLAN(s) which matches (all) WLAN identifiers of at least one entry within wlan-MobilitySet in VarWLAN-MobilityConfig, and/or may not take into account offsets. Mn may be a measurement result of WLAN(s) configured in the measurement object which does not match (all) WLAN identifiers of an entry within wlan-MobilitySet in VarWLAN-MobilityConfig, and/or may not take into account offsets. Hys may be a hysteresis parameter for this event. Thresh1 may be a threshold parameter for this event (i.e. w2-Threshold1 as defined within reportConfigInterRAT for this event). Thresh2 may be a threshold parameter for this event (i.e. w2-Threshold2 as defined within reportConfigInterRAT for this event). Mn and/or Ms may be expressed in dBm. Hys may be expressed in dB. Thresh1 may be expressed in the same unit as Ms. Thresh2 may be expressed in the same unit as Mn.

In an example, the event W3 may be (e.g., all) WLAN (e.g., WiFi signal and/or signal from an access point of WLAN) inside WLAN mobility set becomes worse than a threshold. An entering condition for this event may be considered to be satisfied when condition W3-1 is fulfilled/met/satisfied. A leaving condition for this event may be considered to be satisfied when condition W3-2 is fulfilled/met/satisfied. For the event W3, the inequality W3-1 (Entering condition) may be Ms+Hys<Thresh, and/or the inequality W3-2 (Leaving condition) may be Ms−Hys>Thresh. Ms may be a measurement result of WLAN(s) which matches (all) WLAN identifiers of at least one entry within wlan-MobilitySet in VarWLAN-MobilityConfig, and/or may not take into account any offsets. Hys may be a hysteresis parameter for this event. Thresh may be a threshold parameter for this event (i.e. w3-Threshold as defined within reportConfigInterRAT for this event). Ms may be expressed in dBm. Hys may be expressed in dB. Thresh may be expressed in the same unit as Ms.

In an example, the event V1 may be a channel busy ratio (CBR) (e.g., of a resource pool or of a cell) is above a threshold. An entering condition for this event may be considered to be satisfied when condition V1-1 is fulfilled/met/satisfied. A leaving condition for this event may be considered to be satisfied when condition V1-2 is fulfilled/met/satisfied. For the event V1, the inequality V1-1 (Entering condition) may be Ms−Hys>Thresh, and/or the inequality V1-2 (Leaving condition) may be Ms+Hys<Thresh. Ms may be a measurement result of CBR of a transmission resource pool and/or a cell (e.g., unlicensed spectrum/band cell), and/or may not take into account offsets. Hys may be a hysteresis parameter for this event (e.g., hysteresis as defined within reportConfigNR and/or reportConfigEUTRA for this event). Thresh may be a threshold parameter for this event (e.g., v1-Threshold as defined within reportConfigNR and/or reportConfigEUTRA). Ms may be expressed in decimal from 0 to 1 in steps of 0.01. Hys may be expressed in the same unit as Ms. Thresh may be expressed in the same unit as Ms.

In an example, the event V2 may be a channel busy ratio (CBR) (e.g., of a resource pool or of a cell) is below a threshold. An entering condition for this event may be considered to be satisfied when condition V2-1 is fulfilled/met/satisfied. A leaving condition for this event may be considered to be satisfied when condition V2-2 is fulfilled/met/satisfied. For the event V2, the inequality V2-1 (Entering condition) may be Ms+Hys<Thresh, and/or the inequality V2-2 (Leaving condition) may be Ms−Hys>Thresh. Ms may be a measurement result of CBR of a transmission resource pool and/or a cell (e.g., unlicensed spectrum/band cell), and/or may not take into account offsets. Hys may be a hysteresis parameter for this event (e.g., hysteresis as defined within reportConfigNR and/or reportConfigEUTRA for this event). Thresh may be a threshold parameter for this event (e.g., v2-Threshold as defined within reportConfigNR and/or reportConfigEUTRA). Ms may be expressed in decimal from 0 to 1 in steps of 0.01. Hys may be expressed in the same unit as Ms. Thresh may be expressed in the same unit as Ms.

In an example, the event H1 may be a (aerial) UE height (e.g., height/altitude of location of a wireless device) is above a threshold. An entering condition for this event may be considered to be satisfied when condition H1-1 is fulfilled/met/satisfied. A leaving condition for this event may be considered to be satisfied when condition H1-2 is fulfilled/met/satisfied. For the event H1, the inequality H1-1 (Entering condition) may be Ms−Hys>Thresh+Offset, and/or the inequality H1-2 (Leaving condition) may be Ms+Hys<Thresh+Offset. Ms may be a (aerial) UE height (e.g., height/altitude of location of a wireless device), and/or may not take into account offsets. Hys may be a hysteresis parameter (e.g., h1-Hysteresis as defined within reportConfigNR and/or reportConfigEUTRA) for this event. Thresh may be a reference threshold parameter for this event given in MeasConfig (e.g., and/or execution condition configuration) (e.g., heightThreshRef as defined within MeasConfig and/or execution condition configuration). Offset may be an offset value to heightThreshRef to obtain an absolute threshold for this event (e.g., h1-ThresholdOffset as defined within reportConfigNR and/or reportConfigEUTRA). Ms may be expressed in meters/miles/feet/kilometers. Thresh may be expressed in the same unit as Ms.

In an example, the event H2 may be a (aerial) UE height (e.g., height/altitude of location of a wireless device) is below a threshold. An entering condition for this event may be considered to be satisfied when condition H2-1 is fulfilled/met/satisfied. A leaving condition for this event may be considered to be satisfied when condition H2-2 is fulfilled/met/satisfied. For the event H2, the inequality H2-1 (Entering condition) may be Ms+Hys<Thresh+Offset, and/or the inequality H2-2 (Leaving condition) may be Ms−Hys>Thresh+Offset. Ms may be a (aerial) UE height (e.g., height/altitude of location of a wireless device), and/or may not take into account offsets. Hys may be a hysteresis parameter (e.g., h2-Hysteresis as defined within reportConfigNR and/or reportConfigEUTRA) for this event. Thresh may be a reference threshold parameter for this event given in MeasConfig (e.g., and/or execution condition configuration) (e.g., heightThreshRef as defined within MeasConfig and/or execution condition configuration). Offset may be an offset value to heightThreshRef to obtain the absolute threshold for this event. (e.g., h2-ThresholdOffset as defined within reportConfigNR and/or reportConfigEUTRA). Ms may be expressed in meters. Thresh may be expressed in the same unit as Ms.

In an existing conditional handover procedure, a wireless device (UE) may execute a handover to a cell based on a handover execution condition for the cell being met. During a time gap between a reception time of the handover execution condition from a base station and the handover execution time, a radio condition or a resource situation of the wireless device may change. If, for example, a wireless device moves in a different direction before executing a handover, the conditions that triggered the handover may change. In existing technologies, a wireless device may execute/perform a handover based on limited or fixed handover execution condition for a target cell regardless of radio situation changes. The existing technologies may decrease handover reliability and radio connection robustness.

In an example embodiment, a wireless device may receive, from a base station, multiple handover execution conditions for different beam groups (e.g., different at least one beam) or different transmission and reception points (TRPs) of a handover target cell. A wireless device may execute a handover to a target cell when a handover execution condition for one of multiple beam groups (e.g., or multiple TRPs) of the target cell is met. In an example embodiment, a wireless device may receive, from a base station, a selection condition to select one of multiple handover execution conditions. The selection condition may be based on at least one of an RSRP of a target cell, a height that the wireless device locates at, a channel busy ratio (CBR) of a target cell or a source cell (e.g., resource pool), and/or the like. The wireless device may select and use, for the handover, one of the multiple handover execution conditions depending on whether the selection condition being met. The example embodiments increase handover reliability and radio connection robustness when a wireless device uses a conditional handover procedure.

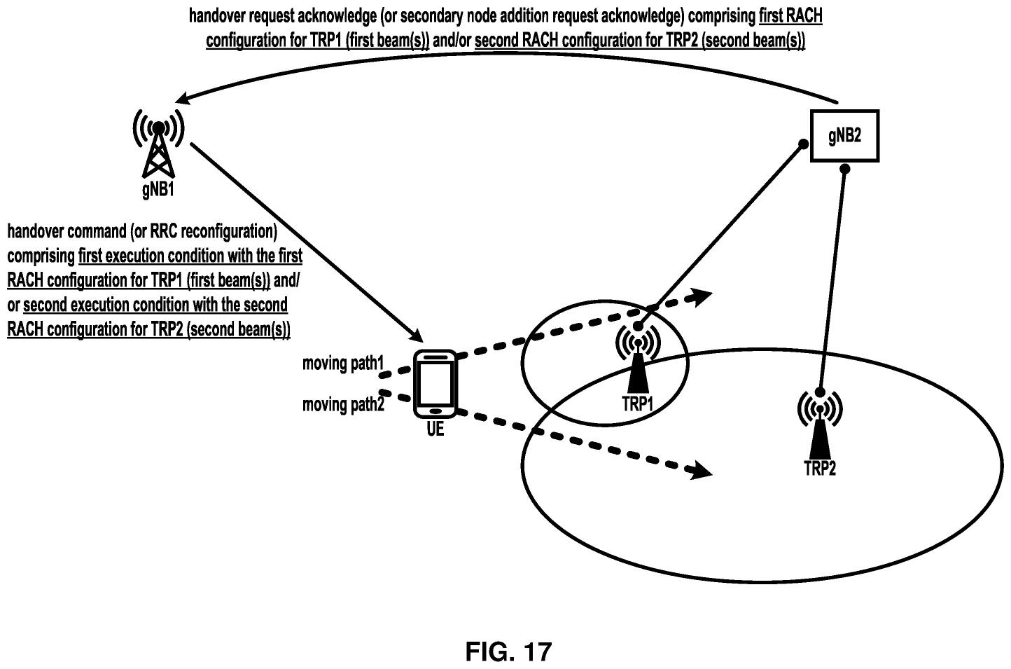

In an example, as shown in FIG. 17, a wireless device may be served by a first base station. The first base station may initiate a handover of the wireless device to a second base station. The handover may be to a cell of the second base station. The cell may be a target cell for the handover of the wireless device. The handover may be from a first cell of the first base station to the cell of the second base station. The first cell may be a primary cell of the wireless device. The first cell may be a source cell of the handover of the wireless device. The wireless device may have a radio resource control (RRC) connection with the first base station.

In an example, the first base station may initiate a secondary node (S-node) addition for the wireless device by adding/configuring one or more cells of the second base station as a secondary cell group (SCG) for the wireless device. The one or more cells may comprise the cell of the second base station. The first cell may be a primary cell of the wireless device. The cell may become a primary secondary cell (PScell), a primary secondary cell group cell (PScell), and/or a secondary cell of the wireless device based on the secondary node addition.

In an example, the first base station may be the second base station. In an example, the first base station or the second base station comprises the cell.

In an example, the first base station and the second base station may be connected to each other via a direct interface and/or an indirect interface. The direct interface may comprise at least one of: an Xn interface, an X2 interface, an F1 interface, and/or the like. The indirect interface may comprise an N2 interface, N3 interface, S1 interface, at least one mobility management entity (MME), at least one access and mobility management function (AMF), one or more core network nodes, and/or the like.

In an example, the wireless device may receive, from the first base station, at least one radio resource control (RRC) configuration message. The at least one RRC configuration message may comprise: a first execution condition for at least one first beam (e.g., a first transmission and reception point (TRP), a first control resource set (CORESET) group, a first transmission configuration indicator (TCI) state, etc.) of the cell (e.g., of the second base station); and a second execution condition for at least one second beam (e.g., a second TRP, a second CORESET group, a second TCI state, etc.) of the cell. The wireless device may monitor whether at least one of the first execution condition or the second execution condition is met. The wireless device may select the at least one first beam or the at least one second beam based on the first execution condition or the second execution condition being met. The wireless device may send a random access preamble via a radio resource, associated with the at least one selected beam, for a random access to the cell.

In an example, the wireless device may receive, from the first base station, the at least one RRC configuration message. The at least one RRC message may comprise: a first execution condition for the cell; a second execution condition for the cell; and a selection condition for selecting between the first execution condition and the second execution condition. The wireless device may determine whether the selection condition is met. The wireless device may determine, based on the selection condition being met, whether the first execution condition is met. The wireless device may determine, based on the selection condition not being met, whether the second execution condition is met. The wireless device may send, based on the first execution condition or the second execution condition being met, a random access preamble via a radio resource associated with the first execution condition or the second execution condition for a random access to the cell. In an example, the selection condition may be associated with at least one of: an RSRP/RSRQ of the cell (e.g., for selecting between a first uplink carrier and a second uplink carrier of the cell); a measurement results of a third cell (e.g., secondary cell of the wireless device associated with the first cell and/or the cell); a channel busy ratio (CBR) of the cell or the first cell (e.g., unlicensed spectrum, V2X resource pool, etc.); a received signal strength indicator (RSSI) of the cell (e.g., unlicensed spectrum, V2X resources, etc.); a height/altitude of a location of the wireless device; and/or the like.

In an example, the wireless device may send, to the first base station, measurement results of the cell. The wireless device may send the measurement results of the cell via at least one uplink RRC message to the first base station. The measurement results may comprise at least one of: a measurement result (e.g., RSRP, RSRQ, SINR, and/or the like based on layer 3 filtering of layer 1 beam measurement results) of the cell. The measurement results may comprise at least one of: a first measurement result (e.g., RSRP, RSRQ, SINR, etc.) of the at least one first beam; a second measurement result (e.g., RSRP, RSRQ, SINR, etc.) of the at least one second beam; and/or the like. In an example, the at least one first beam or the at least one second beam may comprise at least one of: a synchronization signal block (SSB) beam; a channel state information reference signal (CSI-RS) beam; and/or the like. In an example, the at least one first beam may be associated with at least one first spatial domain filter. In an example, the at least one second beam may be associated with at least one second spatial domain filter. In an example, the at least one first beam may be transmitted by the first TRP of the second base station. In an example, the at least one second beam may be transmitted by the second TRP of the second base station. In an example, the at least one first beam may be associated with the first CORESET group. In an example, the at least one second beam may be associated with the second CORESET group. In an example, the at least one first beam may be associated with the first TCI state. In an example, the at least one second beam may be associated with the second TCI state.

In an example, the wireless device may receive, via the cell, at least one of: the at least one first beam (e.g., SSB or CSI-RS); the least one second beam (e.g., SSB or CSI-RS); at least one third beam; and/or the like. The wireless device may receive, from the first base station, a measurement configuration (e.g., meas-Config, via an RRC reconfiguration message) comprising beam configuration parameters (e.g., beam transmission timing, frequency, periodicity, etc.) of the at least one first beam and/or the at least one second beam. The wireless device may receive, based on the measurement configuration, an SSB and/or a CSI-RS associated with the at least one first beam and/or may receive an SSB and/or a CSI-RS associated with the at least one second beam. The wireless device may measure a received quality (e.g., RSRQ, SINR, etc.) and/or a received power (e.g., RSRP) of the at least one first beam, the at least one second beam, the at least one third beam; and/or the like. The wireless device may send, to the first base station, the measurement results of the cell based on the receiving the at least one first beam, the at least one second beam, the at least one third beam, and/or the like.

In an example, the first base station may determine, based on the measurement results, a radio resource configuration initiation (e.g., a handover or a secondary node addition/modification) of the first cell of the first base station for the wireless device. In an example, the first base station may determine, based on the measurement results of the cell, to initiate the handover (e.g., or to initiate a handover preparation) of the wireless device to the cell. In an example, the first base station may determine, based on the measurement results of the cell, to initiate the secondary node addition/modification (e.g., to initiate a secondary node addition/modification preparation) for the wireless device. The secondary node addition comprises adding/configuring a secondary cell group (SCG) comprising the cell (e.g., PScell).

In an example, based on determining the radio resource configuration initiation (e.g., the handover, the handover preparation, the secondary node addition/modification, the secondary node addition/modification preparation, etc.), the first base station may send, to the second base station, a request message for the radio resource configuration initiation of the wireless device. The request message may be a handover request message for the handover of the wireless device. The request message may be, for the secondary node addition/modification of the wireless device, at least one of: a secondary node addition request message (e.g., S-node addition request message, SeNB addition request message, etc.); a secondary node modification request message (e.g., S-node modification request message, SeNB modification request message, etc.); and/or the like. In an example, the first base station may send, to the second base station, the handover request message for the handover of the wireless device. In an example, the first base station may send, to the second base station, a configuration request message (e.g., the secondary node addition request message or the secondary node modification request message) for the secondary node configuration (e.g., the secondary node addition/modification) for the wireless device.

In an example, the first base station may send the request message to the second base station via the direct interface (e.g., the Xn interface and/or the X2 interface) between the first base station and the second base station. In an example, the first base station may send indication of the request of the radio resource configuration initiation (e.g., the handover or the secondary node addition/modification) via the indirect connection (e.g., comprising the one or more N2 or S1 interfaces) through the one or more core network nodes (e.g., AMF, MME, etc.). In an example, the first base station may send, to the AMF, a handover required message for the handover of the wireless device, and/or the AMF may send, to the second base station and based on the handover required message, an S1/N2 handover request message for the handover of the wireless device.

In an example, the request message may comprise the measurement results of the cell that the first base station received from the wireless device. The request message may comprise at least one of: a UE identifier of the wireless device; a cell identifier (e.g., physical cell identifier, PCI, cell global identifier, CGI, etc.) of the cell (e.g., target cell); security capability information and/or security information of the wireless device; PDU session information (e.g., PDU session list, QoS flow list, QoS, S-NSSAI, NSSAI, etc.) of the wireless device; RRC contexts (e.g., RRC configuration parameters; e.g., recommended RRC configuration parameters) of the wireless device; and/or the like.

In an example, the second base station may determine, based on the request message (e.g., the handover request message, the secondary node addition/modification request message, etc.), access information for the wireless device to access the cell. The access information may comprise random access parameters. The random access parameters of the access information may comprise a first index of a first preamble associated with the at least one first beam and/or a second index of a second preamble associated with the at least one second beam. In an example, the first preamble may be same to the second preamble.

In an example, the access information may comprise first fields for first resources associated with the at least one first beam of the cell. The first fields may comprise at least one of: a first number of configured hybrid automatic repeat request (HARQ) processes (e.g., numberOfConfUL-Processes); a first uplink grant (e.g., ul-Grant); a first uplink scheduling interval (e.g., ul-SchedInterval); a first uplink starting subframe/slot/symbol (e.g., ul-StartSubframe, ul-Slot, ul-Symbol, etc.); and/or the like. In an example, the access information may comprise second fields for second resources associated with the at least one second beam of the cell. The second fields may comprise at least one of: a second number of configured HARQ processes (e.g., numberOfConfUL-Processes); a second uplink grant (e.g., ul-Grant); a second uplink scheduling interval (e.g., ul-SchedInterval); a second uplink starting subframe/slot/symbol (e.g., ul-StartSubframe, ul-Slot, ul-Symbol, etc.); and/or the like. In an example, the wireless device may transmit transport blocks via the first resources or the second resources associated with a selected beam (e.g., the at least one first beam or the at least one second beam) to access the cell.

In an example, the first and/or second number of configured HARQ processes (e.g., numberOfConfUL-Processes) may be a number of configured HARQ processes for pre-allocated uplink grant for the wireless device (e.g., when the wireless device is configured with asynchronous HARQ). In an example, the first and/or second uplink grant (e.g., ul-Grant) may indicate resources of a target PCell/PSCell (e.g., the cell) to be used for uplink transmission of PUSCH (e.g., transport blocks). In an example, the first and/or second uplink scheduling interval (e.g., ul-SchedInterval) may indicate a scheduling interval in uplink, and/or may indicate a number of subframes/slots/symbols. Value sf2 may corresponds to 2 subframes, sf5 may correspond to 5 subframes, slot2 may corresponds to 2 slots, symbol2 may corresponds to 2 symbols (e.g., OFDM symbols), and/or the like. In an example, the first and/or second uplink starting subframe/slot/symbol (e.g., ul-StartSubframe, ul-Slot, ul-Symbol, etc.) may indicate a subframe/slot/symbol in which the wireless device may initiate an uplink transmission (e.g., transmission of transport blocks of PUSCH). Value 0 may correspond to subframe/slot/symbol number 0, 1 may correspond to subframe/slot/symbol number 1, and/or the like. A subframe/slot/symbol indicating a valid uplink grant according to calculation/determination of UL grant configured by ul-StartSubframe/Slot/Symbol and/or ul-SchedInterval/may be the same across radio frames.

In an example, the access information may comprise at least one of: a beam index of the at least one first beam (e.g., at least one SSB-Index, at least one CSI-RS-Index); an identifier of the first TRP (e.g., TRP-Index) associated with the at least one first beam; a group identifier of the first CORESET group (e.g., CORESET-Id and/or CORESET-Group-Id) associated with the first TRP and/or the at least one first beam; an identifier of the first TCI state (e.g., at least one TCI-StateId) associated with the first TRP and/or the at least one first beam; a first QCL type associated with the first TRP and/or the at least one first beam; and/or the like. In an example, the access information may comprise at least one of: a beam index of the at least one second beam (e.g., at least one SSB-Index, at least one CSI-RS-Index); an identifier of the second TRP (e.g., TRP-Index) associated with the at least one second beam; a group identifier of the second CORESET group (e.g., CORESET-Id and/or CORESET-Group-Id) associated with the second TRP and/or the at least one second beam; an identifier of a second TCI state (e.g., at least one TCI-StateId) associated with the second TRP and/or the at least one second beam; a second QCL type associated with the second TRP and/or the at least one second beam; and/or the like.

In an example, the random access parameters of the access information may be associated with at least one third beam (e.g., SSB, CSI-RS) (e.g., the at least one third beam may comprise the at least one first beam and/or the at least one second beam) for the wireless device to access the cell. The random access parameters may comprise at least one of: a beam index; a random access preamble index (e.g., integer value 0 to 63) of a random access preamble; at least one random access occasion (e.g., for CSI-RS); a reference signal received power (RSRP) value (e.g., threshold) indicating a range of received power (e.g., to perform a contention free random access procedure). In an example, the at least one third beam may be transmitted by a third TRP (e.g., the third TRP may be one of the first TRP or the second TRP). In an example, if an RSRP of the at least one third beam is in the range of received power indicated by the RSRP value, the wireless device may perform a random access using the random access preamble and/or the at least one random access occasion for the at least one third beam. In an example, if an RSRP of the at least one third beam is in the range of received power indicated by the RSRP value, the wireless device may perform a contention based random access to access the cell.

In an example, the access information may comprise a power value for the wireless device to determine initiation of a random access using the random access parameters (e.g., instead of RACH-less access for the cell; instead of transmitting transport blocks of PUSCH to access the cell). The wireless device may compare the power value with a received power of the at least one first beam and/or the at least one second beam for the initiation of the random access using the random access parameters. In an example, the access information may comprise a time value for the wireless device to determine initiation of a random access using the random access parameters. The wireless device may initiate the random access (e.g., by transmitting a random access preamble) in response to a time duration of the time value passing (e.g., in response to expiry of the time duration) since/from/after the first signal (e.g., one of the transport blocks, PUSCH, random access preamble, and/or the like to access the cell) transmission to the second base station. In an example, a random access using the random access parameters may comprise at least one of: a contention-free random access; a contention-based random access; and/or the like. In an example, a random access using the random access parameters may comprise at least one of: a 2-step random access; a 4-step random access; and/or the like. The access information may comprise a power value (e.g., threshold) for selection of the 2-step random access or the 4 step random access.

In an example, the access information may comprise configuration parameters for the wireless device to determine initiation of a random access. The configuration parameters may indicate at least one of: a two-step random access procedure (e.g., or a four-step random access procedure) for the at least one first beam; or a four-step random access procedure (e.g., or a two-step random access procedure) for the at least one second beam. The first base station may determine, based on the configuration parameters, the first execution condition or the second execution condition to execute the handover and/or the secondary node addition/modification (e.g., the SCG addition/configuration).

In an example, the access information may indicate at least one of: a first panel of the wireless device for transmission associated with the at least one first beam; a second panel of the wireless device for transmission associated with the at least one second beam; and/or the like. The wireless device may use the first panel of the wireless device to transmit the transport blocks to access the cell, in response to the selected beam being the at least one first beam. The wireless device may use the second panel of the wireless device to transmit the transport blocks to access the cell, in response to the selected beam being the at least one second beam.

In an example, the access information may be determined by at least one of: the second base station (e.g., for the handover and/or the secondary base station addition/modification of the wireless device) and/or the first base station (e.g., for the secondary base station addition/modification of the wireless device).

In an example, the second base station may send, to the first base station and in response to the request message (e.g., the handover request message, the secondary node addition/modification request message, etc.) and/or in response to determining to accept the request for the radio resource configuration initiation (e.g., the handover or the secondary node addition/modification) of the wireless device, a request acknowledge message (e.g., a handover request acknowledge message or a secondary base station addition/modification request acknowledge message) comprising the access information for the cell. In an example, the first base station may receive, from the second base station, a handover request acknowledge message (e.g., for the handover) comprising the access information for the cell. In an example, the first base station may receive, from the second base station, a configuration request acknowledge message (e.g., for the secondary node addition/modification) comprising the access information for the cell. The configuration request acknowledge message may comprise at least one of: a secondary node addition request acknowledge message (e.g., S-node addition request acknowledge message, SeNB addition request acknowledge message, etc.); a secondary node modification request acknowledge message (e.g., S-node modification request acknowledge message, SeNB modification request acknowledge message, etc.); and/or the like.

In an example, the first base station may receive, from the second base station, the handover request acknowledge message indicating acceptance of the handover. The handover request acknowledge message may indicate (e.g., via the access information) at least one of: the random access preamble (e.g., the first preamble and/or the second preamble) for the random access of the wireless device to the cell, the radio resource (e.g., the first resources and/or the second resource) for the random access to the cell, the random access parameters for the random access to the cell, the configuration parameters for the random access to the cell, and/or the like. In an example, the first base station may receive, from the second base station, the secondary node addition/modification request acknowledge message indicating acceptance of the secondary node addition/modification. The secondary node addition request acknowledge message may indicate (e.g., via the access information) at least one of: the random access preamble (e.g., the first preamble and/or the second preamble) for the random access to the cell, the radio resource (e.g., the first resources and/or the second resource) for the random access to the cell, the random access parameters for the random access to the cell, the configuration parameters (e.g., indicating the 2-step or 4-step random access process) for the random access to the cell, and/or the like.

In an example, the second base station may send the request acknowledge message to the first base station via the direct interface (e.g., the Xn interface and/or the X2 interface) between the first base station and the second base station. In an example, the second base station may send indication of the request acknowledge of the radio resource configuration initiation (e.g., the handover or the secondary node addition/modification) via the indirect connection (e.g., comprising the one or more N2 or S1 interfaces) through the one or more core network nodes (e.g., AMF, MME, etc.). In an example, the second base station may send, to the AMF, an S1/N2 handover request acknowledge message for the handover of the wireless device, and/or the AMF may send, to the first base station and based on the handover request acknowledge message, an S1/N2 handover command message for the handover of the wireless device.

In an example, the request acknowledge message and/or the indication of the request acknowledge may comprise at least one of: a UE identifier of the wireless device; a cell identifier (e.g., physical cell identifier, PCI, cell global identifier, CGI, etc.) of the cell (e.g., target cell, PSCell); security capability information and/or security information of the wireless device; PDU session information (e.g., accepted/setup/modified/rejected/released PDU session list, QoS flow list, QoS, S-NSSAI, NSSAI, etc.) of the wireless device; RRC contexts (e.g., RRC configuration parameters that may be configured based on the measurement results of the wireless device for the cell) of the wireless device; and/or the like.

In an example, the first base station may receive from the second base station, the random access parameters (e.g., via the access information) for the random access of the wireless device to the cell. The random access parameters may comprise at least one of: first resource configuration parameters indicating a first radio resource (e.g., the first resources) associated with the at least one first beam; second resource configuration parameters indicating a second radio resource (e.g., the second resources) associated with the at least one second beam; a first preamble index (e.g., the first index of the first preamble) associated with the at least one first beam; a second preamble index (e.g., the second index of the second preamble) associated with the at least one second beam; and/or the like. In an example, the first radio resource or the second radio resource may comprise the radio resource that may be used by the wireless device to perform the random access to the cell. The first preamble index or the second preamble index may indicate the random access preamble that may be used by the wireless device to perform the random access to the cell.

In an example, the first resources and/or the first radio resources for the random access to the cell may be resources of a UL (e.g., normal uplink; e.g., high frequency carrier) of the cell. In an example, the second resources and/or the second radio resources for the random access to the cell may be resources of an SUL (e.g., supplementary uplink; e.g., low frequency carrier) of the cell.

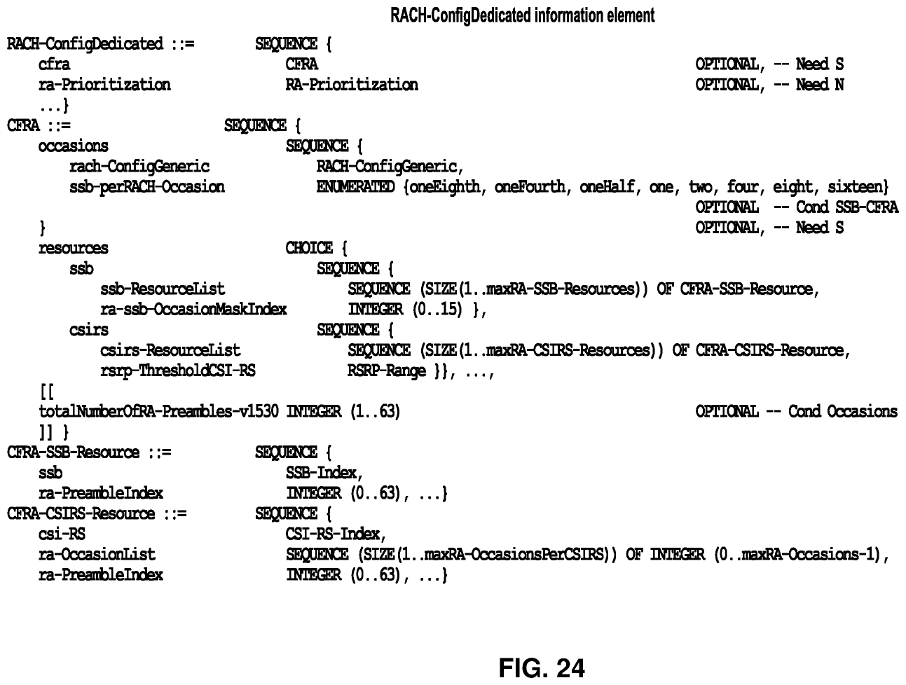

In an example, the first resources and/or the first radio resources for the random access to the cell may be sent, from the second base station to the second base station, via at least one of: separate RACH-ConfigDedicateds in a CellGroupConfig of an RRC container of the request acknowledge message; separate ssb/csirs-ResourceLists in a RACH-ConfigDedicated in a CellGroupConfig of an RRC container of the request acknowledge message; and/or the like. FIG. 24 shows an example structure of the RACH-ConfigDedicated.

In an example, the first base station may determine multiple execution conditions for the wireless device to execute the handover and/or the secondary node addition/modification. In an example, based on the request acknowledge message (e.g., the handover request acknowledge message or the secondary node addition request acknowledge message), the first base station may determine a first execution condition and a second execution condition for the wireless device to execute the handover or the secondary node addition/modification. In an example, the first execution condition and/or the second execution condition may comprise at least one of: a handover execution condition for the handover to the cell; a secondary node addition execution condition for the secondary node addition adding/configuring the secondary cell group comprising the cell; a secondary cell group addition execution condition adding/configuring the secondary cell group comprising the cell; a secondary cell addition execution condition for adding/configuring a secondary cell (e.g., the cell); an initiation condition of a random access procedure for the random access (e.g., for the handover or the secondary node addition/modification) to the cell; and/or the like.

In an example, the first base station may determine the first execution condition and/or the second execution condition based on at least one of: the access information; the random access parameters of the access information; the configuration parameters (e.g., indicating the 2-step or 4-step random access process) of the access information for the random access to the cell; the measurement results of the cell that the first base station received from the wireless device; and/or the like.

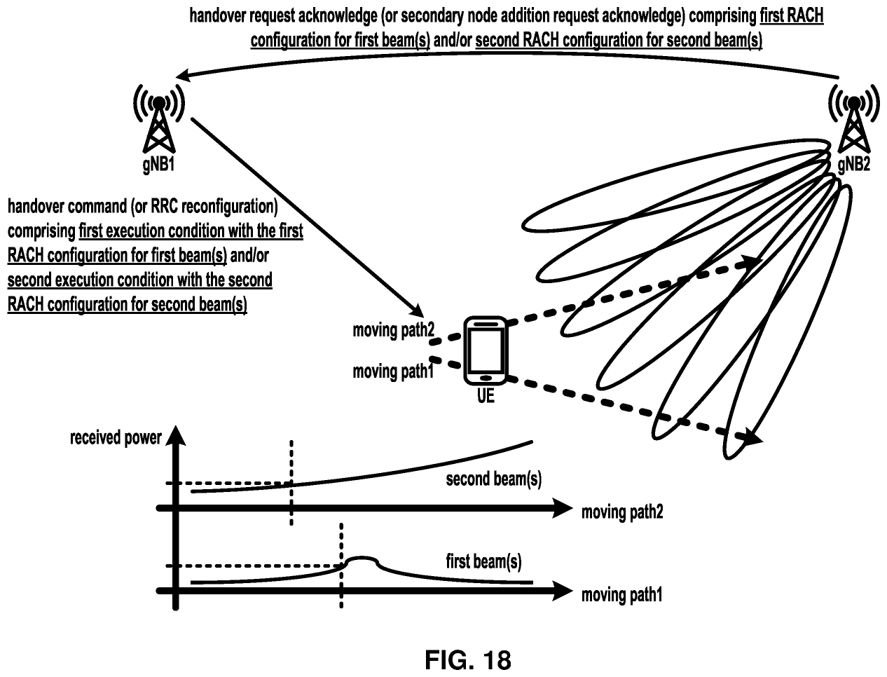

In an example, as shown in FIG. 17 and/or FIG. 18, the first base station may determine at least one of: the first execution condition for the at least one first beam; the second execution condition for the at least one second beam; and/or the like. In an example, the second base station may determine at least one of: the first execution condition for the at least one first beam; the second execution condition for the at least one second beam; and/or the like. The first execution condition may be based on the first RSRP/RSRQ/SINR of the at least one first beam in the measurement results. The second execution condition may be based on the second RSRP/RSRQ/SINR of the at least one second beam in the measurement results. The first base station may determine, based on the measurement results, the first execution condition or the second execution condition. The first execution condition may be applied when the wireless device moves towards the at least one first beams and/or the first TRP. The second execution condition may be applied when the wireless device moves towards the at least one second beams and/or the second TRP. In an example, for the case that the wireless device moves fast towards the at least one first beam and/or the first TRP, the first execution condition may be configured to delay/avoid executing the handover because the coverage of the at least one first beam and/or the first TRP in the moving direction is small and may cause a link failure of the wireless device. In an example, for the case that the wireless device moves fast towards the at least one second beam and/or the second TRP, the second execution condition may be configured to speed up executing the handover because the coverage of the at least one first beam and/or the first TRP in the moving direction is reliable for the wireless device (e.g., a late handover execution may cause a link failure from the source serving cell).

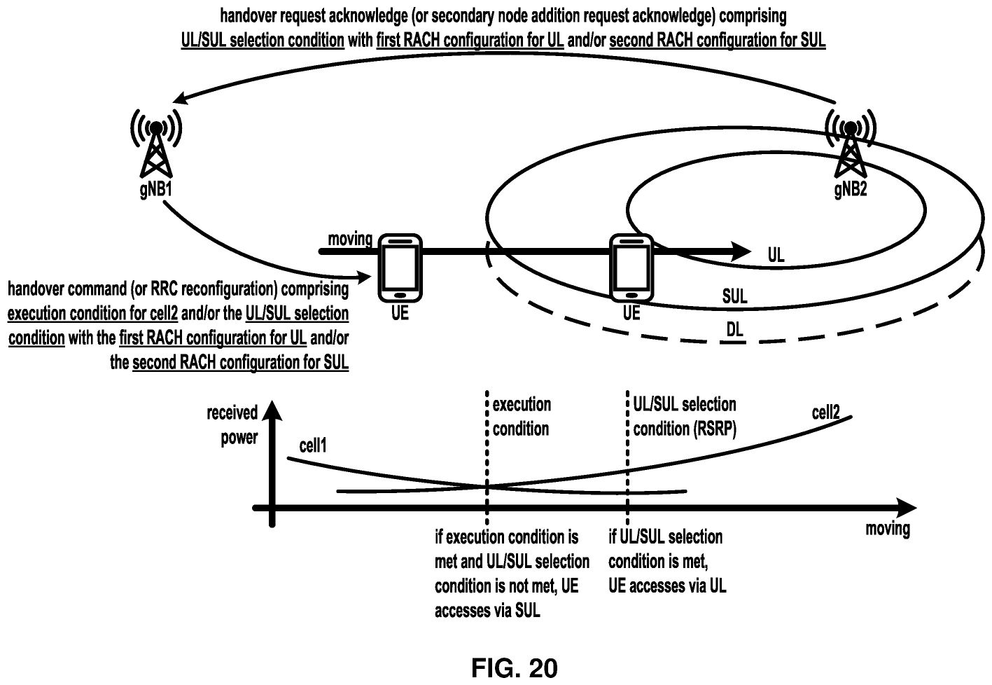

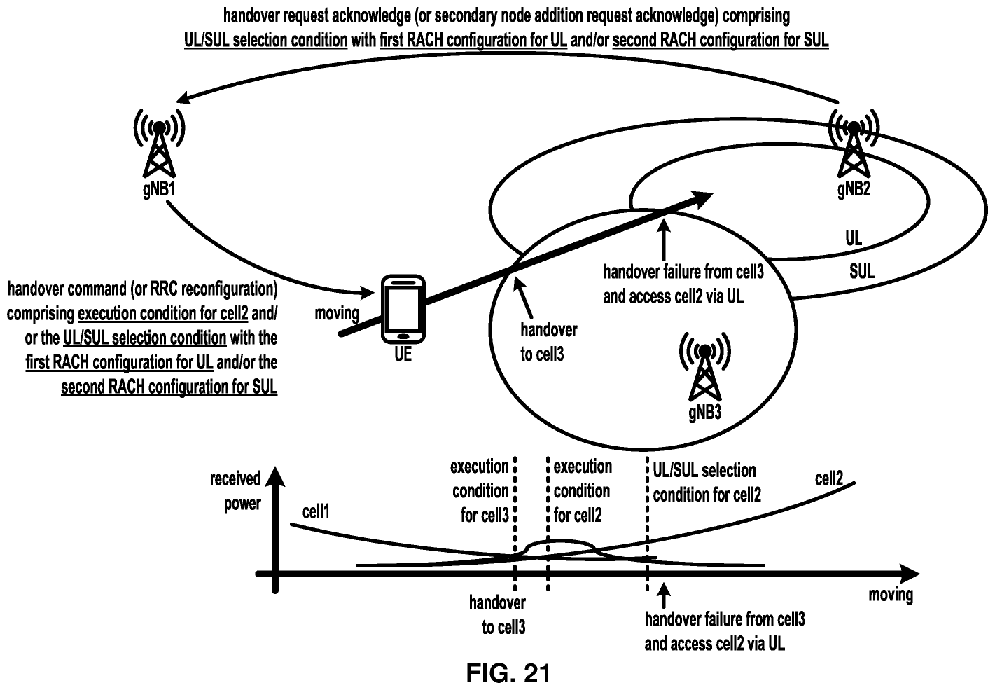

In an example, as shown in FIG. 20 and/or FIG. 21, the first base station may determine an execution condition for the handover, the secondary node addition/modification, and/or the random access of the wireless device to the cell. The request acknowledge message may comprise an UL/SUL selection condition (e.g., RSRP/RSRQ/SINR threshold of the cell). The wireless device may receive the execution condition for the cell and/or the UL/SUL selection condition. The wireless device may determine whether the execution condition is met. If the execution condition is met, the wireless device may select the UL (e.g., normal uplink) or the SUL (e.g., supplementary uplink) depending on whether the UL/SUL selection condition being met. In an example, if an RSRP of the cell is equal to or larger than the RSRP threshold (e.g., the UL/SUL selection condition), the wireless device may select the UL for the random access and/or may send the random access preamble via the first resources and/or the first radio resources of the UL. In an example, if an RSRP of the cell is equal to or small than the RSRP threshold (e.g., the UL/SUL selection condition), the wireless device may select the SUL for the random access and/or may send the random access preamble via the second resources and/or the second radio resources of the UL.

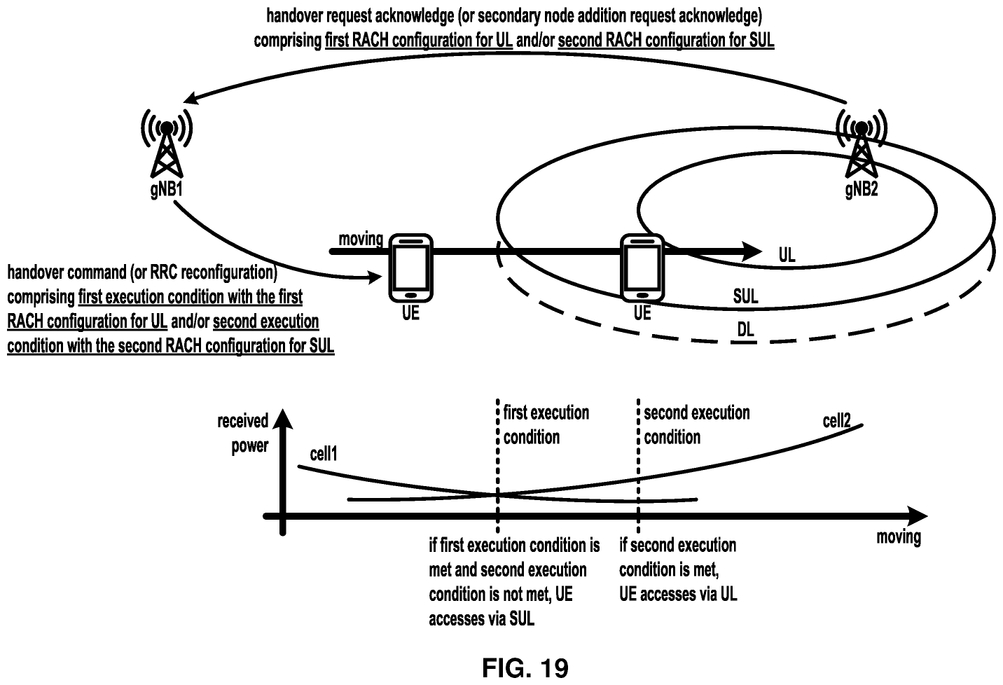

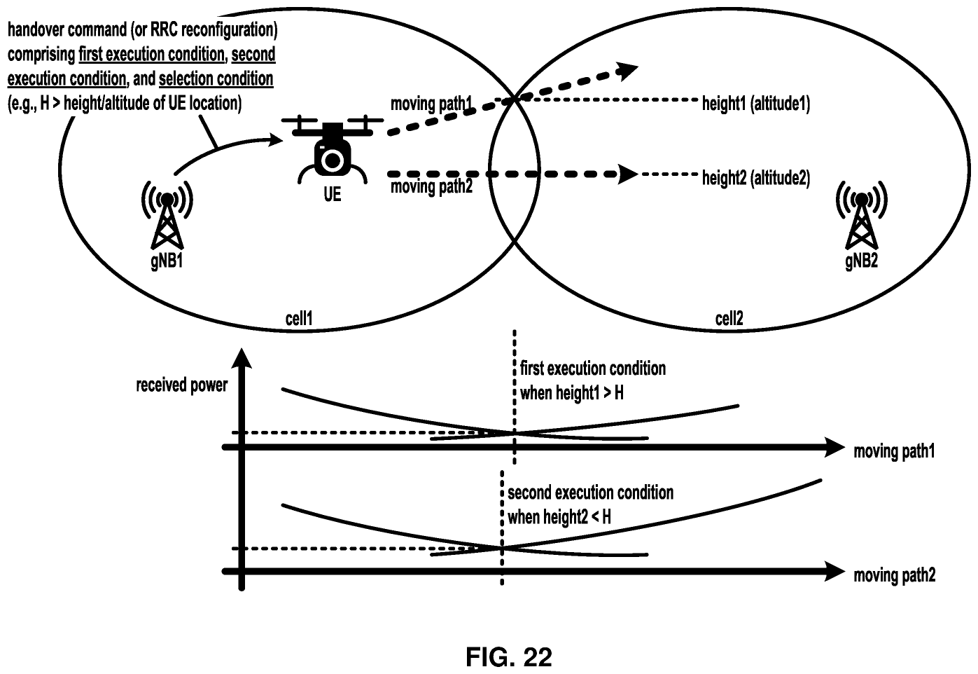

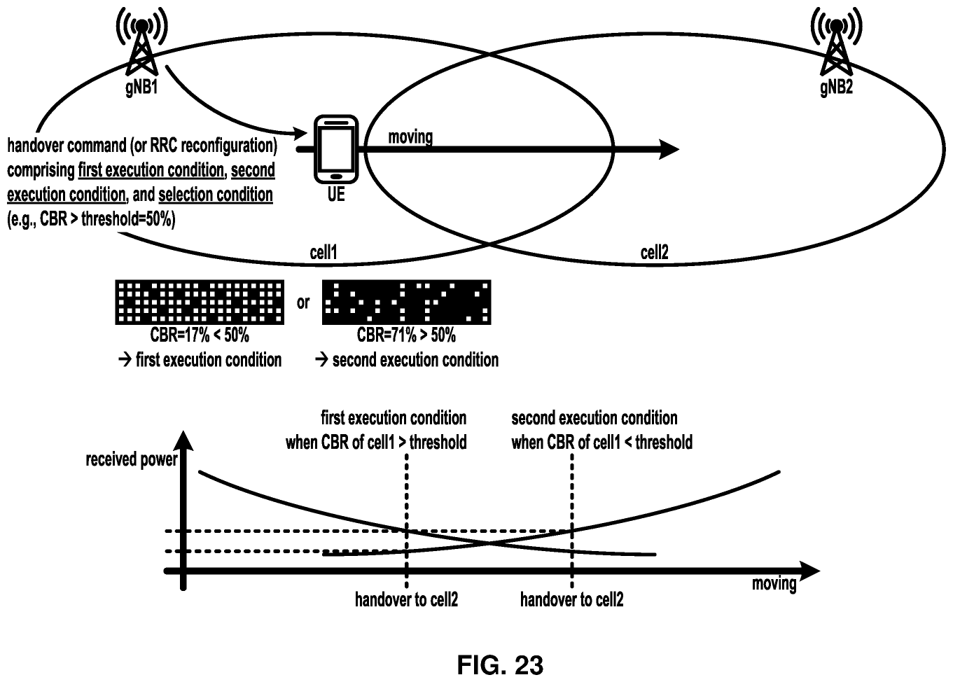

In an example, as shown in FIG. 19, FIG. 22, and/or FIG. 23, the first base station may determine: the first execution condition for the cell; the second execution condition for the cell; and a selection condition for selecting between the first execution condition and the second execution condition. In an example, the selection condition may be associated with at least one of: an RSRP/RSRQ of the cell (e.g., for selecting between a first uplink carrier and a second uplink carrier of the cell as shown in FIG. 19); a measurement results of a third cell (e.g., secondary cell of the wireless device associated with the first cell and/or the cell); a height/altitude of a location of the wireless device (as shown in FIG. 22); a channel busy ratio (CBR) of the cell or the first cell (e.g., unlicensed spectrum, V2X resource pool, etc. as shown in FIG. 23); a received signal strength indicator (RSSI) of the cell (e.g., unlicensed spectrum, V2X resources, etc. as shown in FIG. 23); and/or the like. In an example, the wireless device may use the first execution condition to execute the handover, the secondary node addition/modification, and/or the random access to the cell if the selection condition is met/satisfied/fulfilled. In an example, the wireless device may use the second execution condition to execute the handover, the secondary node addition/modification, and/or the random access to the cell if the selection condition is not met/satisfied/fulfilled.

In an example, as shown in FIG. 19, the first base station may determine at least one of: the first execution condition for the UL (e.g., the first uplink) of the cell; the second execution condition for the SUL (e.g., the second uplink) of the cell; and/or the like. In an example, the second base station may determine at least one of: the first execution condition for the UL (e.g., the first uplink) of the cell; the second execution condition for the SUL (e.g., the second uplink) of the cell; and/or the like. The first base station may receive, from the second base station, the selection condition (e.g., the UL/SUL selection condition (e.g., RSRP/RSRQ/SINR threshold of the cell)). In an example, the wireless device may use the first execution condition to execute the handover, the secondary node addition/modification, and/or the random access to the cell if the selection condition is met/satisfied/fulfilled (e.g., RSRP of the cell is equal to or larger than the RSRP threshold). In an example, the wireless device may use the second execution condition to execute the handover, the secondary node addition/modification, and/or the random access to the cell if the selection condition is not met/satisfied/fulfilled (e.g., RSRP of the cell is equal to or smaller than the RSRP threshold).

The first base station may determine, based on the measurement results, the first execution condition and/or the second execution condition. The first execution condition and/or the second execution condition may be based on RSRP/RSRQ/SINR of the cell in the measurement results. The first execution condition may be applied when the wireless device moves to the coverage of the UL of the cell (e.g., moves to the center of the cell). The second execution condition may be applied when the wireless device moves around the coverage of SUL (e.g., out of coverage of the UL) of the cell (e.g., moves around edge area of the cell).

In an example, for the case that the wireless device moves fast towards the coverage of the UL of the cell, the first execution condition may be configured to delay/avoid executing the handover to the cell because the coverage of the UL of the cell is small and may cause a link failure of the wireless device. In an example, for the case that the wireless device moves fast around the coverage of the SUL, the second execution condition may be configured to speed up executing the handover because the coverage of the SUL of the cell in the moving direction may be reliable for the wireless device (e.g., a late handover execution may cause a link failure from the source serving cell).

In an example, as shown in FIG. 22, the first base station may determine at least one of: the first execution condition for a high altitude/height of the cell; the second execution condition for a low altitude/height of the cell; and/or the like. In an example, the second base station may determine at least one of: the first execution condition for the high altitude/height of the cell; the second execution condition for the low altitude/height of the cell; and/or the like. The first base station (and/or the second base station) may determine the selection condition (e.g., height/altitude threshold; 30 feet, 50 m, etc.). In an example, the wireless device may use the first execution condition to execute the handover, the secondary node addition/modification, and/or the random access to the cell if the selection condition is met/satisfied/fulfilled (e.g., height/altitude of the wireless device is higher than the height/altitude threshold). In an example, the wireless device may use the second execution condition to execute the handover, the secondary node addition/modification, and/or the random access to the cell if the selection condition is not met/satisfied/fulfilled (e.g., height/altitude of the wireless device is lower than the height/altitude threshold).

The first base station may determine, based on the measurement results, the first execution condition, the second execution condition, and/or the selection condition. The first execution condition, the second execution condition, and/or the selection condition may be based on RSRP/RSRQ/SINR of the cell and/or height/altitude of the wireless device in the measurement results. The first execution condition may be applied when the wireless device moves to a high altitude/height of the cell (e.g., moves to higher than the height/altitude threshold). The second execution condition may be applied when the wireless device moves to a low altitude/height of the cell (e.g., moves to lower than the height/altitude threshold).

In an example, for the case that the wireless device moves towards a high altitude/height of the cell, the first execution condition may be configured to speed up executing the handover to the cell because an overlapping coverage of the source cell and the cell may be small at the high altitude/height and the small overlapping coverage may cause a link failure of the wireless device if the handover is delayed. In an example, for the case that the wireless device moves in a low altitude/height of the cell, the second execution condition may be configured to execute the handover in a normal speed (or based on handover policies) because the overlapping coverage of the source cell and the cell in the moving direction may be large and may provide a reliable connection during the execution (e.g., access procedure, random access) to the cell for the wireless device.

In an example, as shown in FIG. 23, the first base station may determine at least one of: the first execution condition for a high CBR/RSSI of the source cell (e.g., unlicensed spectrum cell, sidelink resource pool of the source cell, etc.) or the cell (e.g., unlicensed spectrum cell, sidelink resource pool of the cell, etc.); the second execution condition for a low CBR/RSSI of the source cell (e.g., unlicensed spectrum cell, sidelink resource pool of the source cell, etc.) or the cell (e.g., unlicensed spectrum cell, sidelink resource pool of the cell, etc.); and/or the like. In an example, the second base station may determine at least one of: the first execution condition for the high CBR/RSSI of the source cell or the cell; the second execution condition for the low CBR/RSSI of the source cell or the cell; and/or the like. The first base station (and/or the second base station) may determine the selection condition (e.g., CBR/RSSI of the source cell is equal to or higher than a first CBR/RSSI threshold; and/or CBR/RSSI of the cell is equal to or higher than a second CBR/RSSI threshold). In an example, the wireless device may use the first execution condition to execute the handover, the secondary node addition/modification, and/or the random access to the cell if the selection condition is met/satisfied/fulfilled (e.g., if CBR/RSSI of the source cell is equal to or higher than the first CBR/RSSI threshold; and/or if CBR/RSSI of the cell is equal to or higher than the second CBR/RSSI threshold). In an example, the wireless device may use the second execution condition to execute the handover, the secondary node addition/modification, and/or the random access to the cell if the selection condition is not met/satisfied/fulfilled (e.g., if CBR/RSSI of the source cell is equal to or lower than the first CBR/RSSI threshold; and/or if CBR/RSSI of the cell is equal to or lower than the second CBR/RSSI threshold).

The first base station may determine, based on the measurement results (e.g., CBR/RSSI of the source cell and/or the cell), the first execution condition, the second execution condition, and/or the selection condition. The first execution condition, the second execution condition, and/or the selection condition may be based on RSRP/RSRQ/SINR of the cell and/or CBR/RSSI of the source cell and/or the cell in the measurement results. The first execution condition may be applied when the wireless device detects/measures/determines that CBR/RSSI of the source cell is equal to or higher than the first CBR/RSSI threshold and/or that CBR/RSSI of the cell is equal to or higher than the second CBR/RSSI threshold. The second execution condition may be applied when the wireless device detects/measures/determines that CBR/RSSI of the source cell is equal to or lower than the first CBR/RSSI threshold and/or that CBR/RSSI of the cell is equal to or lower than the second CBR/RSSI threshold.

In an example, for the case that the wireless device detects/measures/determines CBR/RSSI of the source cell is equal to or higher than the first CBR/RSSI threshold, the first execution condition may be configured to execute the handover early to the cell because the wireless device may get more radio resources and/or better service quality in the cell (e.g., the target cell), for example, than in the source cell. In an example, for the case that the wireless device detects/measures/determines CBR/RSSI of the source cell is equal to or lower than the first CBR/RSSI threshold, the second execution condition may be configured to execute the handover late to the cell because the wireless device may get more radio resources and/or better service quality in the source cell (e.g., the current serving cell), for example, than in the cell (e.g., the target cell).

In an example, for the case that the wireless device detects/measures/determines CBR/RSSI of the cell (e.g., the target cell) is equal to or higher than the second CBR/RSSI threshold, the first execution condition may be configured to execute the handover late to the cell because the wireless device may get more radio resources and/or better service quality in the source cell (e.g., the current serving cell), for example, than in the cell (e.g., the target cell). In an example, for the case that the wireless device detects/measures/determines CBR/RSSI of the cell (e.g., the target cell) is equal to or lower than the second CBR/RSSI threshold, the second execution condition may be configured to execute the handover early to the cell because the wireless device may get more radio resources and/or better service quality in the cell (e.g., the target cell), for example, than in the source cell.

In an example, the first execution condition may comprise at least one of: the event A1, the event A2, the event A3, the event A4, the event A5, the event A6, the event B 1, the event B2, the event C1, the event C2, the event W1, the event W2, the event W3, the event V1, the event V2, the event H1, the event H2, and/or the like. The first execution condition may comprise the “AND combination” or the “OR combination” of at least one of: the event A1, the event A2, the event A3, the event A4, the event A5, the event A6, the event B 1, the event B2, the event C1, the event C2, the event W1, the event W2, the event W3, the event V1, the event V2, the event H1, the event H2, and/or the like.

In an example, the first execution condition may indicate at least one of:
Event A1/C1 (Serving becomes better than threshold): a measurement result of a first cell (e.g., and/or at least one beam of the first cell) of the first base station becomes worse than a value;
Event A2 (Serving becomes worse than threshold): a measurement result of the first cell (e.g., and/or at least one beam of the first cell) becomes worse than a value;
Event A3/C2 (Target becomes offset better than PCell/PSCell): a measurement result of the at least one first beam of the cell becomes offset better than a measurement result of the first cell (e.g., and/or at least one beam of the first cell);
Event A4/C1 (Target becomes better than threshold): a measurement result of the at least one first beam of the cell becomes better than a value;
Event A5 (PCell/PSCell becomes worse than threshold1 and target becomes better than threshold2): a measurement result of the first cell (e.g., and/or at least one beam of the first cell) becomes worse than a value and a measurement result of the at least one first beam of the cell becomes better than a value;
Event A6 (Target becomes offset better than SCell): a measurement result of the at least one first beam of the cell becomes offset better than a measurement result of a secondary cell (e.g., and/or at least one beam of the secondary cell) of the wireless device;
Event B1 (Inter RAT target becomes better than threshold): a measurement result of the at least one first beam of the cell (e.g., inter-RAT cell) becomes better than a value;
Event B2 (PCell becomes worse than threshold1 and inter RAT target becomes better than threshold2): a measurement result of the first cell (e.g., and/or at least one beam of the first cell) becomes worse than a value and a measurement result of the at least one first beam of the cell (e.g., inter-RAT cell) becomes better than a value;
Event W1 (WLAN becomes better than a threshold);
Event W2 (All WLAN inside WLAN mobility set becomes worse than threshold1 and a WLAN outside WLAN mobility set becomes better than threshold2);
Event W3 (All WLAN inside WLAN mobility set becomes worse than a threshold);
Event V1 (The channel busy ratio is above a threshold);
Event V2 (The channel busy ratio is below a threshold);
Event H1 (The Aerial UE height is above a threshold);
Event H2 (The Aerial UE height is below a threshold); and/or the like.

In an example, the second execution condition may comprise at least one of: the event A1, the event A2, the event A3, the event A4, the event A5, the event A6, the event B 1, the event B2, the event C1, the event C2, the event W1, the event W2, the event W3, the event V1, the event V2, the event H1, the event H2, and/or the like. The second execution condition may comprise the “AND combination” or the “OR combination” of at least one of: the event A1, the event A2, the event A3, the event A4, the event A5, the event A6, the event B1, the event B2, the event C1, the event C2, the event W1, the event W2, the event W3, the event V1, the event V2, the event H1, the event H2, and/or the like.

In an example, the second execution condition may indicate at least one of:
Event A1/C1 (Serving becomes better than threshold): a measurement result of a first cell (e.g., and/or at least one beam of the first cell) of the first base station becomes worse than a value;
Event A2 (Serving becomes worse than threshold): a measurement result of the first cell (e.g., and/or at least one beam of the first cell) becomes worse than a value;
Event A3/C2 (Target becomes offset better than PCell/PSCell): a measurement result of the at least one second beam of the cell becomes offset better than a measurement result of the first cell (e.g., and/or at least one beam of the first cell);
Event A4/C1 (Target becomes better than threshold): a measurement result of the at least one second beam of the cell becomes better than a value;
Event A5 (PCell/PSCell becomes worse than threshold1 and target becomes better than threshold2): a measurement result of the first cell (e.g., and/or at least one beam of the first cell) becomes worse than a value and a measurement result of the at least one second beam of the cell becomes better than a value;
Event A6 (Target becomes offset better than SCell): a measurement result of the at least one second beam of the cell becomes offset better than a measurement result of a secondary cell (e.g., and/or at least one beam of the secondary cell) of the wireless device;
Event B1 (Inter RAT target becomes better than threshold): a measurement result of the at least one second beam of the cell (e.g., inter-RAT cell) becomes better than a value;
Event B2 (PCell becomes worse than threshold1 and inter RAT target becomes better than threshold2): a measurement result of the first cell (e.g., and/or at least one beam of the first cell) becomes worse than a value and a measurement result of the at least one second beam of the cell (e.g., inter-RAT cell) becomes better than a value;
Event W1 (WLAN becomes better than a threshold);
Event W2 (All WLAN inside WLAN mobility set becomes worse than threshold1 and a WLAN outside WLAN mobility set becomes better than threshold2);
Event W3 (All WLAN inside WLAN mobility set becomes worse than a threshold);
Event V1 (The channel busy ratio is above a threshold);
Event V2 (The channel busy ratio is below a threshold);
Event H1 (The Aerial UE height is above a threshold);
Event H2 (The Aerial UE height is below a threshold); and/or the like.

In an example, the first base station may send at least one RRC configuration message (e.g., a handover command message (e.g., a handover command) and/or an RRC reconfiguration message) to the wireless device and based on the handover request acknowledge message or the secondary node addition/modification request acknowledge message. In an example, the wireless device may receive, from the first base station, the at least one RRC configuration message. In an example, the at least one RRC configuration message may comprise at least one of: a handover command message (e.g., comprising an RRC reconfiguration message); an RRC reconfiguration message (e.g., for addition/configuration of the SCG comprising the cell); and/or the like. In an example, the handover command message (e.g., comprising an RRC reconfiguration message configured by the second base station) may be configured by the second base station, and the first base station may forward the handover command to the wireless device. The at least one RRC configuration message (e.g., the handover command message and/or the RRC reconfiguration message) may be based on the handover request acknowledge message and/or the secondary node addition/modification request acknowledge message. The handover request acknowledge message may comprise the RRC reconfiguration message (e.g., comprising the access information) that is the handover command message.

In an example, the at least one RRC configuration message may comprise at least one of: the access information, the random access parameters (e.g., for the random access to the cell) of the access information, the configuration parameters (e.g., indicating the 2-step or 4-step random access process) of the access information, the index of the random access preamble (e.g., the first preamble and/or the second preamble) for the random access to the cell, resource information indicating the radio resource (e.g., the first resources and/or the second resource) for the random access to the cell, and/or the like.

In an example, the at least one RRC configuration message may comprise the random access parameters for the random access to the cell. The random access parameters may comprise at least one of: the first resource configuration parameters indicating the first radio resource associated with the at least one first beam; the second resource configuration parameters indicating the second radio resource associated with the at least one second beam; the first preamble index associated with the at least one first beam; the second preamble index associated with the at least one second beam; and/or the like. In an example, the first radio resource or the second radio resource may comprise the radio resource that the wireless device uses for the random access to the cell. The first preamble index or the second preamble index may indicate the random access preamble that the wireless device uses for the random access to the cell.

In an example, the at least one RRC configuration message may comprise at least one of: the execution condition for the cell; the first execution condition for the cell and/or the at least one first beam (e.g., the first TRP, the first CORESET group, the first TCI state, etc.); the second execution condition for the cell and/or the at least one second beam (e.g., the second TRP, the second CORESET group, the second TCI state, etc.); and the selection condition for selecting between the first execution condition and the second execution condition; and/or the like.

In an example, the at least one RRC configuration message may comprise at least one of: a third execution condition for at least one third beam of the cell; third resource configuration parameters indicating a third radio resource associated with the at least one third beam; a third preamble index associated with the at least one first beam; third configuration parameters indicating a two-step random access procedure or a four-step random access procedure for the at least one third beam; and/or the like.

In an example, the wireless device may monitor the cell (e.g., target cell, candidate PSCell, etc.) and/or the first cell (e.g., the source cell, primary cell, etc.) based on the at least one RRC configuration message. The wireless device may monitor and/or determine whether at least one of the first execution condition or the second execution condition is met. The wireless device may select the at least one first beam or the at least one second beam based on the first execution condition or the second execution condition being met. In an example, the selecting by the wireless device the at least one first beam or the at least one second beam may comprise at least one of: selecting the at least one first beam in response to the first execution condition being met for the at least one first beam; selecting the at least one second beam in response to the second execution condition being met for the at least one second beam; and/or the like.

The wireless device may monitor and/or determine whether the selection condition is met. The wireless device may determine, based on the selection condition being met, whether the first execution condition is met for the cell and/or for the at least one first beam. The wireless device may determine, based on the selection condition not being met, whether the second execution condition is met for the cell and/or for the at least one second beam.

In an example, the wireless device may perform, based on determining the first execution condition or the second execution condition being met, a random access procedure by sending one or more random access preambles via the cell. The wireless device may send, based on the first execution condition or the second execution condition being met, the random access preamble via the radio resource associated with the first execution condition or the second execution condition for the random access to the cell. The wireless device may send the random access preamble (e.g., indicated in the at least one RRC configuration message) via the radio resource (e.g., indicated in the at least one RRC configuration message) (e.g., the first resource and/or the first radio resource; or the second resource and/or the second radio resource) for the random access to the cell. The radio resource may be associated with the at least one selected beam. The radio resource may be associated with the selected uplink (e.g., UL or SUL).

In an example, the random access to the cell may be a contention free random access. In an example, the wireless device may receive a random access response for the random access preamble that is sent via the radio resource of the cell. The wireless device may send, (e.g., to the second base station) based on the random access response, an RRC reconfiguration complete message.

In an example, the wireless device may determine a failure of the random access to the cell (e.g., if the wireless device does not receive the random access response). The wireless device may send, to a base station (e.g., the first base station and/or the second base station), a failure report (e.g., radio link failure report, RLF report, random access report, RACH report, handover failure report, HOF report, etc.) indicating at least one of: the failure (e.g., a radio link failure, a random access failure, a handover failure, etc.) associated with the random access; a beam index of the at least one first beam or the at least one second beam associated with the failure; information of an uplink (e.g., UL or SUL used for the failed random access) associated with the failure; and/or the like. The failure may comprise at least one of: a radio link failure (RLF); a random access failure (e.g., RACH failure); a handover failure (HOF); and/or the like.

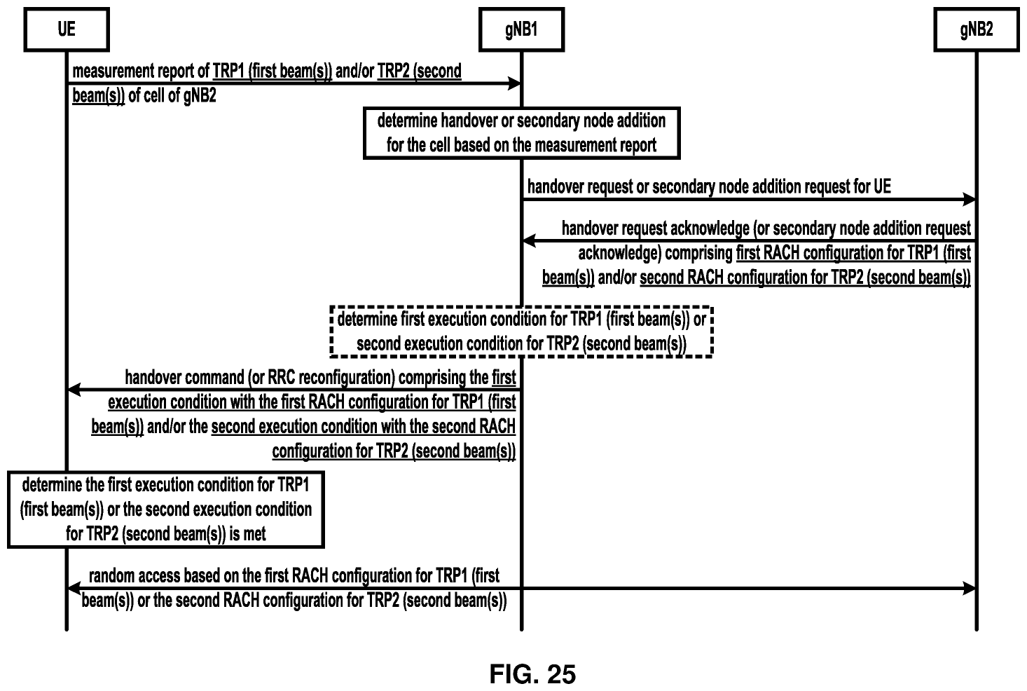

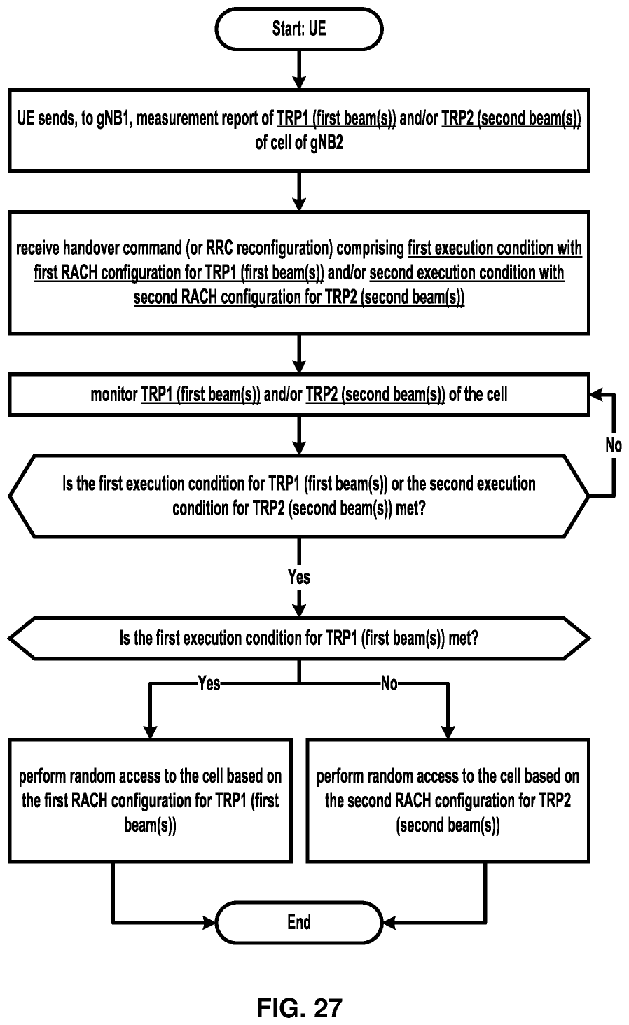

In an example, as shown in FIG. 25 and/or FIG. 27, a wireless device may receive, from a first base station, at least one radio resource control (RRC) configuration message comprising: a first execution condition for at least one first beam of a cell; and a second execution condition for at least one second beam of the cell. The wireless device may select the at least one first beam or the at least one second beam based on whether the first execution condition or the second execution condition is met. The wireless device may send a random access preamble via a radio resource, associated with the at least one selected beam, for a random access to the cell.

In an example, the at least one RRC configuration message may comprise at least one of: a handover command message for a handover to the cell; an RRC message for addition/configuration of a secondary cell group (SCG) comprising the cell; and/or the like.

In an example, the at least one RRC configuration message may comprise random access parameters for the random access to the cell. The random access parameters may comprise at least one of: first resource configuration parameters indicating a first radio resource associated with the at least one first beam; second resource configuration parameters indicating a second radio resource associated with the at least one second beam; a first preamble index associated with the at least one first beam; a second preamble index associated with the at least one second beam; and/or the like. In an example, the first radio resource or the second radio resource may comprise the radio resource. The first preamble index or the second preamble index may indicate the random access preamble. In an example, the first base station may receive from a second base station, the random access parameters for the random access to the cell. The first base station may determine, based on the random access parameters, the first execution condition or the second execution condition.

In an example, the first base station or the second base station comprises the cell.

In an example, the at least one RRC configuration message may comprise configuration parameters for the random access to the cell. The configuration parameters may indicate at least one of: a two-step random access procedure (e.g., or a four-step random access procedure) for the at least one first beam; or a four-step random access procedure (e.g., or a two-step random access procedure) for the at least one second beam.

In an example, the first base station may determine at least one of: the first execution condition for the at least one first beam; the second execution condition for the at least one second beam; and/or the like. In an example, the second base station may determine at least one of: the first execution condition for the at least one first beam; the second execution condition for the at least one second beam; and/or the like.

In an example, the wireless device may send, to the first base station, measurement results of the cell. The measurement results may comprise at least one of: a first RSRP/RSRQ/SINR of the at least one first beam; a second RSRP/RSRQ/SINR of the at least one second beam; and/or the like. The first execution condition may be based on the first RSRP/RSRQ/SINR. The second execution condition may be based on the second RSRP/RSRQ/SINR. The first base station may determine, based on the measurement results, the first execution condition or the second execution condition.

In an example, the first base station may determine, based on the measurement results of the cell, to initiate a handover of the wireless device to the cell. The first base station may send, to the second base station, a handover request message for the handover. The first base station may receive, from the second base station, a handover request acknowledge message indicating acceptance of the handover. The handover request acknowledge message may indicate at least one of: the random access preamble for the random access to the cell, the radio resource for the random access to the cell, the random access parameters for the random access to the cell, the configuration parameters for the random access to the cell, and/or the like.

In an example, the first base station may determine, based on the measurement results of the cell, to initiate a secondary node addition for the wireless device. The secondary node addition comprises adding/configuring a secondary cell group comprising the cell (e.g., PScell). The first base station may send, to the second base station, a secondary node addition request message for the secondary node addition. The first base station may receive, from the second base station, a secondary node addition request acknowledge message indicating acceptance of the secondary node addition. The secondary node addition request acknowledge message may indicate at least one of: the random access preamble for the random access to the cell, the radio resource for the random access to the cell, the random access parameters for the random access to the cell, the configuration parameters for the random access to the cell, and/or the like.

In an example, the selecting the at least one first beam or the at least one second beam may comprise at least one of: selecting the at least one first beam in response to the first execution condition being met for the at least one first beam; selecting the at least one second beam in response to the second execution condition being met for the at least one second beam; and/or the like.

In an example, the first execution condition and/or the second execution condition may comprise at least one of: a handover execution condition for the handover to the cell; a secondary node addition execution condition for the secondary node addition adding/configuring the secondary cell group comprising the cell; a secondary cell group addition execution condition adding/configuring the secondary cell group comprising the cell; a secondary cell addition execution condition for adding/configuring a secondary cell (e.g., the cell); an initiation condition of a random access procedure for the random access to the cell; and/or the like.

In an example, the first execution condition may indicate at least one of:
Event A1/C1 (Serving becomes better than threshold): a measurement result of a first cell (e.g., and/or at least one beam of the first cell) of the first base station becomes worse than a value;
Event A2 (Serving becomes worse than threshold): a measurement result of the first cell (e.g., and/or at least one beam of the first cell) becomes worse than a value;
Event A3/C2 (Target becomes offset better than PCell/PSCell): a measurement result of the at least one first beam of the cell becomes offset better than a measurement result of the first cell (e.g., and/or at least one beam of the first cell);
Event A4/C1 (Target becomes better than threshold): a measurement result of the at least one first beam of the cell becomes better than a value;
Event A5 (PCell/PSCell becomes worse than threshold1 and target becomes better than threshold2): a measurement result of the first cell (e.g., and/or at least one beam of the first cell) becomes worse than a value and a measurement result of the at least one first beam of the cell becomes better than a value;
Event A6 (Target becomes offset better than SCell): a measurement result of the at least one first beam of the cell becomes offset better than a measurement result of a secondary cell (e.g., and/or at least one beam of the secondary cell) of the wireless device;
Event B1 (Inter RAT target becomes better than threshold): a measurement result of the at least one first beam of the cell (e.g., inter-RAT cell) becomes better than a value;
Event B2 (PCell becomes worse than threshold1 and inter RAT target becomes better than threshold2): a measurement result of the first cell (e.g., and/or at least one beam of the first cell) becomes worse than a value and a measurement result of the at least one first beam of the cell (e.g., inter-RAT cell) becomes better than a value; and/or the like.

In an example, the second execution condition may indicate at least one of:
Event A1/C1 (Serving becomes better than threshold): a measurement result of a first cell (e.g., and/or at least one beam of the first cell) of the first base station becomes worse than a value;
Event A2 (Serving becomes worse than threshold): a measurement result of the first cell (e.g., and/or at least one beam of the first cell) becomes worse than a value;
Event A3/C2 (Target becomes offset better than PCell/PSCell): a measurement result of the at least one second beam of the cell becomes offset better than a measurement result of the first cell (e.g., and/or at least one beam of the first cell);
Event A4/C1 (Target becomes better than threshold): a measurement result of the at least one second beam of the cell becomes better than a value;
Event A5 (PCell/PSCell becomes worse than threshold1 and target becomes better than threshold2): a measurement result of the first cell (e.g., and/or at least one beam of the first cell) becomes worse than a value and a measurement result of the at least one second beam of the cell becomes better than a value;
Event A6 (Target becomes offset better than SCell): a measurement result of the at least one second beam of the cell becomes offset better than a measurement result of a secondary cell (e.g., and/or at least one beam of the secondary cell) of the wireless device;
Event B1 (Inter RAT target becomes better than threshold): a measurement result of the at least one second beam of the cell (e.g., inter-RAT cell) becomes better than a value;
Event B2 (PCell becomes worse than threshold1 and inter RAT target becomes better than threshold2): a measurement result of the first cell (e.g., and/or at least one beam of the first cell) becomes worse than a value and a measurement result of the at least one second beam of the cell (e.g., inter-RAT cell) becomes better than a value; and/or the like.

In an example, the random access to the cell may be a contention free random access. In an example, the wireless device may receive a random access response for the random access preamble that is sent via the radio resource of the cell. The wireless device may send, based on the random access response, an RRC reconfiguration complete message.

In an example, the at least one RRC configuration message may comprise at least one of: a third execution condition for at least one third beam of the cell; third resource configuration parameters indicating a third radio resource associated with the at least one third beam; a third preamble index associated with the at least one first beam; third configuration parameters indicating a two-step random access procedure or a four-step random access procedure for the at least one third beam; and/or the like.

In an example, the at least one first beam or the at least one second beam may comprise at least one of: a synchronization signal block (SSB) beam; a channel state information reference signal (CSI-RS) beam; and/or the like.

In an example, the at least one first beam may be associated with at least one first spatial domain filter. In an example, the at least one second beam may be associated with at least one second spatial domain filter.

In an example, the wireless device may determine a failure of the random access to the cell. The wireless device may send, to a base station (e.g., the first base station and/or the second base station), a failure report (e.g., radio link failure report, RLF report, random access report, RACH report, handover failure report, HOF report, etc.) indicating at least one of: the failure (e.g., a radio link failure, a random access failure, a handover failure, etc.) associated with the random access; a beam index of the at least one first beam or the at least one second beam associated with the failure; and/or the like. The failure may comprise at least one of: a radio link failure (RLF); a random access failure (e.g., RACH failure); a handover failure (HOF); and/or the like.

In an example, a wireless device may receive, from a first base station, at least one RRC configuration message comprising: a first execution condition for a first transmission and reception point (TRP) of a cell and a second execution condition for a second TRP of the cell. The wireless device may select the first TRP or the second TRP based on whether the first execution condition or the second execution condition is met. The wireless device may send a random access preamble via a radio resource, associated with the selected TRP, for a random access to the cell.

In an example, a wireless device may receive, from a first base station, at least one RRC configuration message comprising: a first execution condition for a first control resource set (CORESET) group of a cell and a second execution condition for a second CORESET group of the cell. The wireless device may select the first CORESET group or the second CORESET group based on whether the first execution condition or the second execution condition is met. The wireless device may send a random access preamble via a radio resource, associated with the selected CORESET group, for a random access to the cell.

In an example, a wireless device may receive, from a first base station, at least one RRC configuration message comprising: a first execution condition for a first transmission configuration indicator (TCI) state of a cell and a second execution condition for a second TCI state of the cell. The wireless device may select the first TCI state or the second TCI state based on whether the first execution condition or the second execution condition is met. The wireless device may send a random access preamble via a radio resource, associated with the selected TCI state, for a random access to the cell.

In an example, a wireless device may receive, from a first base station, at least one RRC configuration message comprising: a first execution condition for at least one first beam of a cell and a second execution condition for at least one second beam of the cell. The wireless device may monitor whether at least one of the first execution condition or the second execution condition is met. The wireless device may select the at least one first beam or the at least one second beam based on the first execution condition or the second execution condition being met. The wireless device may send a random access preamble via a radio resource, associated with the at least one selected beam, for a random access to the cell.

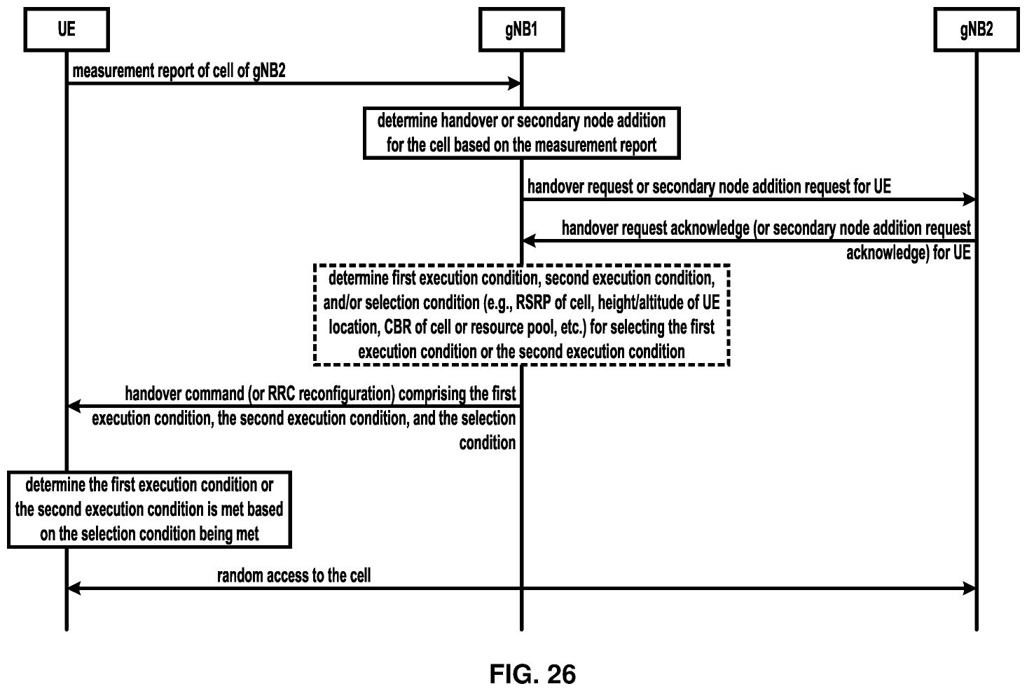

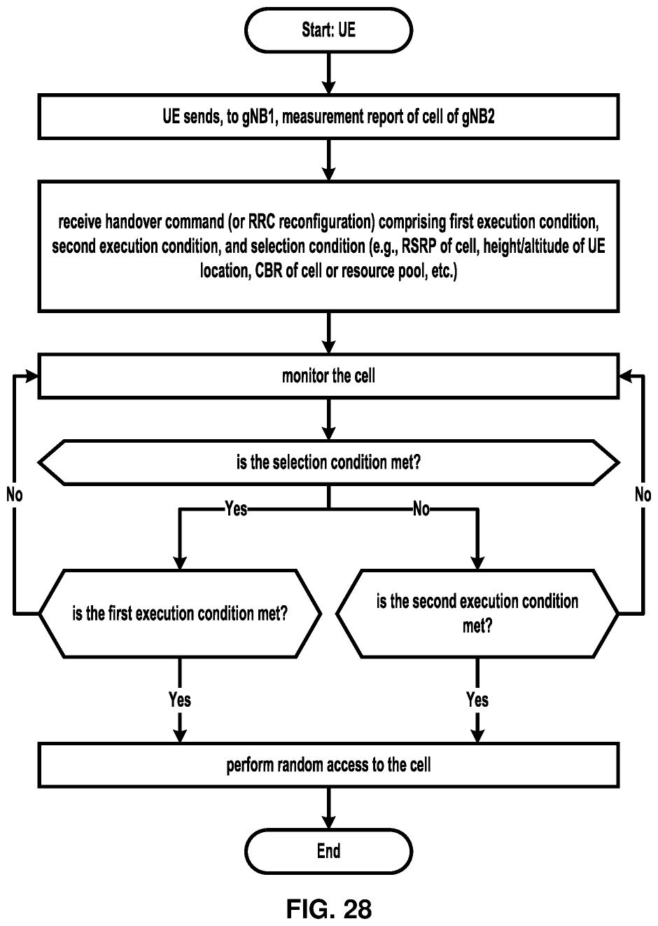

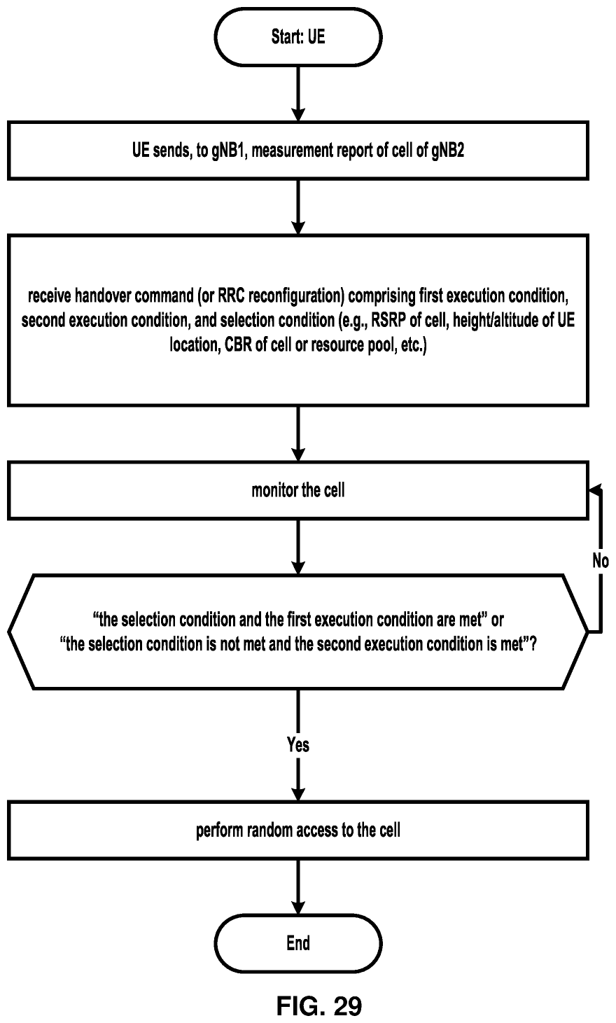

In an example, as shown in FIG. 26, FIG. 28, and/or FIG. 29, a wireless device may receive, from a first base station, at least one RRC configuration message comprising: a first execution condition for a cell; a second execution condition for the cell; and a selection condition for selecting between the first execution condition and the second execution condition. The wireless device may determine whether the selection condition is met. The wireless device may determine, in response to the selection condition being met, whether the first execution condition is met; or the wireless device may determine, in response to the selection condition not being met, whether the second execution condition is met. The wireless device may send, based on the first execution condition or the second execution condition being met, a random access preamble via a radio resource associated with the first execution condition or the second execution condition for a random access to the cell. In an example, the selection condition may be associated with at least one of: selecting between a first uplink carrier and a second uplink carrier of the cell; a measurement results of a third cell (e.g., secondary cell of the wireless device associated with the first cell and/or the cell); a channel busy ratio (CBR) of the cell (e.g., unlicensed spectrum, V2X resource pool, etc.); a received signal strength indicator (RSSI) of the cell (e.g., unlicensed spectrum, V2X resources, etc.); a height of a location of the wireless device; and/or the like.

In an example, a wireless device may receive, from a first base station, at least one RRC configuration message comprising: a first execution condition for a first uplink carrier of a cell; a second execution condition for a second uplink carrier of the cell; and a selection condition for selecting between the first uplink carrier and the second uplink carrier. The wireless device may select the first uplink carrier or the second uplink carrier based on the selection condition. The wireless device may determine, in response to selecting the first uplink carrier, whether the first execution condition is met; or the wireless device may determine, in response to selecting the second uplink carrier, whether the second execution condition is met. The wireless device may send, based on the first execution condition or the second execution condition being met, a random access preamble via a radio resource of the selected uplink carrier for a random access to the cell. In an example, the first uplink carrier may be for a normal uplink of the cell. In an example, the second uplink carrier may be for a supplementary uplink of the cell.

In an example, a wireless device may receive, from a first base station, at least one handover command comprising: a first execution condition for a first uplink carrier of a cell; and a second execution condition for a second uplink carrier of the cell. The wireless device may determine one of the first uplink carrier or the second uplink carrier as a selected uplink carrier based on monitoring/measuring/detecting whether at least one of the first execution condition or the second execution condition is met. The wireless device may send a random access preamble via the selected uplink carrier. In an example, the first execution condition may indicate that a reference signal received power (RSRP) of the first cell is equal to or larger than a power value (e.g., NUL selection threshold). In an example, the second execution condition may indicate that a reference signal received power RSRP of the first cell is equal to or smaller than a power value (e.g., SUL selection threshold).

In an example, a wireless device may receive, from a first base station, at least one handover command comprising: a first execution condition for a first uplink carrier of a cell; and a second execution condition for a second uplink carrier of the cell. The wireless device may monitor/measure/detect whether at least one of the first execution condition or the second execution condition is met. The wireless device may determine, based on the monitoring, one of the first uplink carrier or the second uplink carrier as a selected uplink carrier. The wireless device may send a random access preamble via the selected uplink carrier.

In an example, a wireless device may receive, from a first base station, at least one RRC configuration message comprising: an execution condition for a cell; a selection condition for selecting between a first uplink carrier of the cell and a second uplink carrier of the cell. The wireless device may determine that the execution condition is met. The wireless device may select the first uplink carrier or the second uplink carrier based on the selection condition. The wireless device may send a random access preamble via a radio resource of the selected uplink carrier for a random access to the cell.

In an existing conditional handover procedure, a wireless device (UE) may execute a handover to a cell based on a handover execution condition for the cell being met. A wireless device may receive multiple handover commands for multiple handover target cells that may have different priority levels.

In existing technologies, a wireless device may execute/perform a handover to a higher priority cell if handover execution conditions of both a lower priority cell and the higher priority cell are met simultaneously. A wireless device may execute/perform a handover to a cell if a handover execution condition for the cell being met before a handover execution condition of a higher priority cell is met. A wireless device may have a chance to handover to a higher priority cell only when a handover execution condition of the higher priority cell is met simultaneously with or earlier than a handover execution condition of the lower priority cell being met. The existing technologies may decrease chances of a wireless device to be served by a higher priority cell.

In existing technologies, a wireless device may wait a handover execution condition of a higher priority cell being met for too long time. Waiting a handover execution condition of a higher priority cell being bet, a wireless device may lose a connection with a serving cell. The existing technologies may decrease handover reliability of a wireless device.

Implementation of example embodiments supports that a wireless device gets a suspension condition for waiting a higher priority cell becoming better. Based on the suspension condition, the wireless device may suspend a handover execution to a lower priority cell, maintaining handover reliability of a wireless device. Example embodiments increase handover reliability of a wireless device. Example embodiments increase chances of a wireless device to be served by a higher priority cell.

In an existing conditional handover procedure, a wireless device (UE) may execute a handover to a cell based on a handover execution condition for the cell being met. A wireless device may receive multiple handover commands for multiple handover target cells that may have fixed priority levels. During a wait time for a handover execution condition becoming met, a radio status of the wireless device may change due to various reasons (e.g., moving location of the wireless device, interference, radio signal fading, traffic load change, etc.). A fixed priority level of a handover target cell may make a wireless device execute a handover to a less proper cell at the time of handover execution. The existing technologies may decrease service quality and handover reliability for a wireless device.

Implementation of example embodiments supports that a wireless device gets a priority condition to determine priorities of handover target cells. Based on the priority condition, a wireless device may determine priorities of handover target cells depending on a radio status of cells. Example embodiments increase handover reliability and service quality of a wireless device.

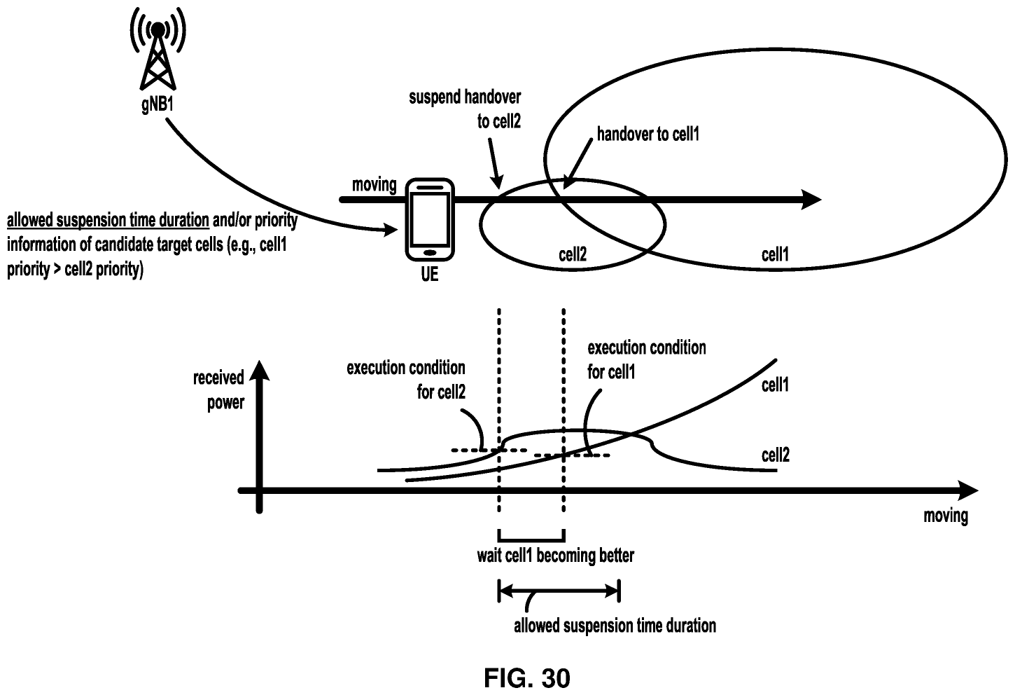

In an example, as shown in FIG. 30, a wireless device may be served by a first base station. The first base station may initiate a handover of the wireless device to at least one second base station. The handover may be to a first cell (e.g., cell1) of one of the at least one second base station. The handover may be to a second cell (e.g., cell2) of one of the at least one second base station. The first cell and/or the second cell may be a target cell for the handover of the wireless device. The handover may be from a serving cell (e.g., source cell) of the first base station to the first cell or the second cell of the at least one second base station. The serving cell may be a primary cell of the wireless device (e.g., at the first base station). The serving cell may be a source cell of the handover of the wireless device. The wireless device may have a radio resource control (RRC) connection with the first base station.

In an example, the first base station may initiate a secondary node (S-node) addition for the wireless device by adding/configuring one or more cells of the at least one second base station as a secondary cell group (SCG) for the wireless device. The one or more cells may comprise the first cell and/or the second cell of the at least one second base station. The serving cell may be a primary cell of the wireless device (e.g., at the first base station). The first cell and/or the second cell may become a primary secondary cell (PScell), a primary secondary cell group cell (PScell), and/or a secondary cell of the wireless device based on the secondary node addition.

In an example, the first base station may be one of the at least one second base station. In an example, the first base station or the at least one second base station may comprise the first cell, the second cell, a third cell, the serving cell, and/or the like.

In an example, the first base station and the at least one second base station may be connected to each other via a direct interface and/or an indirect interface. The direct interface may comprise at least one of: an Xn interface, an X2 interface, an F1 interface, and/or the like. The indirect interface may comprise an N2 interface, N3 interface, S1 interface, at least one mobility management entity (MME), at least one access and mobility management function (AMF), one or more core network nodes, and/or the like.

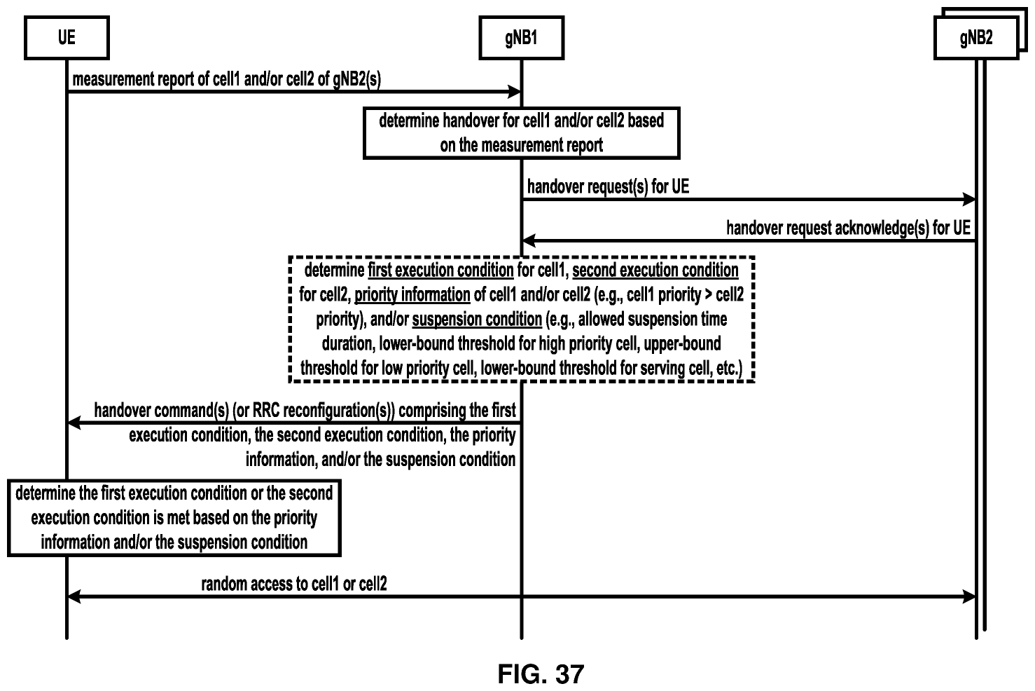

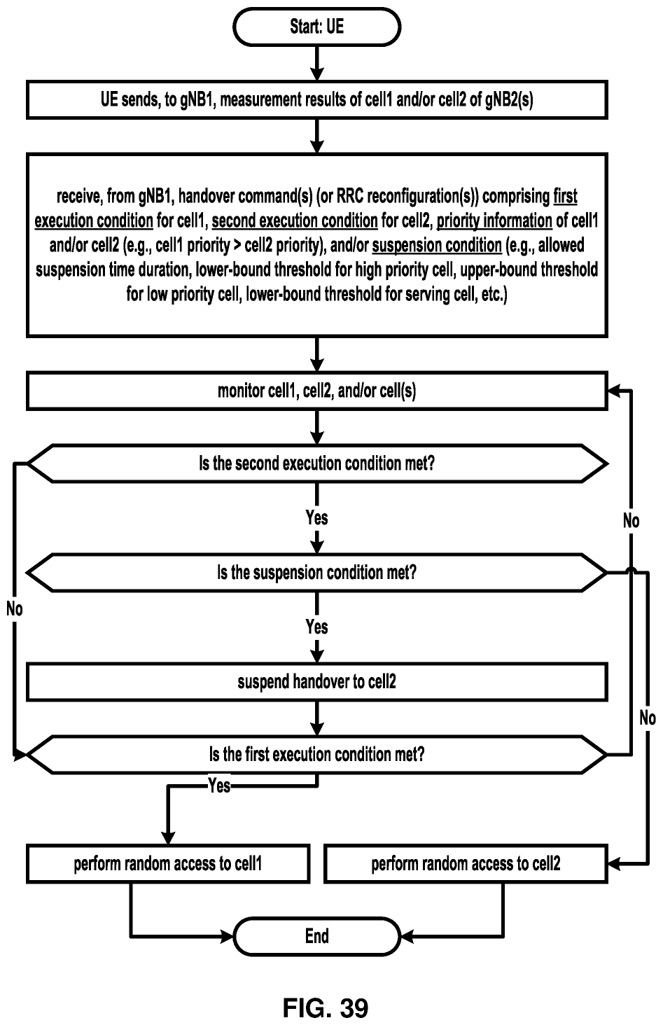

In an example, as shown in FIG. 37 and/or FIG. 39, the wireless device may receive at least one handover command (e.g., a first handover command for the first cell and a second handover command for the second cell) indicating a first execution condition for the first cell and/or a second execution condition for the second cell. The at least one handover command may comprise a suspension condition for suspending a handover execution to the second cell after the second execution condition is met. The wireless device may determine that the second execution condition is met. The wireless device may suspend, based on the suspension condition, a handover execution to the second cell.

In an example, the wireless device may determine that the first execution condition is met during the suspension condition being met. The wireless device may send, based on the first execution condition being met, a random access preamble via the first cell.

In an example, the wireless device may determine that the suspension condition becomes not met without the first execution condition being met. The wireless device may send, based on the suspension condition becoming not met, a random access preamble via the second cell.

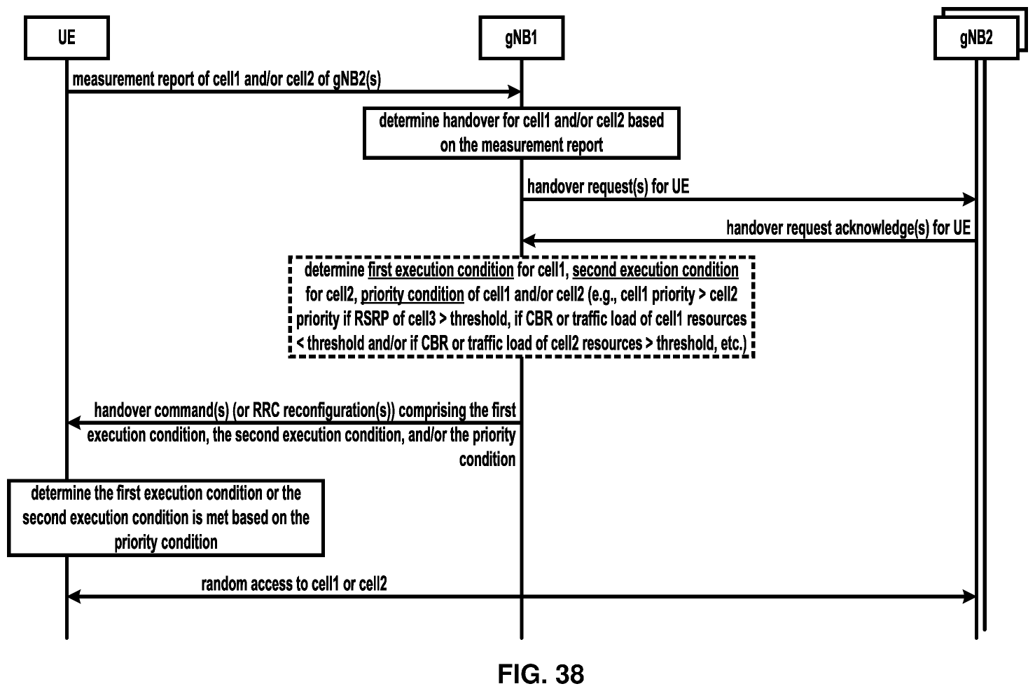

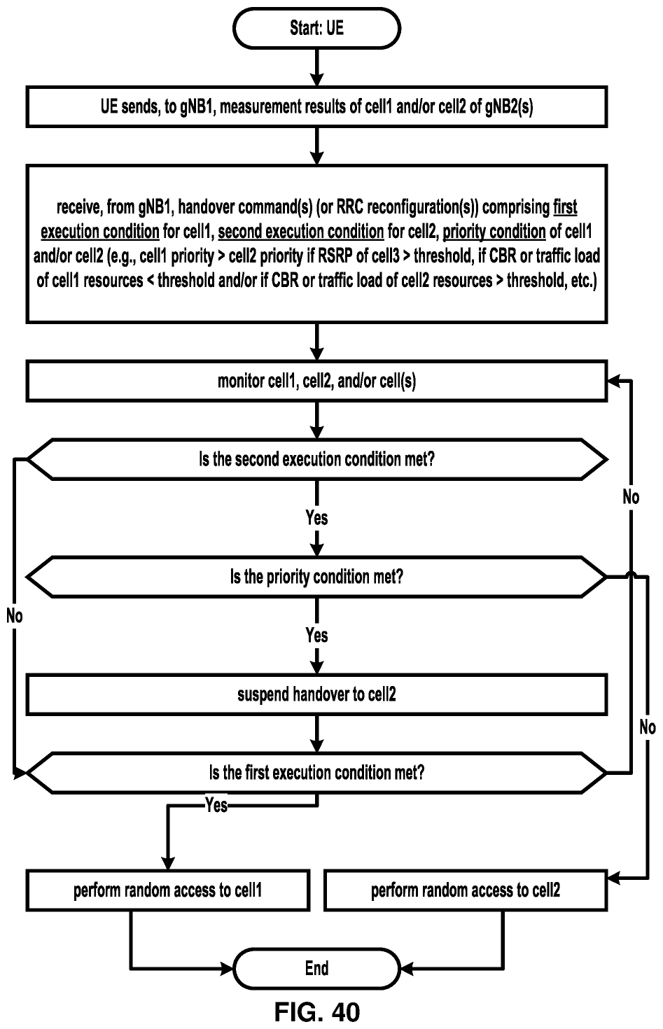

In an example, as shown in FIG. 38 and/or FIG. 40, the at least one handover command may comprise a priority condition. The priority condition may comprise at least one of: a channel busy ratio (CBR) or a received signal strength indicator (RSSI) of the first cell; a CBR or an RSSI of the second cell; a traffic load of the first cell; a traffic load of the second cell; a height/altitude of location of the wireless device; a received power (e.g., RSRP, RSRQ, SINR, etc.) of a third cell (e.g., a potential secondary cell of the wireless device at a target cell); and/or the like. The wireless device may determine priority levels of the first cell and/or the second cell based on the priority condition. The wireless device may determine that the first cell has a higher priority than the second cell based on the priority condition being met. The wireless device may suspend the handover execution to the second cell based on the first cell having a higher priority than the second cell.

In an example, the wireless device may send, to the first base station, measurement results of the first cell and/or the second cell. The measurement results may comprise at least one of: a first RSRP/RSRQ/SINR (e.g., first measurement result) of the first cell; a second RSRP/RSRQ/SINR (e.g., second measurement result) of the second cell; and/or the like. The measurement results may comprise at least one of RSRP, RSRQ, SINR, and/or the like based on layer 3 filtering of layer 1 beam measurement results of the first cell and/or the second cell.

The wireless device may receive, from the first base station, a measurement configuration (e.g., meas-Config, via an RRC reconfiguration message) comprising beam configuration parameters (e.g., beam transmission timing, frequency, periodicity, etc.) of the first cell and/or the second cell. The wireless device may receive, based on the measurement configuration, one or more beams (e.g., an SSB and/or a CSI-RS) associated with the first cell and/or the second cell. The wireless device may measure a received quality (e.g., RSRQ, SINR, etc.) and/or a received power (e.g., RSRP) of at least one of: the one or more beams of the first cell and/or the second cell; the first cell; and/or the second cell. The wireless device may send, to the first base station, the measurement results of the first cell and/or the second cell.

In an example, the first base station may determine, based on the measurement results of the first cell and/or the second cell, to initiate a handover of the wireless device to the first cell and/or the second cell. In an example, the first base station may determine, based on the measurement results of the first cell and/or the second cell, to initiate the handover (e.g., or to initiate a handover preparation) of the wireless device to the first cell and/or the second cell. In an example, the first base station may determine, based on the measurement results of the first cell and/or the second cell, to initiate the secondary node addition/modification (e.g., to initiate a secondary node addition/modification preparation) for the wireless device. The secondary node addition comprises adding/configuring a secondary cell group (SCG) comprising the first cell and/or the second cell (e.g., PScell).

In an example, the first base station may send, to at least one second base station, at least one handover request message (e.g., a request message: a first request message for the first cell or a second request message for the second cell) for the handover. In an example, the first base station may send, to the at least one second base station, the request message for radio resource configuration initiation (e.g., the handover or the secondary node addition/modification) of the wireless device. The request message may be a handover request message for the handover of the wireless device. The request message may be, for the secondary node addition/modification of the wireless device, at least one of: a secondary node addition request message (e.g., S-node addition request message, SeNB addition request message, etc.); a secondary node modification request message (e.g., S-node modification request message, SeNB modification request message, etc.); and/or the like. In an example, the first base station may send, to the at least one second base station, the handover request message for the handover of the wireless device. In an example, the first base station may send, to the at least one second base station, a configuration request message (e.g., the secondary node addition request message or the secondary node modification request message) for the secondary node configuration (e.g., the secondary node addition/modification) for the wireless device.

In an example, the first base station may send the request message to the at least one second base station via the direct interface (e.g., the Xn interface and/or the X2 interface) between the first base station and the at least one second base station. In an example, the first base station may send indication of the request of the radio resource configuration initiation (e.g., the handover or the secondary node addition/modification) via the indirect connection (e.g., comprising the one or more N2 or S1 interfaces) through the one or more core network nodes (e.g., AMF, MME, etc.). In an example, the first base station may send, to the AMF, a handover required message for the handover of the wireless device, and/or the AMF may send, to the at least one second base station and based on the handover required message, an S1/N2 handover request message for the handover of the wireless device.

In an example, the request message may comprise the measurement results of the first cell and/or the second cell that the first base station received from the wireless device. The request message may comprise at least one of: a UE identifier of the wireless device; a cell identifier (e.g., physical cell identifier, PCI, cell global identifier, CGI, etc.) of the first cell and/or the second cell (e.g., target cell); security capability information and/or security information of the wireless device; PDU session information (e.g., PDU session list, QoS flow list, QoS, S-NSSAI, NSSAI, etc.) of the wireless device; RRC contexts (e.g., RRC configuration parameters; e.g., recommended RRC configuration parameters) of the wireless device; and/or the like.

In an example, the at least one second base station may determine, based on the request message (e.g., the handover request message, the secondary node addition/modification request message, etc.), access information for the wireless device to access the first cell and/or the second cell. The access information may comprise random access parameters. The random access parameters of the access information may comprise a first index of a first preamble associated with the first cell and/or a second index of a second preamble associated with the second cell.

In an example, the access information may comprise first fields for first resources associated with the first cell. The first fields may comprise at least one of: a first number of configured hybrid automatic repeat request (HARQ) processes (e.g., numberOfConfUL-Processes); a first uplink grant (e.g., ul-Grant); a first uplink scheduling interval (e.g., ul-SchedInterval); a first uplink starting subframe/slot/symbol (e.g., ul-StartSubframe, ul-Slot, ul-Symbol, etc.); and/or the like. In an example, the access information may comprise second fields for second resources associated with the second cell. The second fields may comprise at least one of: a second number of configured HARQ processes (e.g., numberOfConfUL-Processes); a second uplink grant (e.g., ul-Grant); a second uplink scheduling interval (e.g., ul-SchedInterval); a second uplink starting subframe/slot/symbol (e.g., ul-StartSubframe, ul-Slot, ul-Symbol, etc.); and/or the like. In an example, the wireless device may transmit transport blocks via the first resources or the second resources associated with a selected target cell (e.g., the first cell or the second cell) to access to the selected target cell.

In an example, the first and/or second number of configured HARQ processes (e.g., numberOfConfUL-Processes) may be a number of configured HARQ processes for pre-allocated uplink grant for the wireless device (e.g., when the wireless device is configured with asynchronous HARQ). In an example, the first and/or second uplink grant (e.g., ul-Grant) may indicate resources of a target PCell/PSCell (e.g., the first cell and/or the second cell) to be used for uplink transmission of PUSCH (e.g., transport blocks). In an example, the first and/or second uplink scheduling interval (e.g., ul-SchedInterval) may indicate a scheduling interval in uplink, and/or may indicate a number of subframes/slots/symbols. Value sf2 may corresponds to 2 subframes, sf5 may correspond to 5 subframes, slot2 may corresponds to 2 slots, symbol2 may corresponds to 2 symbols (e.g., OFDM symbols), and/or the like. In an example, the first and/or second uplink starting subframe/slot/symbol (e.g., ul-StartSubframe, ul-Slot, ul-Symbol, etc.) may indicate a subframe/slot/symbol in which the wireless device may initiate an uplink transmission (e.g., transmission of transport blocks of PUSCH). Value 0 may correspond to subframe/slot/symbol number 0, 1 may correspond to subframe/slot/symbol number 1, and/or the like. A subframe/slot/symbol indicating a valid uplink grant according to calculation/determination of UL grant configured by ul-StartSubframe/Slot/Symbol and/or ul-SchedInterval/may be the same across radio frames.

In an example, the access information may comprise a power value for the wireless device to determine initiation of a random access using the random access parameters (e.g., instead of RACH-less access for the first cell and/or the second cell; instead of transmitting transport blocks of PUSCH to access the first cell and/or the second cell). The wireless device may compare the power value with a received power of the at least one first beam and/or the at least one second beam for the initiation of the random access using the random access parameters. In an example, the access information may comprise a time value for the wireless device to determine initiation of a random access using the random access parameters. The wireless device may initiate the random access (e.g., by transmitting a random access preamble) in response to a time duration of the time value passing (e.g., in response to expiry of the time duration) since/from/after the first signal (e.g., one of the transport blocks, PUSCH, random access preamble, and/or the like to access the first cell and/or the second cell) transmission to the at least one second base station. In an example, a random access using the random access parameters may comprise at least one of: a contention-free random access; a contention-based random access; and/or the like. In an example, a random access using the random access parameters may comprise at least one of: a 2-step random access; a 4-step random access; and/or the like. The access information may comprise a power value (e.g., threshold) for selection of the 2-step random access or the 4 step random access.

In an example, the access information may comprise configuration parameters for the wireless device to determine initiation of a random access. The configuration parameters may indicate a two-step random access procedure or a four-step random access procedure for the first cell and/or the second cell. The first base station may determine, based on the configuration parameters, the first execution condition (e.g., for the first cell) or the second execution condition (e.g., for the second cell) to execute the handover and/or the secondary node addition/modification (e.g., the SCG addition/configuration).

In an example, the first base station may receive, from the at least one second base station, at least one handover request acknowledge message (e.g., a request acknowledge message: a first request acknowledge message for the first cell or a second request acknowledge message for the second cell) indicating acceptance of the handover. The at least one handover request acknowledge message may indicate the random access parameters and/or the configuration parameters for a random access to the first cell and/or the second cell. In an example, the at least one second base station may send, to the first base station and in response to the request message (e.g., the handover request message, the secondary node addition/modification request message, etc.) and/or in response to determining to accept the request for the radio resource configuration initiation (e.g., the handover or the secondary node addition/modification) of the wireless device, the request acknowledge message (e.g., a handover request acknowledge message or a secondary base station addition/modification request acknowledge message) comprising the access information for the first cell and/or the second cell. In an example, the first base station may receive, from the at least one second base station, a handover request acknowledge message (e.g., for the handover) comprising the access information for the first cell and/or the second cell. In an example, the first base station may receive, from the at least one second base station, a configuration request acknowledge message (e.g., for the secondary node addition/modification) comprising the access information for the first cell and/or the second cell. The configuration request acknowledge message may comprise at least one of: a secondary node addition request acknowledge message (e.g., S-node addition request acknowledge message, SeNB addition request acknowledge message, etc.); a secondary node modification request acknowledge message (e.g., S-node modification request acknowledge message, SeNB modification request acknowledge message, etc.); and/or the like.

In an example, the first base station may receive, from the at least one second base station, the handover request acknowledge message indicating acceptance of the handover. The handover request acknowledge message may indicate (e.g., via the access information) at least one of: the random access preamble (e.g., the first preamble and/or the second preamble) for the random access of the wireless device to the first cell and/or the second cell, the radio resource (e.g., the first resources and/or the second resource) for the random access to the first cell and/or the second cell, the random access parameters for the random access to the first cell and/or the second cell, the configuration parameters for the random access to the first cell and/or the second cell, and/or the like. In an example, the first base station may receive, from the at least one second base station, the secondary node addition/modification request acknowledge message indicating acceptance of the secondary node addition/modification. The secondary node addition request acknowledge message may indicate (e.g., via the access information) at least one of: the random access preamble (e.g., the first preamble and/or the second preamble) for the random access to the first cell and/or the second cell, the radio resource (e.g., the first resources and/or the second resource) for the random access to the first cell and/or the second cell, the random access parameters for the random access to the first cell and/or the second cell, the configuration parameters (e.g., indicating the 2-step or 4-step random access process) for the random access to the first cell and/or the second cell, and/or the like.

In an example, the at least one second base station may send the request acknowledge message to the first base station via the direct interface (e.g., the Xn interface and/or the X2 interface) between the first base station and the at least one second base station. In an example, the at least one second base station may send indication of the request acknowledge of the radio resource configuration initiation (e.g., the handover or the secondary node addition/modification) via the indirect connection (e.g., comprising the one or more N2 or S1 interfaces) through the one or more core network nodes (e.g., AMF, MME, etc.). In an example, the at least one second base station may send, to the AMF, an S1/N2 handover request acknowledge message for the handover of the wireless device, and/or the AMF may send, to the first base station and based on the handover request acknowledge message, an S1/N2 handover command message for the handover of the wireless device.

In an example, the request acknowledge message and/or the indication of the request acknowledge may comprise at least one of: a UE identifier of the wireless device; a cell identifier (e.g., physical cell identifier, PCI, cell global identifier, CGI, etc.) of the first cell and/or the second cell (e.g., target cell, PSCell); security capability information and/or security information of the wireless device; PDU session information (e.g., accepted/setup/modified/rejected/released PDU session list, QoS flow list, QoS, S-NSSAI, NSSAI, etc.) of the wireless device; RRC contexts (e.g., RRC configuration parameters that may be configured based on the measurement results of the wireless device for the first cell and/or the second cell) of the wireless device; and/or the like.

In an example, the first base station may receive from the at least one second base station, the random access parameters (e.g., via the access information) for the random access of the wireless device to the first cell and/or the second cell. The random access parameters may comprise at least one of: first resource configuration parameters indicating a first radio resource (e.g., the first resources) associated with the at least one first beam; second resource configuration parameters indicating a second radio resource (e.g., the second resources) associated with the at least one second beam; a first preamble index (e.g., the first index of the first preamble) associated with the at least one first beam; a second preamble index (e.g., the second index of the second preamble) associated with the at least one second beam; and/or the like. In an example, the first radio resource or the second radio resource may comprise the radio resource that may be used by the wireless device to perform the random access to the first cell and/or the second cell. The first preamble index or the second preamble index may indicate the random access preamble that may be used by the wireless device to perform the random access to the first cell and/or the second cell.

In an example, the first base station may determine execution conditions for the wireless device to execute the handover and/or the secondary node addition/modification. In an example, based on the request acknowledge message (e.g., the handover request acknowledge message or the secondary node addition request acknowledge message), the first base station may determine a first execution condition for the first cell and a second execution condition for the second cell for the wireless device to execute the handover or the secondary node addition/modification. In an example, the first execution condition and/or the second execution condition may comprise at least one of: a handover execution condition for the handover to the first cell or the second cell; a secondary node addition execution condition for the secondary node addition adding/configuring the secondary cell group comprising the first cell or the second cell; a secondary cell group addition execution condition adding/configuring the secondary cell group comprising the first cell or the second cell; a secondary cell addition execution condition for adding/configuring a secondary cell (e.g., the first cell or the second cell); an initiation condition of a random access procedure for the random access (e.g., for the handover or the secondary node addition/modification) to the first cell or the second cell; and/or the like.

In an example, the first base station may determine, based on the at least one handover request acknowledge message (e.g., the request acknowledge message: the first request acknowledge message for the first cell or the second request acknowledge message for the second cell), at least one of: priority levels of the first cell and/or the second cell; the first cell has a higher priority than the second cell for the handover; a suspension condition for suspending a handover execution to a lower priority cell (e.g., the second cell); a priority condition for determining priority levels of the target cells (e.g., the first cell and/or the second cell); and/or the like.

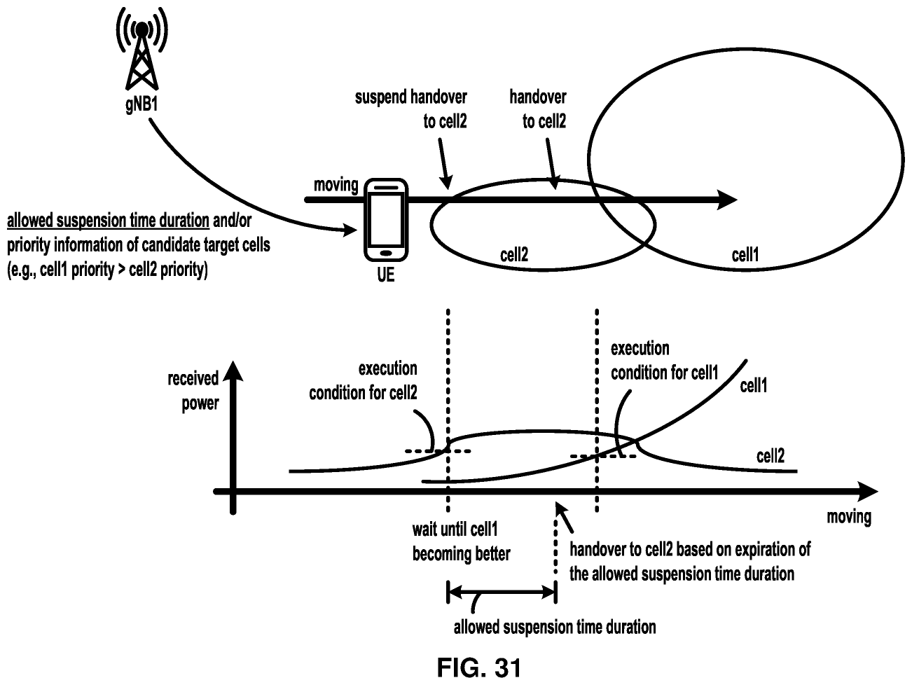

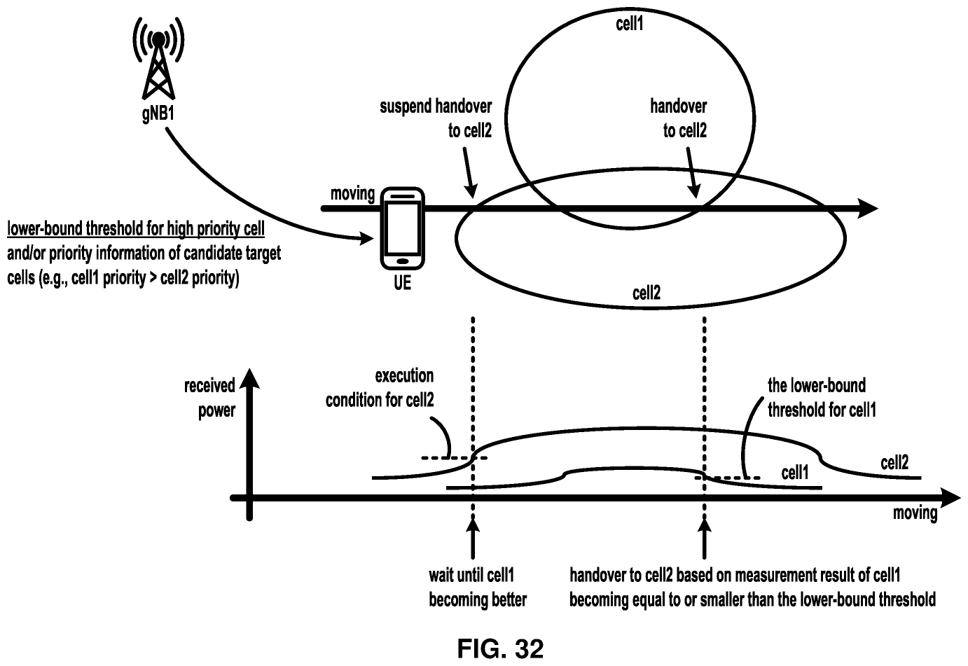

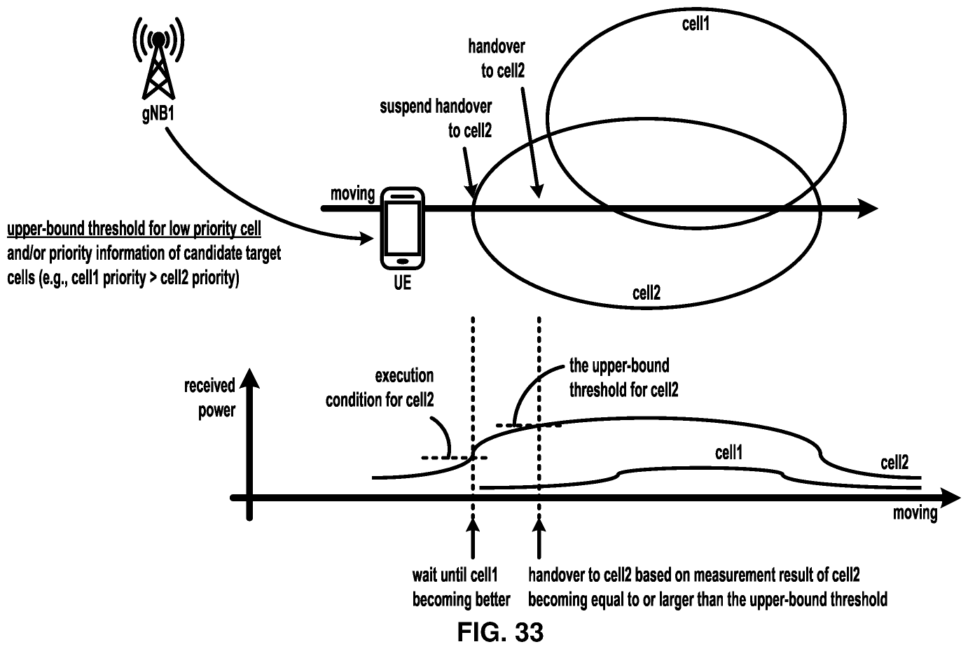

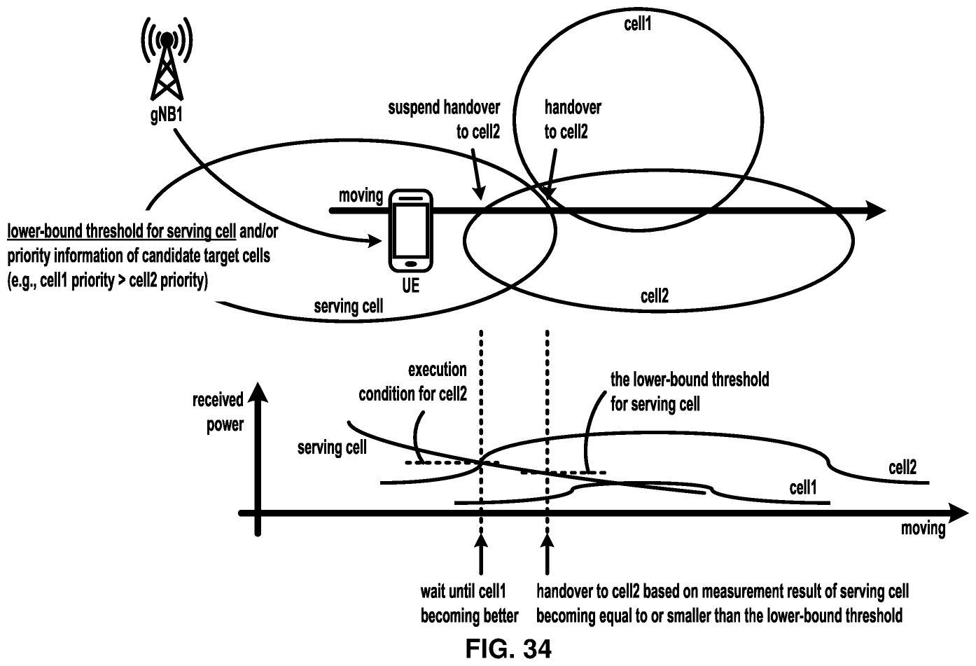

In an example, the suspension condition may comprise at least one of: an allowed time duration for suspending a handover execution to the second cell after the second execution condition is met (e.g., as shown in FIG. 30 and/or FIG. 31); a lower-bound received power of the first cell (e.g., as shown in FIG. 32); an upper-bound received power of the second cell (e.g., as shown in FIG. 33); a lower-bound received power of a serving cell (e.g., a source cell of a handover) of the wireless device (e.g., as shown in FIG. 34); and/or the like. The wireless device may start a timer for the allowed time duration in response to the determining that the second execution condition is met.

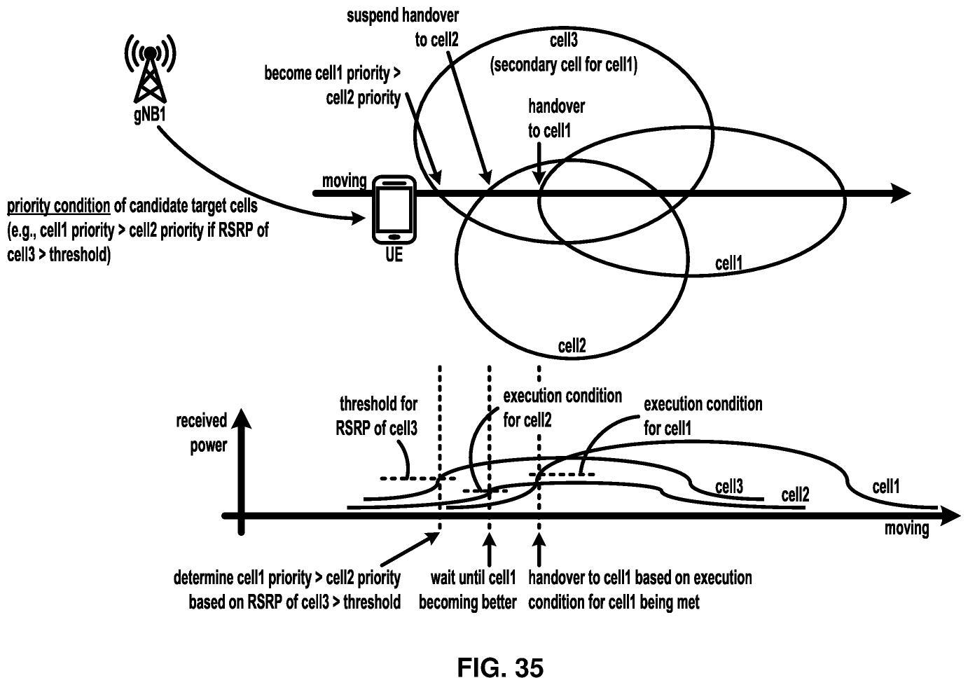

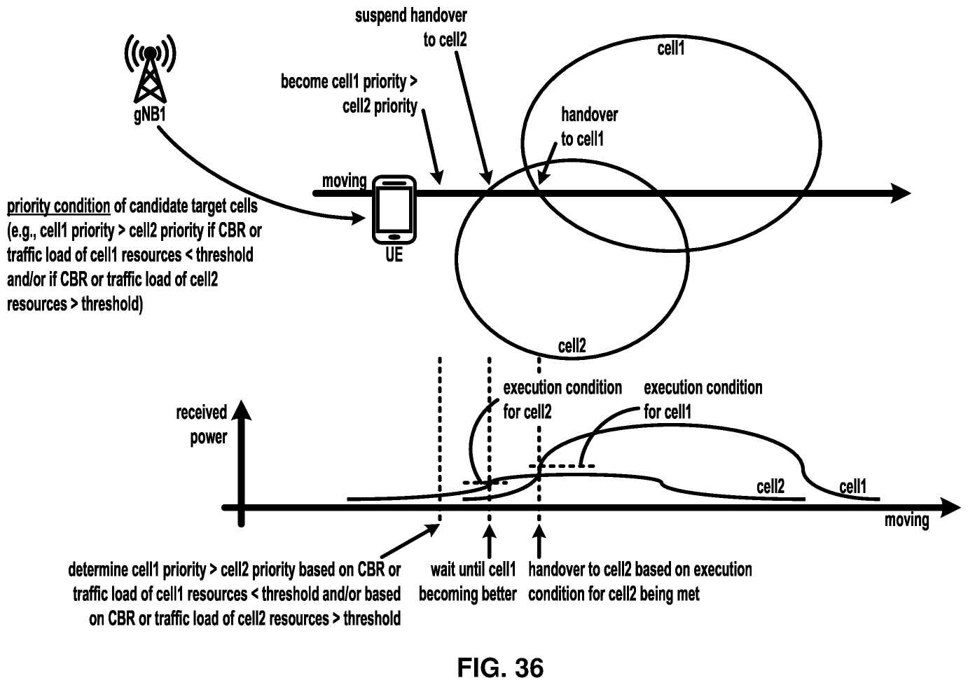

In an example, the priority condition may comprise at least one of: a channel busy ratio (CBR) or a received signal strength indicator (RSSI) of the first cell (e.g., as shown in FIG. 36); a CBR or an RSSI of the second cell (e.g., as shown in FIG. 36); a traffic load of the first cell (e.g., as shown in FIG. 36); a traffic load of the second cell (e.g., as shown in FIG. 36); a height/altitude of location of the wireless device; a received power (e.g., RSRP, RSRQ, SINR, etc.) of a third cell (e.g., a potential secondary cell of the wireless device at a target cell) (e.g., as shown in FIG. 35); and/or the like.

In an example, as shown in FIG. 35, FIG. 36, FIG. 38, and/or FIG. 40, the priority levels may be determined (e.g., by the first base station or by the wireless device) based on the priority condition and/or measurement results. The wireless device may determine priority levels of the first cell and/or the second cell based on the priority condition. The wireless device may determine that the first cell has a higher priority than the second cell based on the priority condition being met.

In an example, the first base station may determine the first execution condition and/or the second execution condition based on at least one of: the access information; the random access parameters of the access information; the configuration parameters (e.g., indicating the 2-step or 4-step random access process) of the access information for the random access to the first cell or the second cell; the measurement results of the first cell or the second cell that the first base station received from the wireless device; and/or the like.

In an example, the first execution condition may comprise at least one of: the event A1, the event A2, the event A3, the event A4, the event A5, the event A6, the event B 1, the event B2, the event C1, the event C2, the event W1, the event W2, the event W3, the event V1, the event V2, the event H1, the event H2, and/or the like. The first execution condition may comprise the “AND combination” or the “OR combination” of at least one of: the event A1, the event A2, the event A3, the event A4, the event A5, the event A6, the event B 1, the event B2, the event C1, the event C2, the event W1, the event W2, the event W3, the event V1, the event V2, the event H1, the event H2, and/or the like.

In an example, the first execution condition may indicate at least one of:
Event A1/C1 (Serving becomes better than threshold): a measurement result of the serving cell (e.g., and/or at least one beam of the serving cell) of the first base station becomes worse than a value;
Event A2 (Serving becomes worse than threshold): a measurement result of the serving cell (e.g., and/or at least one beam of the serving cell) becomes worse than a value;
Event A3/C2 (Target becomes offset better than PCell/PSCell): a measurement result of the first cell and/or the at least one first beam of the first cell becomes offset better than a measurement result of the serving cell (e.g., and/or at least one beam of the serving cell);
Event A4/C1 (Target becomes better than threshold): a measurement result of the first cell and/or the at least one first beam of the first cell becomes better than a value;
Event A5 (PCell/PSCell becomes worse than threshold1 and target becomes better than threshold2): a measurement result of the serving cell (e.g., and/or at least one beam of the serving cell) becomes worse than a value and a measurement result of the first cell and/or the at least one first beam of the first cell becomes better than a value;
Event A6 (Target becomes offset better than SCell): a measurement result of the first cell and/or the at least one first beam of the first cell becomes offset better than a measurement result of a secondary cell (e.g., and/or at least one beam of the secondary cell) of the wireless device;
Event B1 (Inter RAT target becomes better than threshold): a measurement result of the first cell and/or the at least one first beam of the first cell (e.g., inter-RAT cell) becomes better than a value;
Event B2 (PCell becomes worse than threshold1 and inter RAT target becomes better than threshold2): a measurement result of the serving cell (e.g., and/or at least one beam of the serving cell) becomes worse than a value and a measurement result of the first cell and/or the at least one first beam of the first cell (e.g., inter-RAT cell) becomes better than a value; and/or the like.
Event W1 (WLAN becomes better than a threshold);
Event W2 (All WLAN inside WLAN mobility set becomes worse than threshold1 and a WLAN outside WLAN mobility set becomes better than threshold2);
Event W3 (All WLAN inside WLAN mobility set becomes worse than a threshold);
Event V1 (The channel busy ratio is above a threshold);
Event V2 (The channel busy ratio is below a threshold);
Event H1 (The Aerial UE height is above a threshold);
Event H2 (The Aerial UE height is below a threshold); and/or the like.

In an example, the second execution condition may comprise at least one of: the event A1, the event A2, the event A3, the event A4, the event A5, the event A6, the event B 1, the event B2, the event C1, the event C2, the event W1, the event W2, the event W3, the event V1, the event V2, the event H1, the event H2, and/or the like. The second execution condition may comprise the “AND combination” or the “OR combination” of at least one of: the event A1, the event A2, the event A3, the event A4, the event A5, the event A6, the event B 1, the event B2, the event C1, the event C2, the event W1, the event W2, the event W3, the event V1, the event V2, the event H1, the event H2, and/or the like.

In an example, the second execution condition may indicate at least one of:
Event A1/C1 (Serving becomes better than threshold): a measurement result of the serving cell (e.g., and/or at least one beam of the serving cell) of the first base station becomes worse than a value;
Event A2 (Serving becomes worse than threshold): a measurement result of the serving cell (e.g., and/or at least one beam of the serving cell) becomes worse than a value;
Event A3/C2 (Target becomes offset better than PCell/PSCell): a measurement result of the second cell and/or the at least one second beam of the second cell becomes offset better than a measurement result of the serving cell (e.g., and/or at least one beam of the serving cell);
Event A4/C1 (Target becomes better than threshold): a measurement result of the second cell and/or the at least one second beam of the second cell becomes better than a value;
Event A5 (PCell/PSCell becomes worse than threshold1 and target becomes better than threshold2): a measurement result of the serving cell (e.g., and/or at least one beam of the serving cell) becomes worse than a value and a measurement result of the second cell and/or the at least one second beam of the second cell becomes better than a value;
Event A6 (Target becomes offset better than SCell): a measurement result of the second cell and/or the at least one second beam of the second cell becomes offset better than a measurement result of a secondary cell (e.g., and/or at least one beam of the secondary cell) of the wireless device;
Event B1 (Inter RAT target becomes better than threshold): a measurement result of the second cell and/or the at least one second beam of the second cell (e.g., inter-RAT cell) becomes better than a value;
Event B2 (PCell becomes worse than threshold1 and inter RAT target becomes better than threshold2): a measurement result of the serving cell (e.g., and/or at least one beam of the serving cell) becomes worse than a value and a measurement result of the second cell and/or the at least one second beam of the second cell (e.g., inter-RAT cell) becomes better than a value; and/or the like.
Event W1 (WLAN becomes better than a threshold);
Event W2 (All WLAN inside WLAN mobility set becomes worse than threshold1 and a WLAN outside WLAN mobility set becomes better than threshold2);
Event W3 (All WLAN inside WLAN mobility set becomes worse than a threshold);
Event V1 (The channel busy ratio is above a threshold);
Event V2 (The channel busy ratio is below a threshold);
Event H1 (The Aerial UE height is above a threshold);
Event H2 (The Aerial UE height is below a threshold); and/or the like.

In an example, the first base station may send, to the wireless device at least one handover command (e.g., comprising at least one RRC configuration message) indicating/commanding a handover (e.g., conditional handover) of the wireless device to the first cell and/or the second cell. The wireless device may receive, from the first base station, the at least one handover command (e.g., a first handover command for the first cell and a second handover command for the second cell). In an example, the at least one handover command may comprise at least one of: a handover command message for a handover to the first cell or the second cell; an RRC message for addition/configuration of a secondary cell group (SCG) comprising the first cell or the second cell; and/or the like.

In an example, the at least one RRC configuration message (e.g., comprising the at least one handover command) may comprise at least one of: a handover command message (e.g., comprising an RRC reconfiguration message); an RRC reconfiguration message (e.g., for addition/configuration of the SCG comprising the first cell and/or the second cell); and/or the like. In an example, the handover command message (e.g., comprising an RRC reconfiguration message configured by the second base station) may be configured by the second base station, and the first base station may forward the handover command to the wireless device. The at least one RRC configuration message (e.g., the handover command message and/or the RRC reconfiguration message) may be based on the handover request acknowledge message and/or the secondary node addition/modification request acknowledge message. The handover request acknowledge message may comprise the RRC reconfiguration message (e.g., comprising the access information) that is the handover command message.

In an example, the at least one RRC configuration message may comprise at least one of: the access information, the random access parameters (e.g., for the random access to the first cell and/or the second cell) of the access information, the configuration parameters (e.g., indicating the 2-step or 4-step random access process) of the access information, the index of the random access preamble (e.g., the first preamble and/or the second preamble) for the random access to the first cell and/or the second cell, resource information indicating the radio resource (e.g., the first resources and/or the second resource) for the random access to the first cell and/or the second cell, and/or the like.

In an example, the at least one RRC configuration message may comprise the random access parameters for the random access to the first cell and/or the second cell. The random access parameters may comprise at least one of: the first resource configuration parameters indicating the first radio resource associated with the first cell; the second resource configuration parameters indicating the second radio resource associated with the second cell; the first preamble index associated with the first cell; the second preamble index associated with the second cell; and/or the like. In an example, the first radio resource or the second radio resource may comprise the radio resource that the wireless device uses for the random access to the first cell and/or the second cell. The first preamble index or the second preamble index may indicate the random access preamble that the wireless device uses for the random access to the first cell and/or the second cell.

In an example, the at least one RRC configuration message may comprise at least one of: a third execution condition for a third cell; third resource configuration parameters indicating a third radio resource associated with the third cell; a third preamble index associated with the third cell; third configuration parameters indicating a two-step random access procedure or a four-step random access procedure for the third cell; and/or the like.

In an example, the at least one handover command may indicate the first execution condition for the first cell (e.g., in the first handover command) and/or the second execution condition for the second cell (e.g., in the second handover command). The first execution condition and/or the second execution condition may be determined based on the measurement results that the wireless device sends to the first base station. The first execution condition may be based on the first RSRP/RSRQ/SINR. The second execution condition may be based on the second RSRP/RSRQ/SINR. The first base station may determine, based on the measurement results, the first execution condition or the second execution condition.

In an example, the first execution condition and/or the second execution condition may comprise at least one of: a handover execution condition; a secondary node addition execution condition; a secondary cell group addition execution condition; a secondary cell addition execution condition; an initiation condition of a random access procedure for the random access; and/or the like.

In an example, a random access of the wireless device using the random access preamble may be a contention free random access. The wireless device may receive a random access response for the random access preamble. The wireless device may send, based on the random access response, an RRC reconfiguration complete message.

In an example, the at least one handover command may comprise at least one of: a third execution condition for a third cell; third resource configuration parameters indicating a third radio resource associated with the third cell; a third preamble index associated with the third cell; and/or the like.

In an example, the at least one handover command may comprise random access parameters for a random access to the first cell or the second cell. The random access parameters may comprise at least one of: first resource configuration parameters indicating a radio resource for a random access to the first cell; second resource configuration parameters indicating a radio resource for a random access to the second cell; a first preamble index of a first random access preamble for a random access to the first cell; a second preamble index of a second random access preamble for a random access to the second cell; and/or the like. The first base station may receive, from at least one second base station, the random access parameters for the random access to the first cell or the second cell. The first base station may determine, based on the random access parameters, at least one of; the first execution condition; the second execution condition; the suspension condition; and/or the like.

In an example, the at least one handover command may comprise configuration parameters for a random access to the first cell or the second cell. The configuration parameters may indicate at least one of: a two-step random access procedure; a four-step random access procedure; and/or the like. In an example, the first base station may receive, from the at least one second base station, the configuration parameters for the random access to the first cell or the second cell.

In an example, the at least one handover command may comprise/indicate at least one of: the priority levels of the first cell and/or the second cell; the first cell has a higher priority than the second cell for the handover; the suspension condition for suspending a handover execution to a lower priority cell (e.g., the second cell); the priority condition for determining priority levels of the target cells (e.g., the first cell and/or the second cell); and/or the like.

In an example, the at least one handover command may comprise the suspension condition for suspending a handover execution to the second cell after the second execution condition is met. In an example, the suspension condition may comprise at least one of: the allowed time duration for suspending a handover execution to the second cell after the second execution condition is met (e.g., as shown in FIG. 30 and/or FIG. 31); the lower-bound received power of the first cell (e.g., as shown in FIG. 32); the upper-bound received power of the second cell (e.g., as shown in FIG. 33); the lower-bound received power of a serving cell (e.g., a source cell of a handover) of the wireless device (e.g., as shown in FIG. 34); and/or the like. The wireless device may start a timer for the allowed time duration in response to the determining that the second execution condition is met.

In an example, the at least one handover command may comprise the priority condition for determining priority levels of the target cells (e.g., the first cell and/or the second cell). The priority condition may comprise at least one of: a channel busy ratio (CBR) or a received signal strength indicator (RSSI) of the first cell (e.g., as shown in FIG. 36); a CBR or an RSSI of the second cell (e.g., as shown in FIG. 36); a traffic load of the first cell (e.g., as shown in FIG. 36); a traffic load of the second cell (e.g., as shown in FIG. 36); a height/altitude of location of the wireless device; a received power (e.g., RSRP, RSRQ, SINR, etc.) of a third cell (e.g., a potential secondary cell of the wireless device at a target cell) (e.g., as shown in FIG. 35); and/or the like. In an example, as shown in FIG. 35, FIG. 36, FIG. 38, and/or FIG. 40, the priority levels may be determined (e.g., by the first base station or by the wireless device) based on the priority condition and/or measurement results.

In an example, the wireless device may determine priority levels of the first cell and/or the second cell based on the priority condition. The wireless device may determine that the first cell has a higher priority than the second cell based on the priority condition being met. In an example, the wireless device may suspend the handover execution to the second cell based on the first cell having a higher priority than the second cell.

In an example, the wireless device may monitor the first cell (e.g., target cell, candidate PSCell, etc.), the second cell (e.g., target cell, candidate PSCell, etc.), the serving cell (e.g., the source cell, primary cell, etc.), and/or one or more cells, based on the at least one RRC configuration message (e.g., the at least one handover command). The wireless device may monitor and/or determine whether at least one of the first execution condition or the second execution condition is met. The wireless device may select the first cell or the second cell based on the first execution condition or the second execution condition being met. In an example, the selecting by the wireless device the first cell or the second cell may comprise at least one of: selecting the first cell in response to the first execution condition being met for the first cell; selecting the second cell in response to the second execution condition being met for the second cell; and/or the like.

In an example, the wireless device may determine that the first cell has a higher priority than the second cell for a handover. The determining (e.g., by the wireless device or the first base station) that the first cell has a higher priority than the second cell may be based on (e.g., as indicated in the at least one handover command) at least one of: at least one first bearer (PDU session, QoS flow, packet flow, etc.) to be configured at the first cell after a handover; at least one second bearer (PDU session, QoS flow, packet flow, etc.) to be configured at the second cell after a handover; at least one first network slice that is supported at the first cell; at least one second network slice that is supported at the second cell; first radio resources (e.g., configured grant, SPS, sidelink resource pool, etc.) to be configured at the first cell after a handover; second radio resources (e.g., configured grant, SPS, sidelink resource pool, etc.) to be configured at the second cell after a handover; and/or the like. The wireless device and/or the first base station may determine that the first cell has a higher priority than the second cell for a handover based on the first cell (and/or a base station serving the first cell) supporting at least one of: more/important bearers (PDU session, QoS flow, packet flow, etc.), more/important network slices, more/reliable radio resources than the second cell (and/or a base station serving the second cell).

In an example, the determining (e.g., by the wireless device or the first base station) that the first cell has a higher priority than the second cell may be based on one or more information elements indicating at least one of: a priority of a first frequency of the first cell; a priority of a second frequency of the second cell; a cellReselectionPriority (e.g., an absolute priority for NR frequency or E-UTRAN frequency); the first cell is an NR/5G cell and the second cell is an LTE cell or a 3G cell; the first cell uses FR1 and the second cell uses FR2; the first cell uses FR2 and the second cell uses FR1; the first cell is configured with SUL and the second cell is configured with UL (e.g., normal uplink, NUL); and/or the like. The wireless device may receive the one or more information elements via a system information block or a dedicated RRC message for the first cell or the second cell.

In an example, the wireless device may determine that the second execution condition is met. The wireless device may suspend, based on the suspension condition (e.g., being met), a handover execution to the second cell. The suspending the handover execution to the second cell may be based on the first cell having a higher priority than the second cell for a handover.

In an example, the wireless device may determine that the first execution condition is met during the suspension condition being met. In an example, the determining that the first execution condition is met during the suspension condition being met may comprise determining that the first execution condition is met during the suspension condition being met while the second execution condition is met.

In an example, the wireless device may send, based on the first execution condition being met, a random access preamble via the first cell. In an example, the sending the random access preamble via the first cell may be for a handover execution to the first cell.

In an example, the wireless device may determine that the suspension condition becomes not met without the first execution condition being met (e.g., while suspending the handover execution to the second cell). The wireless device may send, based on the suspension condition becoming not met, a random access preamble via the second cell. In an example, the sending the random access preamble via the second cell may be for a handover execution to the second cell.

In an example, the wireless device may receive a random access response for the random access preamble (e.g., via the first cell or the second cell). The wireless device may send, based on the random access response, an RRC reconfiguration complete message.

In an example, the wireless device may determine a failure of a random access to the first cell. The wireless device may send, to a base station (e.g., the first base station and/or at least one second base station), a failure report indicating at least one of: the suspension condition; the first cell has a higher priority than the second cell; the second execution condition was met; the handover execution to the second cell was suspended; and/or the like.

In an example, the wireless device may perform, based on determining the first execution condition or the second execution condition being met, a random access procedure by sending one or more random access preambles via the selected cell (e.g., the first cell and/or the second cell). The wireless device may send, based on the first execution condition or the second execution condition being met, the random access preamble via the radio resource associated with the first cell or the second cell. The wireless device may send the random access preamble (e.g., indicated in the at least one RRC configuration message) via the radio resource (e.g., indicated in the at least one RRC configuration message) (e.g., the first resource and/or the first radio resource; or the second resource and/or the second radio resource) for the random access to the first cell and/or the second cell. In an example, the random access to the first cell and/or the second cell may be a contention free random access. In an example, the wireless device may receive a random access response for the random access preamble that is sent via the radio resource of the first cell and/or the second cell. The wireless device may send, (e.g., to the second base station) based on the random access response, an RRC reconfiguration complete message.

In an example, as shown in FIG. 30, the wireless device may determine that the second execution condition is met. The wireless device may suspend a handover execution to the second cell. The wireless device may determine that the first execution condition is met within the allowed time duration. The wireless device may send, based on the first execution condition being met, a random access preamble via the first cell.

In an example, as shown in FIG. 31, the wireless device may determine that the second execution condition is met. The wireless device may suspend a handover execution to the second cell. The wireless device may determine expiration of the allowed time duration (from the determining that the second execution condition is met) without the first execution condition being met. The wireless device may send, based on the expiration of the allowed time duration, a random access preamble via the second cell.

In an example, as shown in FIG. 32, the wireless device may determine that the second execution condition is met. The wireless device may suspend a handover execution to the second cell. The wireless device may determine that the first execution condition is met during a received power of the first cell being equal to or larger than the lower-bound received power of the first cell. The wireless device may send, based on the first execution condition being met, a random access preamble via the first cell.

In an example, the wireless device may determine that the second execution condition is met. The wireless device may suspend a handover execution to the second cell. The wireless device may determine that a received power of the first cell becomes equal to or smaller than the lower-bound received power of the first cell without the first execution condition being met. The wireless device may send, based on the determining that the received power of the first cell becomes equal to or smaller than the lower-bound received power of the first cell, a random access preamble via the second cell.

In an example, as shown in FIG. 33, the wireless device may determine that the second execution condition is met. The wireless device may suspend a handover execution to the second cell. The wireless device may determine that the first execution condition is met during a received power of the second cell being equal to or smaller than the upper-bound received power of the second cell. The wireless device may send, based on the first execution condition being met, a random access preamble via the first cell.

In an example, the wireless device may determine that the second execution condition is met. The wireless device may suspend a handover execution to the second cell. The wireless device may determine that a received power of the second cell becomes equal to or larger than the upper-bound received power of the second cell without the first execution condition being met. The wireless device may send, based on the determining that the received power of the second cell becomes equal to or larger than the upper-bound received power of the second cell, a random access preamble via the second cell.

In an example, as shown in FIG. 34, the wireless device may determine that the second execution condition is met. The wireless device may suspend a handover execution to the second cell. The wireless device may determine that the first execution condition is met during a received power of the serving cell being equal to or larger than the lower-bound received power of the serving cell. The wireless device may send, based on the first execution condition being met, a random access preamble via the first cell.

In an example, the wireless device may determine that the second execution condition is met. The wireless device may suspend a handover execution to the second cell. The wireless device may determine that a received power of the serving cell becomes equal to or smaller than the lower-bound received power of the serving cell without the first execution condition being met. The wireless device may send, based on the determining that the received power of the serving cell becomes equal to or smaller than the lower-bound received power of the serving cell, a random access preamble via the second cell.

In an example, as shown in FIG. 37 and/or FIG. 39, a wireless device may receive at least one handover command indicating: a first execution condition for a first cell; a second execution condition for a second cell; and a suspension condition for suspending a handover execution to the second cell after the second execution condition is met. The wireless device may determine that the second execution condition is met. The wireless device may suspend, based on the suspension condition, a handover execution to the second cell. The wireless device may determine that the first execution condition is met during the suspension condition being met. The wireless device may send, based on the first execution condition being met, a random access preamble via the first cell.

The wireless device may determine that the first cell has a higher priority than the second cell for a handover. The determining that the first cell has a higher priority than the second cell may be based on (e.g., as indicated in the at least one handover command) at least one of: at least one first bearer (PDU session, QoS flow, packet flow, etc.) to be configured at the first cell after a handover; at least one second bearer (PDU session, QoS flow, packet flow, etc.) to be configured at the second cell after a handover; at least one first network slice that is supported at the first cell; at least one second network slice that is supported at the second cell; first radio resources (e.g., configured grant, SPS, sidelink resource pool, etc.) to be configured at the first cell after a handover; second radio resources (e.g., configured grant, SPS, sidelink resource pool, etc.) to be configured at the second cell after a handover; and/or the like.

The determining that the first cell has a higher priority than the second cell may be based on one or more information elements indicating at least one of: a priority of a first frequency of the first cell; a priority of a second frequency of the second cell; a cellReselectionPriority (e.g., an absolute priority for NR frequency or E-UTRAN frequency); the first cell is an NR/5G cell and the second cell is an LTE cell or a 3G cell; the first cell uses FR1 and the second cell uses FR2; the first cell uses FR2 and the second cell uses FR1; the first cell is configured with SUL and the second cell is configured with UL (e.g., normal uplink, NUL); and/or the like. The wireless device may receive the one or more information elements via a system information block or a dedicated RRC message for the first cell or the second cell.

In an example, the at least one handover command may indicate that the first cell has a higher priority than the second cell for a handover. The at least one handover command may indicate priority levels of the first cell and the second cell. In an example, as shown in FIG. 35, FIG. 36, FIG. 38, and/or FIG. 40, the priority levels may be determined (e.g., by the first base station or by the wireless device) based on a priority condition of measurement results. The at least one handover command may comprise the priority condition. The priority condition may comprise at least one of: a channel busy ratio (CBR) or a received signal strength indicator (RSSI) of the first cell; a CBR or an RSSI of the second cell; a traffic load of the first cell; a traffic load of the second cell; a height/altitude of location of the wireless device; a received power (e.g., RSRP, RSRQ, SINR, etc.) of a third cell (e.g., a potential secondary cell of the wireless device at a target cell); and/or the like.

In an example, the suspending the handover execution to the second cell may be based on the first cell having a higher priority than the second cell for a handover.

In an example, the suspension condition may comprise at least one of: an allowed time duration for suspending a handover execution to the second cell after the second execution condition is met; a lower-bound received power of the first cell; an upper-bound received power of the second cell; a lower-bound received power of a serving cell (e.g., a source cell of a handover) of the wireless device; and/or the like. The wireless device may start a timer for the allowed time duration in response to the determining that the second execution condition is met.

In an example, the sending the random access preamble via the first cell may be for a handover execution to the first cell. In an example, the determining that the first execution condition is met during the suspension condition being met may comprise determining that the first execution condition is met during the suspension condition being met while the second execution condition is met.

In an example, the at least one handover command may comprise at least one of: a handover command message for a handover to the first cell or the second cell; an RRC message for addition/configuration of a secondary cell group (SCG) comprising the first cell or the second cell; and/or the like.

In an example, the at least one handover command may comprise random access parameters for a random access to the first cell or the second cell. The random access parameters may comprise at least one of: first resource configuration parameters indicating a radio resource for a random access to the first cell; second resource configuration parameters indicating a radio resource for a random access to the second cell; a first preamble index of a first random access preamble for a random access to the first cell; a second preamble index of a second random access preamble for a random access to the second cell; and/or the like. The first base station may receive, from at least one second base station, the random access parameters for the random access to the first cell or the second cell. The first base station may determine, based on the random access parameters, at least one of; the first execution condition; the second execution condition; the suspension condition; and/or the like.

In an example, the at least one handover command may comprise configuration parameters for a random access to the first cell or the second cell. The configuration parameters may indicate at least one of: a two-step random access procedure; a four-step random access procedure; and/or the like. In an example, the first base station may receive, from the at least one second base station, the configuration parameters for the random access to the first cell or the second cell.

In an example, the wireless device may send, to the first base station, measurement results of the first cell and/or the second cell. The measurement results may comprise at least one of: a first RSRP/RSRQ/SINR of the first cell; a second RSRP/RSRQ/SINR of the second cell; and/or the like. The first execution condition may be based on the first RSRP/RSRQ/SINR. The second execution condition may be based on the second RSRP/RSRQ/SINR. The first base station may determine, based on the measurement results, the first execution condition or the second execution condition.

In an example, the first base station may determine, based on the measurement results of the first cell and/or the second cell, to initiate a handover of the wireless device to the first cell and/or the second cell. The first base station may send, to at least one second base station, at least one handover request message for the handover. The first base station may receive, from the at least one second base station, at least one handover request acknowledge message indicating acceptance of the handover. The at least one handover request acknowledge message may indicate random access parameters for a random access to the first cell and/or the second cell.

In an example, the first base station or at least one second base station may comprise the first cell and/or the second cell.

In an example, the first execution condition and/or the second execution condition may comprise at least one of: a handover execution condition; a secondary node addition execution condition; a secondary cell group addition execution condition; a secondary cell addition execution condition; an initiation condition of a random access procedure for the random access; and/or the like.

In an example, the first execution condition may indicate at least one of:
Event A1/C1 (Serving becomes better than threshold): a measurement result of the serving cell (e.g., and/or at least one beam of the serving cell) of the first base station becomes worse than a value;
Event A2 (Serving becomes worse than threshold): a measurement result of the serving cell (e.g., and/or at least one beam of the serving cell) becomes worse than a value;
Event A3/C2 (Target becomes offset better than PCell/PSCell): a measurement result of the first cell and/or the at least one first beam of the first cell becomes offset better than a measurement result of the serving cell (e.g., and/or at least one beam of the serving cell);
Event A4/C1 (Target becomes better than threshold): a measurement result of the first cell and/or the at least one first beam of the first cell becomes better than a value;
Event A5 (PCell/PSCell becomes worse than threshold1 and target becomes better than threshold2): a measurement result of the serving cell (e.g., and/or at least one beam of the serving cell) becomes worse than a value and a measurement result of the first cell and/or the at least one first beam of the first cell becomes better than a value;
Event A6 (Target becomes offset better than SCell): a measurement result of the first cell and/or the at least one first beam of the first cell becomes offset better than a measurement result of a secondary cell (e.g., and/or at least one beam of the secondary cell) of the wireless device;
Event B1 (Inter RAT target becomes better than threshold): a measurement result of the first cell and/or the at least one first beam of the first cell (e.g., inter-RAT cell) becomes better than a value;
Event B2 (PCell becomes worse than threshold1 and inter RAT target becomes better than threshold2): a measurement result of the serving cell (e.g., and/or at least one beam of the serving cell) becomes worse than a value and a measurement result of the first cell and/or the at least one first beam of the first cell (e.g., inter-RAT cell) becomes better than a value; and/or the like.

In an example, the second execution condition may indicate at least one of:
Event A1/C1 (Serving becomes better than threshold): a measurement result of the serving cell (e.g., and/or at least one beam of the serving cell) of the first base station becomes worse than a value;
Event A2 (Serving becomes worse than threshold): a measurement result of the serving cell (e.g., and/or at least one beam of the serving cell) becomes worse than a value;
Event A3/C2 (Target becomes offset better than PCell/PSCell): a measurement result of the second cell and/or the at least one second beam of the second cell becomes offset better than a measurement result of the serving cell (e.g., and/or at least one beam of the serving cell);
Event A4/C1 (Target becomes better than threshold): a measurement result of the second cell and/or the at least one second beam of the second cell becomes better than a value;
Event A5 (PCell/PSCell becomes worse than threshold1 and target becomes better than threshold2): a measurement result of the serving cell (e.g., and/or at least one beam of the serving cell) becomes worse than a value and a measurement result of the second cell and/or the at least one second beam of the second cell becomes better than a value;
Event A6 (Target becomes offset better than SCell): a measurement result of the second cell and/or the at least one second beam of the second cell becomes offset better than a measurement result of a secondary cell (e.g., and/or at least one beam of the secondary cell) of the wireless device;
Event B1 (Inter RAT target becomes better than threshold): a measurement result of the second cell and/or the at least one second beam of the second cell (e.g., inter-RAT cell) becomes better than a value;
Event B2 (PCell becomes worse than threshold1 and inter RAT target becomes better than threshold2): a measurement result of the serving cell (e.g., and/or at least one beam of the serving cell) becomes worse than a value and a measurement result of the second cell and/or the at least one second beam of the second cell (e.g., inter-RAT cell) becomes better than a value; and/or the like.

In an example, a random access of the wireless device using the random access preamble may be a contention free random access. The wireless device may receive a random access response for the random access preamble. The wireless device may send, based on the random access response, an RRC reconfiguration complete message. The at least one handover command may comprise at least one of: a third execution condition for a third cell; third resource configuration parameters indicating a third radio resource associated with the third cell; a third preamble index associated with the third cell; and/or the like.

In an example, the wireless device may determine a failure of a random access to the first cell. The wireless device may send, to a base station (e.g., the first base station and/or at least one second base station), a failure report indicating at least one of: the suspension condition; the first cell has a higher priority than the second cell; the second execution condition was met; the handover execution to the second cell was suspended; and/or the like.

In an example, a wireless device may receive at least one handover command indicating: a first execution condition for a first cell; a second execution condition for a second cell; and a suspension condition for suspending a handover execution to the second cell after the second execution condition is met. The wireless device may suspend, based on the suspension condition, a handover execution to the second cell while the first execution condition is not met and the second execution condition is met.

In an example, a wireless device may receive at least one handover command indicating: a first execution condition for a first cell; a second execution condition for a second cell; and a suspension condition for suspending a handover execution to the second cell after the second execution condition is met. The wireless device may determine that the second execution condition is met. The wireless device may suspend, based on the suspension condition, a handover execution to the second cell. The wireless device may determine that the suspension condition becomes not met without the first execution condition being met. The wireless device may send, based on the suspension condition becoming not met, a random access preamble via the second cell.

In an example, as shown in FIG. 30, a wireless device may receive at least one handover command indicating: a first execution condition for a first cell; a second execution condition for a second cell; and an allowed time duration for suspending a handover execution to the second cell after the second execution condition is met. The wireless device may determine that the second execution condition is met. The wireless device may suspend a handover execution to the second cell. The wireless device may determine that the first execution condition is met within the allowed time duration. The wireless device may send, based on the first execution condition being met, a random access preamble via the first cell.

In an example, as shown in FIG. 31, a wireless device may receive at least one handover command indicating: a first execution condition for a first cell; a second execution condition for a second cell; and an allowed time duration for suspending a handover execution to the second cell after the second execution condition is met. The wireless device may determine that the second execution condition is met. The wireless device may suspend a handover execution to the second cell. The wireless device may determine expiration of the allowed time duration (from the determining that the second execution condition is met) without the first execution condition being met. The wireless device may send, based on the expiration of the allowed time duration, a random access preamble via the second cell.

In an example, as shown in FIG. 32, a wireless device may receive at least one handover command indicating: a first execution condition for a first cell; a second execution condition for a second cell; and a lower-bound received power of the first cell for suspending a handover execution to the second cell after the second execution condition is met. The wireless device may determine that the second execution condition is met. The wireless device may suspend a handover execution to the second cell. The wireless device may determine that the first execution condition is met during a received power of the first cell being equal to or larger than the lower-bound received power of the first cell. The wireless device may send, based on the first execution condition being met, a random access preamble via the first cell.

In an example, a wireless device may receive at least one handover command indicating: a first execution condition for a first cell; a second execution condition for a second cell; and a lower-bound received power of the first cell for suspending a handover execution to the second cell after the second execution condition is met. The wireless device may determine that the second execution condition is met. The wireless device may suspend a handover execution to the second cell. The wireless device may determine that a received power of the first cell becomes equal to or smaller than the lower-bound received power of the first cell without the first execution condition being met. The wireless device may send, based on the determining that the received power of the first cell becomes equal to or smaller than the lower-bound received power of the first cell, a random access preamble via the second cell.

In an example, as shown in FIG. 33, a wireless device may receive at least one handover command indicating: a first execution condition for a first cell; a second execution condition for a second cell; and an upper-bound received power of the second cell for suspending a handover execution to the second cell after the second execution condition is met. The wireless device may determine that the second execution condition is met. The wireless device may suspend a handover execution to the second cell. The wireless device may determine that the first execution condition is met during a received power of the second cell being equal to or smaller than the upper-bound received power of the second cell. The wireless device may send, based on the first execution condition being met, a random access preamble via the first cell.

In an example, a wireless device may receive at least one handover command indicating: a first execution condition for a first cell; a second execution condition for a second cell; and an upper-bound received power of the second cell for suspending a handover execution to the second cell after the second execution condition is met. The wireless device may determine that the second execution condition is met. The wireless device may suspend a handover execution to the second cell. The wireless device may determine that a received power of the second cell becomes equal to or larger than the upper-bound received power of the second cell without the first execution condition being met. The wireless device may send, based on the determining that the received power of the second cell becomes equal to or larger than the upper-bound received power of the second cell, a random access preamble via the second cell.

In an example, as shown in FIG. 34, a wireless device may receive at least one handover command indicating: a first execution condition for a first cell; a second execution condition for a second cell; and a lower-bound received power of a serving cell for suspending a handover execution to the second cell after the second execution condition is met. The wireless device may determine that the second execution condition is met. The wireless device may suspend a handover execution to the second cell. The wireless device may determine that the first execution condition is met during a received power of the serving cell being equal to or larger than the lower-bound received power of the serving cell. The wireless device may send, based on the first execution condition being met, a random access preamble via the first cell.

In an example, a wireless device may receive at least one handover command indicating: a first execution condition for a first cell; a second execution condition for a second cell; and a lower-bound received power of a serving cell for suspending a handover execution to the second cell after the second execution condition is met. The wireless device may determine that the second execution condition is met. The wireless device may suspend a handover execution to the second cell. The wireless device may determine that a received power of the serving cell becomes equal to or smaller than the lower-bound received power of the serving cell without the first execution condition being met. The wireless device may send, based on the determining that the received power of the serving cell becomes equal to or smaller than the lower-bound received power of the serving cell, a random access preamble via the second cell.

What is claimed is:

1. A method comprising:
receiving, by a wireless device from a first base station, at least one radio resource control configuration message for a conditional handover to a cell, wherein the at least one radio resource control configuration message comprises:
a first execution condition for at least one first beam of the cell; and
a second execution condition for at least one second beam of the cell;
selecting one of:
the at least one first beam based on the first execution condition being met; or
the at least one second beam based on the second execution condition being met; and
sending, via a radio resource associated with the selected at least one beam of the cell, a random access preamble for a random access.

2. The method of claim 1, wherein the at least one radio resource control configuration message comprises random access parameters for the random access to the cell, the random access parameters comprising at least one of:
first resource configuration parameters indicating a first radio resource associated with the at least one first beam; or
second resource configuration parameters indicating a second radio resource associated with the at least one second beam.

3. The method of claim 2, wherein the first radio resource or the second radio resource comprises the radio resource.

4. The method of claim 2, further comprising receiving, by the first base station from a second base station, the random access parameters for the random access to the cell.

5. The method of claim 2, wherein the random access parameters comprises at least one of:
a first preamble index associated with the at least one first beam; or
a second preamble index associated with the at least one second beam.

6. The method of claim 5, wherein the first preamble index or the second preamble index indicates the random access preamble.

7. The method of claim 2, further comprising determining, by the first base station and based on the random access parameters, the first execution condition or the second execution condition.

8. The method of claim 1, further comprising determining by a second base station at least one of:
the first execution condition for the at least one first beam; or
the second execution condition for the at least one second beam.

9. The method of claim 8, wherein the first base station is the second base station.

10. The method of claim 1, wherein the first base station or a second base station comprises the cell.

11. The method of claim 1, further comprising sending, by the wireless device to the first base station, measurement results of the cell, wherein:
the measurement results comprise at least one of:
a first received power of the at least one first beam; or
a second received power of the at least one second beam;
the first execution condition is based on the first received power; and
the second execution condition is based on the second received power.

12. The method of claim 11, further comprising determining, by a second base station and based on the measurement results, the first execution condition or the second execution condition.

13. The method of claim 11, further comprising:
determining, by the first base station and based on the measurement results of the cell, to initiate a handover of the wireless device to the cell;
sending, by the first base station to a second base station, a handover request message for the handover; and
receiving, by the first base station from the second base station, a handover request acknowledge message indicating acceptance of the handover, wherein the handover request acknowledge message indicates the random access preamble and the radio resource.

14. The method of claim 11, further comprising:
determining, by the first base station and based on the measurement results of the cell, to initiate a secondary node addition for the wireless device, wherein the secondary node addition comprises configuring a secondary cell group comprising the cell;
sending, by the first base station to a second base station, a secondary node addition request message for the secondary node addition; and
receiving, by the first base station from the second base station, a secondary node addition request acknowledge message indicating acceptance of the secondary node addition, wherein the secondary node addition request acknowledge message indicates the random access preamble and the radio resource.

15. The method of claim 1, wherein the first execution condition or the second execution condition comprise at least one of:
a handover execution condition;
a secondary node addition execution condition;
a secondary cell group addition execution condition;
a secondary cell addition execution condition; or
an initiation condition of a random access procedure for the random access.

16. The method of claim 1, wherein the first execution condition or the second execution condition indicates at least one of:
a measurement result of a first cell becomes worse than a value;
a measurement result of the at least one first beam of the cell becomes offset better than a measurement result of the first cell;
a measurement result of the at least one first beam of the cell becomes better than a value;
a measurement result of the first cell becomes worse than a value and a measurement result of the at least one first beam of the cell becomes better than a value; or
a measurement result of the at least one first beam of the cell becomes offset better than a measurement result of a secondary cell of the wireless device.

17. The method of claim 1, further comprising receiving, by the wireless device, a random access response for the random access preamble.

18. The method of claim 17, further comprising sending, by the wireless device and based on the random access response, a radio resource control reconfiguration complete message.

19. The method of claim 1, wherein the at least one first beam or the at least one second beam comprises at least one of:
a synchronization signal block (SSB) beam; or
a channel state information reference signal (CSI-RS) beam.

20. The method of claim 1, wherein:
the at least one first beam is associated with at least one first spatial domain filter; and
the at least one second beam is associated with at least one second spatial domain filter.
